(19) United States
(12) Patent Application Publication
(10) Pub. No.: US 2005/0273346 A1
(43) Pub. Date: Dec. 8, 2005

(54) Real property information management system and method

(76) Inventor: Richard N. Frost, Corona Del Mar, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/859,926

(22) Filed: Jun. 2, 2004

(51) Int. Cl. G06F 17/60; G06F 17/00

(52) U.S. Cl. 705/1; 705/27

(57) ABSTRACT

A system of finding real property comprises a map-based search tool and a street-based search tool. The map-based search tool allows a user to enter geographical coordinates by drawing a shape on a map. The map-based search tool queries a map coordinate-geographical coordinate database to determine geographical coordinates that define the drawn shape. The map-based search tool queries a property coordinates database to find a first set of properties that are within the coordinates. The map-based search tool queries a parcel map database to find a second set of properties displayed on a parcel map that also displays at least one property in the first set of properties. The street-based search tool allows a user to enter a number of street names and queries a parcel map database to find properties that are displayed on a parcel map that also displays the streets identified by the street names.

### FIELD OF THE INVENTION

Embodiments of the present invention relate to the field of data management and transaction management. More specifically, the embodiments relate to data management and transaction management regarding real estate.

### BACKGROUND OF THE INVENTION

Real estate transactions typically involve many participants, including buyers, sellers, agents, brokers, developers, property owners, inspectors, escrow agents, loan officers, and the like. Each participant typically maintains various information about the properties for which the participant is involved in a transaction or potential transaction. Often, each participant maintains a separate physical or electronic file. The individual files of the participants may or may not share common information. Nevertheless, even if all participants have accurate information, the maintenance of separate files results in duplicated effort, as each participant generates and records the same information about a property. Furthermore, while it is possible to share real estate information through computer networks, conventional computer networks have not offered security features that are tailored to the individual needs and roles of participants in real estate transactions.

Additionally, while electronic sources for real estate information exist, the sources have typically been scattered, with tax information available from one source, valuation information from another source, and the like. Furthermore, conventional electronic sources of real estate information have typically provided limited ways to search for properties, such as, for example, searching by address, by a single street name, or by a single neighborhood. Such search limitations make it difficult for some users to find parcels of real property in which the users may have interest.

### SUMMARY OF THE INVENTION

Embodiments of the present invention assist participants in real estate transactions in sharing real estate information while providing information security that is tailored to the special needs and roles of participants in real estate transactions. According to embodiments, pre-defined roles define which participants in an organization that participates in real estate transactions can access which features and data of a real estate information management system. Advantageously, a large number of templates are provided that assist a user to select the specific roles that are appropriate for the user's organization. Additionally, in one embodiment, a large number of templates are provided that assist a user to select an organizational hierarchy that best describes the user's organization. The user can modify hierarchies and roles created based on the templates to make the roles and hierarchies correspond more closely to the actual needs of the organization.

Additionally, embodiments of the invention comprise search techniques that assist a user to locate parcels of real estate in a particular geographical reason. In one embodiment, a map-based search tool allows a user to find parcels of real estate by drawing a box or polygon around an area on a map that the user is interested in. Advantageously, the map-based search tool can find parcels of property based on the parcels' geographical coordinates, and can find certain parcels without regard to the certain parcels' street addresses. Thus, the map-based search tool can find parcels that are not found by searches that rely solely on associations between street addresses and geographical location. In one embodiment, a street-based search tool allows a user to find parcels of real estate by entering a number of street names. The street-based search module, in one embodiment, finds parcels that appear on parcel maps upon which two or more of the entered streets also appear.

In one embodiment, a system for finding parcels of real property located within a geographical area comprises at least one property database and a map-based search tool. The property database comprises records concerning properties. At least one of the records comprises geographical coordinates and a property identifier associated with at least one property. The coordinates indicate a location of the at least one associated property. The property identifier identifies the property. At least one of the records with geographical coordinates is not associated with a street address of any property. The map-based search tool is configured to receive user input regarding a geographical area to search, to determine, based on the user input, a range of geographical coordinates that define the geographical search area, to find, within the property database, a first set of properties that, according to a property coordinates database, is located within the range of geographical coordinates, and to find a second set of properties that are displayed on at least one parcel map that also displays at least one property of the first set of properties.

The map-based search tool can be configured to retrieve at least one parcel map from an external database. The map-based search tool can be configured to determine the range of geographical coordinates by querying an external database. The geographical coordinates can comprise longitude and latitude coordinates.

In one embodiment, the map-based search tool further comprises a first map selection tool that allows a user to provide input regarding a geographical area to search by drawing, on a map, a rectangle that define the geographical area to search. The map based search tool can also have a second map selection tool that allows a user to provide input regarding a geographical area to search by drawing, on the map, a polygon that defines the geographical area to search. In one embodiment, the map-based search tool generates a rectangle-approximated polygon of any polygon that a user draws using the second map selection tool and finds parcels of real property that, according to the property database, are located within the rectangle-approximated polygon. The map-based search tool can generate the rectangle-approximated polygon by determining extreme points of the polygon, dividing a rectangle defined by the extreme points into a plurality of smaller rectangles, and including, in the generated rectangle-approximated polygon, each smaller rectangle that has at least a portion of the polygon within the confines of the smaller rectangle.

In addition to the foregoing features, the foregoing embodiments can also include a street-based search tool that is configured to receive user input comprising a plurality of street names and to find at least one parcel of real property that appears on a parcel map on which a street designated by each of the plurality of street names appears.

In one embodiment, a method of finding real property comprises (1) receiving a user-selected geographical area, (2) receiving a range of geographical coordinates generated based on the selected geographical area, (3) receiving a first set of properties having property identifiers and being associated with the range of geographical coordinates, (4) receiving a second set of properties that are geographically close to the first set of properties, and (5) displaying summary information regarding the first set of properties and the second set of properties. The association between the first set of properties and the range of geographical coordinates can be that the property identifiers of the first set of properties are associated with at least one record that indicates that the first set of properties are located within the range of geographical coordinates. Receiving a second set of properties can comprise querying a parcel map database to find properties that are displayed on at least one parcel map that also displays at least one property in the first set of properties. Receiving the second set of properties can comprise receiving at least one property that does not have an address.

In one embodiment, a method of finding parcels of real property located within a geographical area comprises (1) receiving user input regarding a geographical area, wherein the user input is entered graphically into a map-based interface, (2) querying a map coordinates-geographical coordinates database to determine a range of geographical coordinates that define the geographical area, (3) querying a property coordinates database to find a first set of properties that, according to the property coordinate database, are located within the range of geographical coordinates, and (4) querying a parcel map database to find a second set of properties that, according to the parcel map database, are displayed on at least one parcel map that also displays at least one of the properties in the first set of properties. The range of coordinates determined by the map coordinates-geographical coordinates database can be longitudinal and latitudinal coordinates.

In the foregoing embodiments, the user input can be received from a user that draws a rectangle on a map to define an area to be searched. The input can be received from a user that draws a polygon on a map to define an area to be searched.

In one embodiment, a system of finding parcels of real property located within a geographical area comprises a street-based map tool configured to receive user input comprising a plurality of street names and to query a parcel map database that comprises a plurality of records that associate a plurality of parcel maps with streets that appear on each parcel map and with properties that appear on each parcel map. The querying is performed to find at least one property that is displayed on at least one parcel map that also displays at least two of the streets identified by the plurality of street names. The street-based map tool can be further configured to display a summary listing regarding the at least one property found.

The street based search tool of the foregoing embodiments can be configured to query the parcel map database to find at least one parcel map on which a street identified by all of the plurality of street names appears.

In one embodiment, a method of finding real property comprises (1) receiving a plurality of street names, (2) requesting a set of parcel maps associated with the streets identified by the street names, (3) receiving a set of properties associated with the parcel maps, and (4) displaying summary information about the properties. The association between a parcel map and a street can be that at least a portion of the street appears on the parcel map. Receiving the set of properties can comprise receiving at least one property that does not have an address.

In one embodiment, a real property information management system comprises a plurality of property files, at least one role database, at least one hierarchy database, and a template management module. The plurality of property files comprise data concerning parcels of real property. The system allows for the creation of property files. The role database comprises data that defines a plurality of roles, each role being associated with a plurality of access privileges that define one or more tasks that a user associated with the role is allowed to perform on the real property information management system. The real property information management system enforces the access privileges. The hierarchy database comprises data that defines at least one organizational hierarchy having a plurality of nodes, each node being associated with a role and with a user. When a user creates a property file, the property file becomes accessible to the creating user and to any user that is associated with a node of which the creating user's associated node is a descendant. The template management module is configured to manage a plurality of role templates that each comprise a pre-defined role and to manage a plurality of hierarchy templates that each comprise a pre-defined organizational hierarchy.

In one embodiment, the template management module allows a user to set up an organization within the real property information management system by selecting at least one of the hierarchy templates. In one embodiment, the template management module also allows the user to modify the nodes defined by the pre-defined organizational hierarchy of the selected hierarchy template. Additionally, the template management module can be configured to allow the user to modify the access rights defined by the pre-defined roles associated with the selected hierarchy template. The pre-defined roles of the role templates comprise, in one embodiment, at least a “President” role, a “System Administrator” role, a “Sales Manager” role, and a “Sales Agent” role. In one embodiment, the pre-defined organizational hierarchies of the hierarchy templates comprise at least one organizational hierarchy that defines an organization that has a plurality of geographically-based sales regions.

In addition to the foregoing features, an embodiment of the system has a map-based search tool configured to receive user input regarding a geographical area to search, to determine, based on the user input, a range of geographical coordinates that define the geographic search area, and to find, within a property database, at least one parcel of real property that, according to the property database, is located within the range of geographical coordinates. In this embodiment, the system allows the user to import data from a parcel of real property found using the map-based search tool into one of the property files.

In addition to the foregoing features, an embodiment of the system has a street-based search tool configured to receive user input comprising a plurality of street names and to find at least one parcel of real property that appears on a parcel map on which a street designated by each of the plurality of street names appears. In this embodiment, the system allows the user to import data from a parcel of real property found using the street-based search tool into one of the property files.

Neither this summary nor the following detailed description purports to define the invention. The invention is defined only by the claims.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements. In addition, the digits other than the rightmost two digits of each reference number indicates the figure in which the element first appears.

FIG. 1 illustrates a block diagram of a commercial real estate transaction system in accordance with an embodiment of the invention.

FIG. 2 illustrates a block diagram of a data management system of the commercial real estate transaction system illustrated in FIG. 1, in accordance with an embodiment of the invention.

FIG. 3A illustrates a block diagram of a set of user accounts for accessing the commercial real estate transaction system illustrated in FIG. 1, in accordance with an embodiment of the invention.

FIG. 3B illustrates a group user account for accessing the commercial real estate transaction system illustrated in FIG. 1, in accordance with an embodiment of the invention.

FIG. 3C illustrates a block diagram of a tree hierarchy for administering user access to the commercial real estate transaction system illustrated in FIG. 1, in accordance with an embodiment of the invention.

FIG. 3D illustrates a screen shot of a number of access rights and event history rights that can be associated, in one embodiment, with a role.

FIG. 3E illustrates an embodiment of a simplified pre-defined template that associates a number of rights with a “President” role.

FIG. 3F illustrates an embodiment of a simplified pre-defined template that associates a number of rights with a “System Administrator” role.

FIG. 3G illustrates an embodiment of a simplified pre-defined template that associates a number of rights with a “Sales Manager” role.

FIG. 3H illustrates an embodiment of a simplified pre-defined template that associates a number of rights with a “Sales Agent” role.

FIG. 3I illustrates an embodiment of a simplified pre-defined hierarchy template that defines a hierarchy of an organization.

FIG. 3J illustrates an embodiment of another simplified pre-defined hierarchy template that defines a hierarchy of an organization.

FIG. 4 illustrates a block diagram of a commercial real estate transaction system, in accordance with an embodiment of the invention.

FIG. 5 illustrates a screen for viewing a set of property files, in accordance with an embodiment of the invention.

FIG. 6A illustrates a screen for managing a set of property file group names, in accordance with an embodiment of the invention.

FIG. 6B illustrates a screen for managing a set of property file type names, in accordance with an embodiment of the invention.

FIG. 7 illustrates a file facts tab for managing certain content within a property file, in accordance with an embodiment of the invention.

FIG. 8 illustrates a screen for searching properties, in accordance with an embodiment of the invention.

FIG. 8A illustrates a screen shot of a map-based search tool for searching properties using a graphical map, in accordance with an embodiment of the invention.

FIG. 8B illustrates a screen shot of a property listing obtained by using a map-based search tool for searching properties using a graphical map, in accordance with an embodiment of the invention.

FIG. 8C illustrates a screen shot of a map-based search tool for selecting a polygon-shaped area on a map for searching for properties within the polygon-shaped area, in accordance with an embodiment of the invention.

FIG. 8D illustrates a rectangle-approximated polygon used for searching for properties within an approximately polygon-shaped area, in accordance with an embodiment of the invention.

FIG. 8E illustrates vertical merging of rectangles that make up a rectangle-approximated polygon that is used for searching for properties within an approximately polygon-shaped area, in accordance with an embodiment of the invention.

FIG. 8F illustrates a block diagram of a map-based search tool and its interaction with a map coordinates-geographical coordinates database, a property coordinates database, and a parcel map database, according to one embodiment.

FIG. 8G illustrates a flowchart of a process of finding real property using a map-based search tool according to one embodiment.

FIG. 8H illustrates a block diagram of a street-based search tool and its interaction with a parcel map database according to one embodiment.

FIG. 8I illustrates a flowchart of a process of finding real property using a street-based search tool according to one embodiment.

FIG. 9 illustrates a block diagram of a process for searching properties, in accordance with an embodiment of the invention.

FIG. 10A illustrates a search results screen for displaying properties found as the result of a search, in accordance with an embodiment of the invention.

FIG. 10B illustrates a search results screen preferably for displaying maps found as the result of the process in FIG. 9, in accordance with an embodiment of the invention.

FIG. 10C illustrates a search map screen, in accordance with an embodiment of the invention.

FIG. 11 illustrates a block diagram of a process for searching properties using a global positioning receiver, in accordance with an embodiment of the invention.

FIG. 12A illustrates a contacts tab for managing certain content within a property file, in accordance with an embodiment of the invention.

FIG. 12B illustrates a contacts tab for managing certain content within a property file, in accordance with an embodiment of the invention.

FIG. 13A illustrates a description tab for managing certain content within a property file, in accordance with an embodiment of the invention.

FIG. 13B illustrates a description tab for managing certain content within a property file, in accordance with an embodiment of the invention.

FIG. 14 illustrates a documents tab for managing certain content within a property file, in accordance with an embodiment of the invention.

FIG. 15 illustrates a forms tab for managing certain content within a property file, in accordance with an embodiment of the invention.

FIG. 16 illustrates a location tab for managing certain content within a property file, in accordance with an embodiment of the invention.

FIG. 17 illustrates a pictures tab for managing certain content within a property file, in accordance with an embodiment of the invention.

FIG. 18A illustrates a search results screen for displaying properties found as the result of a search, in accordance with an embodiment of the invention.

FIG. 18B illustrates a search results screen for displaying properties found as the result of a search, in accordance with an embodiment of the invention.

FIG. 19A illustrates a search map screen, in accordance with an embodiment of the invention.

FIG. 19B illustrates a search map screen, in accordance with an embodiment of the invention.

FIG. 20A illustrates a screen for viewing a set of property files, in accordance with an embodiment of the invention.

FIG. 20B illustrates a screen for viewing a set of property files, in accordance with an embodiment of the invention.

FIG. 21A illustrates a block diagram of a data management system for managing relationships among two or more members, in accordance with an embodiment of the invention.

FIG. 21B illustrates a block diagram of a data management system for managing relationships among two or more members, in accordance with an embodiment of the invention.

FIG. 21C illustrates a block diagram of a data management process preferably used with the data management system illustrated in FIG. 21A and FIG. 21B, in accordance with an embodiment of the invention.

FIG. 22A illustrates a block diagram of a data management system for managing relationships among two or more members, in accordance with an embodiment of the invention.

FIG. 22B illustrates a block diagram of a data management system for managing relationships among two or more members, in accordance with an embodiment of the invention.

FIG. 22C illustrates a block diagram of a data management process preferably used with the data management system illustrated in FIG. 22A and FIG. 22B, in accordance with an embodiment of the invention.

### DETAILED DESCRIPTION OF THE PREFERRED EMBODIMENT

This detailed description describes various embodiments and features of the invention with reference to the drawings, wherein like reference numbers are referenced with like numerals throughout. While preferred embodiments are described herein, a person of ordinary skill in the art (hereinafter sometimes referred to simply as a “skilled artisan”) will appreciate that alternative embodiments exist that omit certain features and advantages described herein. Many such alternative embodiments nevertheless are novel, advantageous, and useful, and the invention encompasses such alternative embodiments. Such alternative embodiments will be apparent to a skilled artisan in light of this disclosure.

Preferably, embodiments described herein are implemented as one or more software modules that are executable on one or more general purpose computers. While modules or software tools are described for performing the functions outlined herein, a skilled artisan will appreciate, in light of this disclosure, that the modules and tools can be implemented in software, in hardware, in firmware, or in some combination of the foregoing. Additionally, a skilled artisan will appreciate in light of this disclosure, that where any module, tool, database, or other component is illustrated or described as being located on a single computer, that such module, tool, database, or other component can also be distributed over more than one computer, such as, for example, over a network. Furthermore, modules or tools can be divided into multiple modules or tools, or multiple modules or tools can be combined into a single module or tool. Further, the communication between the modules may occur in a variety of ways, such as hardware implementations (e.g., network, serial interface, parallel interface, or internal bus), software implementations (e.g., database, DDE, function call), or a combination of hardware and software. Further, the modules may be realized using state machines, microcode, microprocessors, digital signal processors, or any other appropriate digital or analog technology.

Described herein are a number of embodiments of systems and methods related to a real estate information management system. Many features, components, functions, and advantages are described with reference to these systems and methods. Preferred embodiments have one or more of these features, components, functions, and advantages describe preferred embodiments. However, unless otherwise stated, the features, components, functions, and advantages described herein are not required aspects of the invention. Indeed, many embodiments exist that omit one or more of the features, components, functions, and advantages describes herein and that are still believed to be useful, novel, and nonobvious. The invention encompasses all such useful, novel, and nonobvious embodiments that are described herein or that are apparent to a skilled artisan in light of this disclosure, whether or not such embodiments do or do not have all of the features, components, functions, and advantages described herein. Furthermore, methods or processes described herein do not necessarily need to be performed in the order in which they are explained, unless indicated herein.

In accordance with the foregoing, the claims alone define the invention.

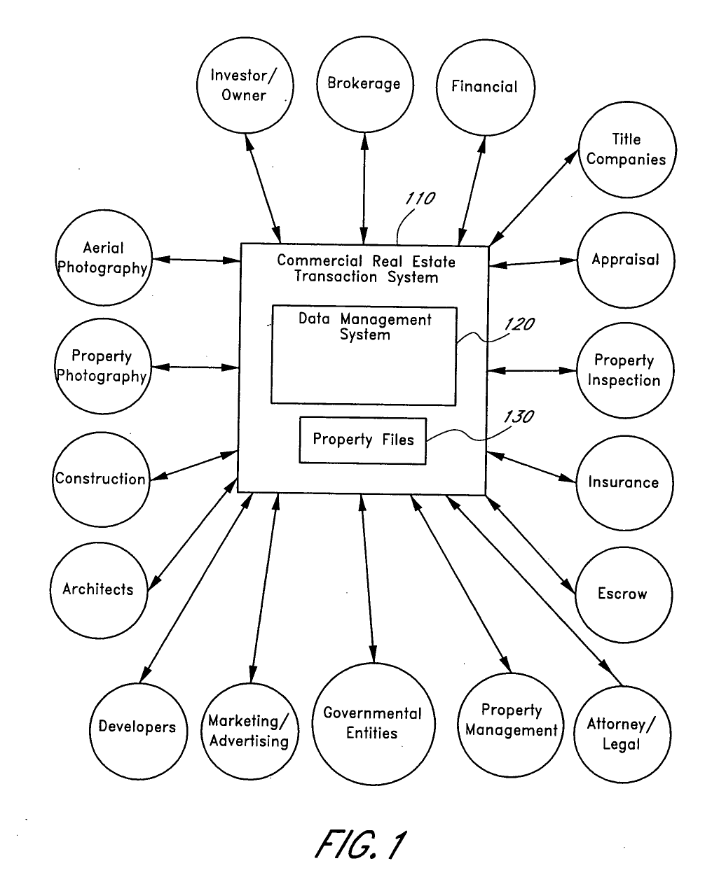

FIG. 1 illustrates a commercial real estate transaction system 110 according to one embodiment of the invention. The commercial real estate transaction system 110 includes a data management system 120 and one or more property files 130. Each property file 130 preferably corresponds to, and includes information about, a particular parcel of real property. As described below, a given property file may contain content (e.g., data, documents, graphics, photographs, or the like) generated by a number of different participants in a real estate transaction. One or more real estate transaction participants use the commercial real estate transaction system 110 to facilitate activities related to a real estate transaction.

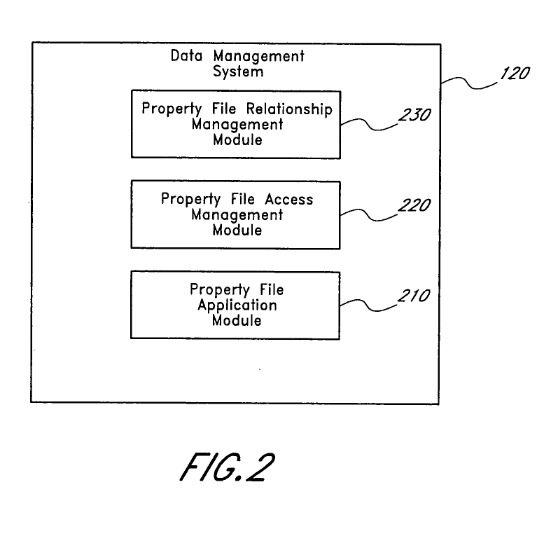

As shown in FIG. 2, a participant preferably uses a property file application module 210 to create a property file 130 for a parcel of property. The property file application module is preferably a multi-user, web-based server application. To accomplish a transaction-related task, a participant also uses the property file application module 210 to access and modify the content of existing property files 130. Operations that may be performed include viewing, adding, deleting, editing, importing, exporting content of the property files 130. The various embodiments described herein for creating property files 130 and using the content of the property files 130 are preferably embodied in the property file application module 210. Some embodiments described in further detail below include aspects that rapidly locate and add content to the property file 130.

A participant can advantageously use a property file access module 220 to administer access rights for using the property file 130 to one or more other participants. The access rights include but are not limited to viewing, adding, deleting, editing, importing, exporting or the like. A given user may be given different access rights to different property files 130. Further, the participant can advantageously use the property file access module 220 to create a “view” comprising some or all of the portions of a property file 130. Accordingly, a participant may use the property file access module 220 to advantageously grant another participant access rights for completing a transaction-related task, but still protect the integrity of some or all of its work product, protect the secrecy of some or all of its work product, or both.

The participant can advantageously use the property file access module 220 to create a hierarchy of access rights for using a plurality of property files 130. The participant may administer the hierarchy of access rights for one or more other participants. Some embodiments described in further detail below allow a participant to use a set of property files within a hierarchy. Accordingly, a participant having more responsibility may advantageously be granted rights to use more files and/or may be granted greater access rights to specific files. Conversely, a participant having less responsibility may advantageously be granted rights to use fewer files and/or may be granted a lower level of access rights (e.g., view only) to specific files. The various embodiments described herein for administering access rights to property files 130 are preferably embodied in the property file access module 220.

Also, a participant can advantageously use a property file relationship management module 230 for creating a relationship among two or more participants. Upon dissolution of the relationship, the relationship preferably determines the post-relationship access rights to property files that were created within the relationship. Accordingly, prior to entering a relationship, two or more participants may advantageously decide how to resolve disputes relating to the work product generated within the relationship. The various embodiments described herein for creating and managing relationships are preferably embodied in the property file relationship management module 230.

Unless indicated otherwise, the components and functions described herein are implemented within software modules (e.g. programs) that are executed by one or more general purpose computers. The software modules may be stored on or within any suitable computer-readable medium. It should be understood that the components and functions may alternatively be implemented in-whole or in-part within specially designed hardware.

### Account Types

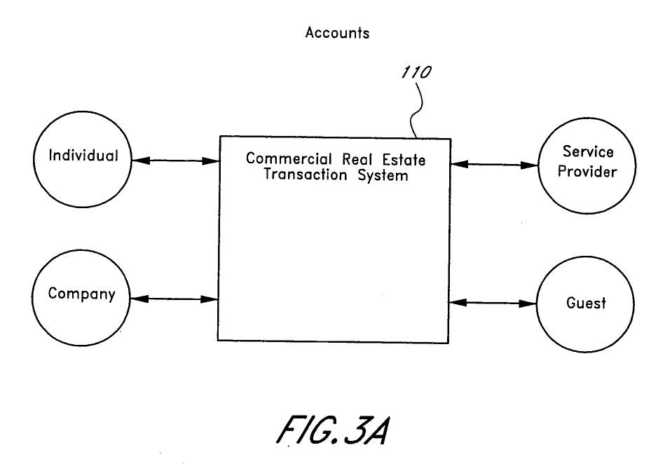

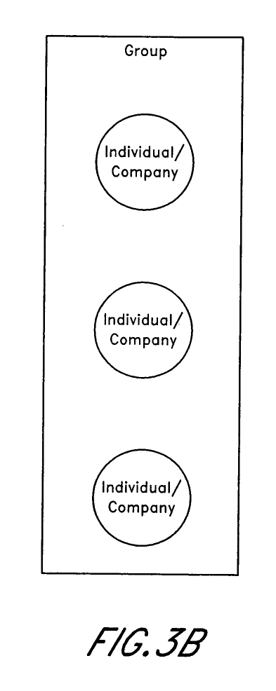

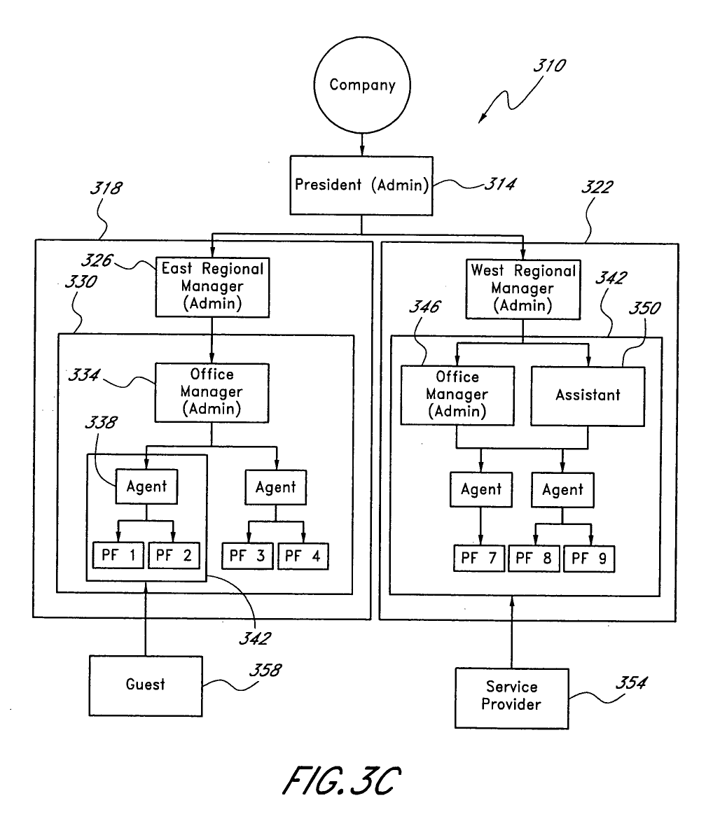

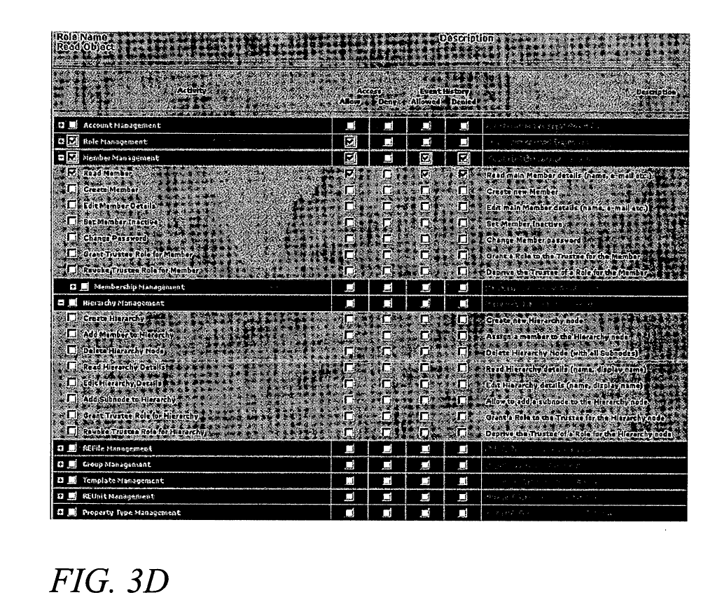

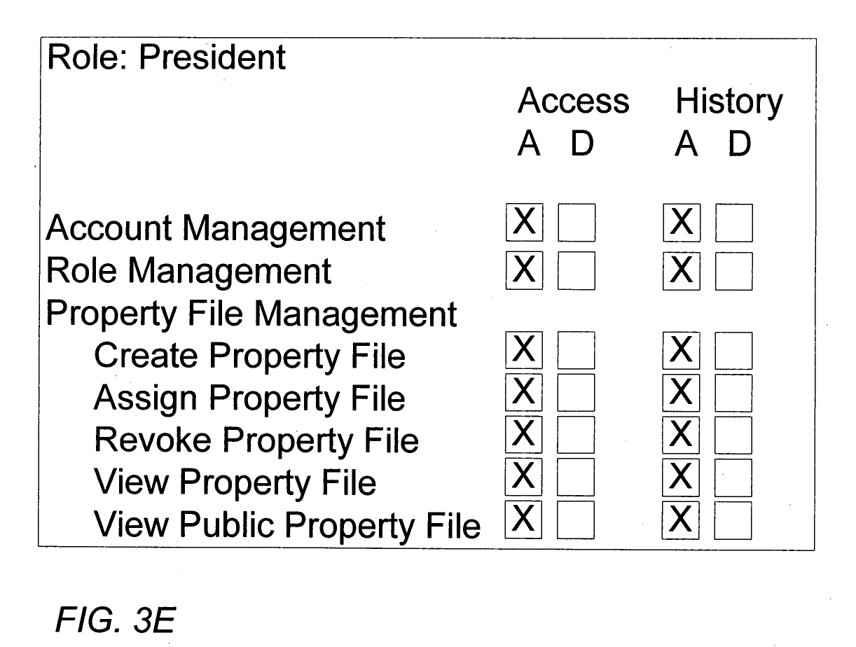

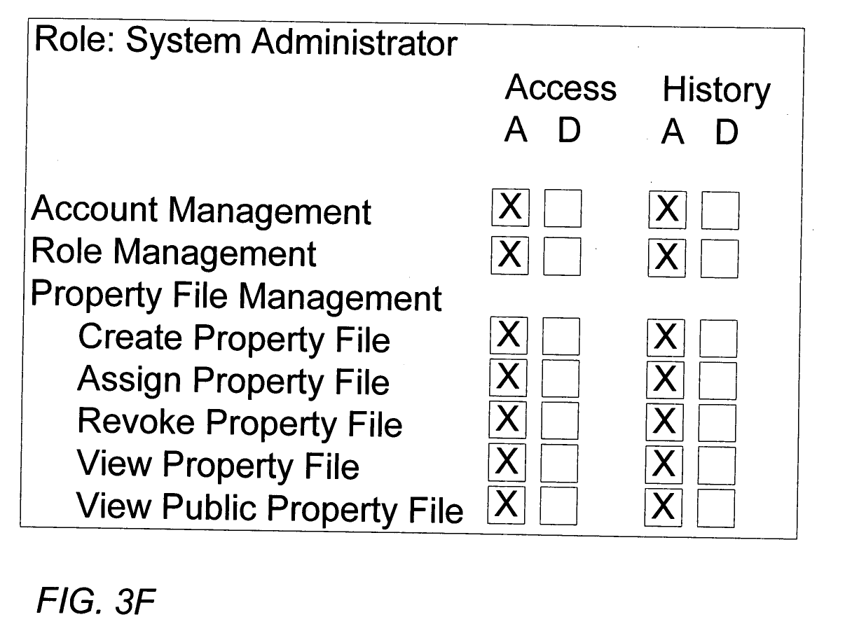

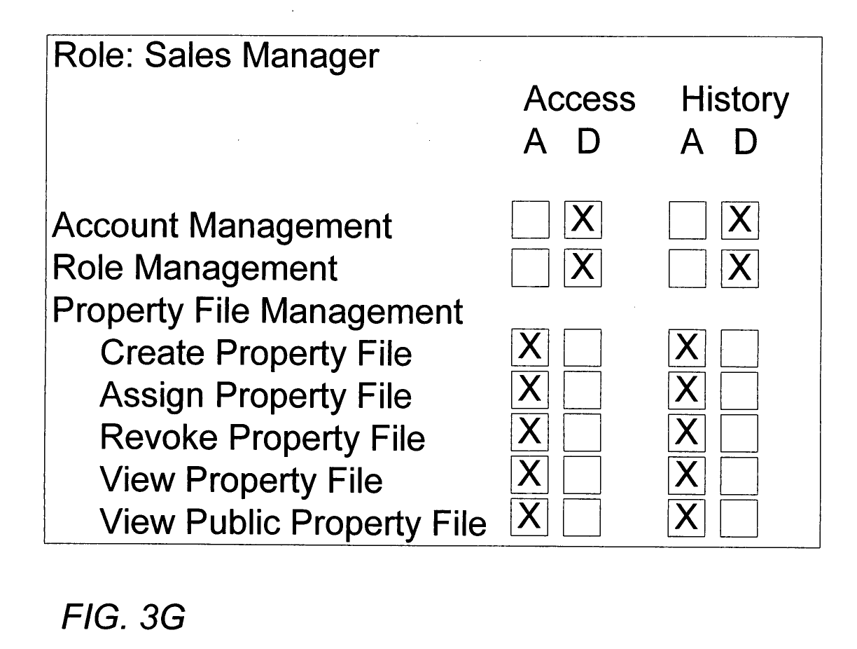

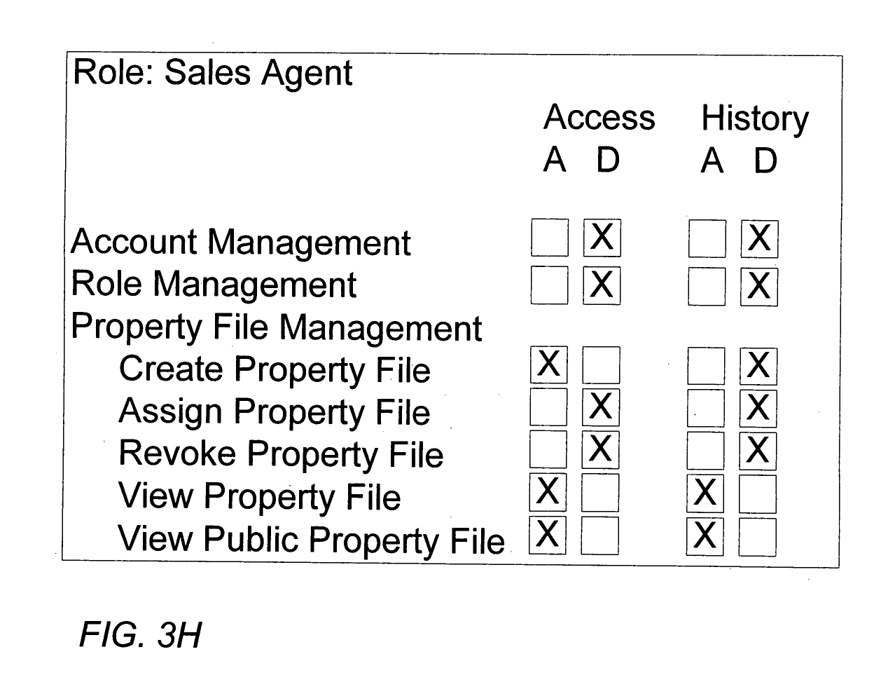

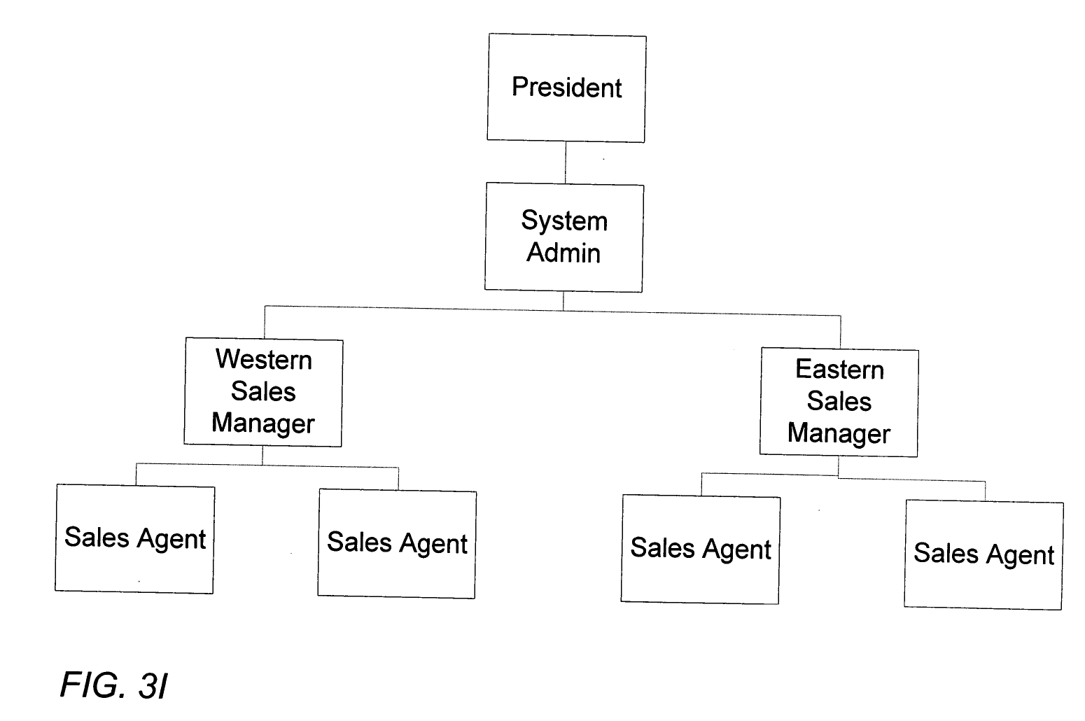

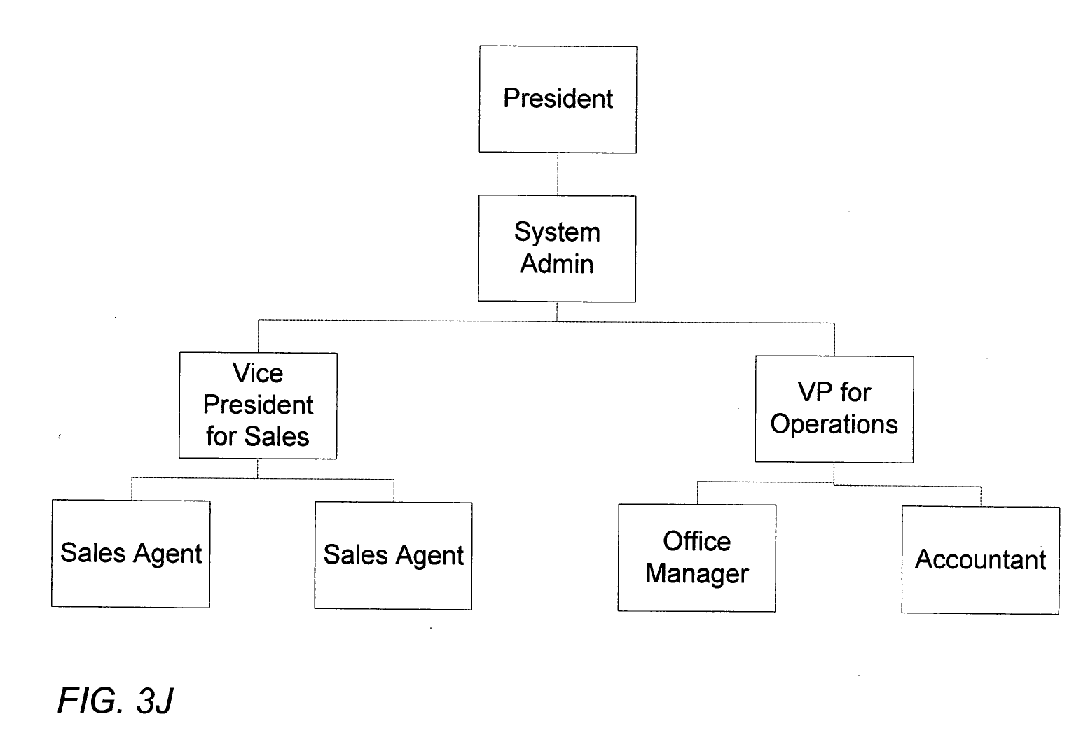

As illustrated in FIG. 3A, various types of accounts access the commercial real estate transaction system 110, according to an embodiment of the invention. The account types preferably include but are not limited to an individual member type, a company member type, a group member type, a guest member type, and a service provider type. Of course, other account types could be used.

Individual Member

In one embodiment, an individual member uses the property file application module 210 to create and use one or more property files 130. The individual member can advantageously use the property file access module 220 to grant access rights to others for using the individual's property files 130, to create a view using some or all of the portions of individual's property files 130, or both. Thus, the individual member “possesses” a property file 130 because the individual member has the administrative control of the access rights to the property files 130 it created.

Company Member

In one embodiment, a company member comprises one or more sub-account members operating under one company member account. The property file application module 210 is preferably used to create and use one or more property files 130 for the company member account.

The property file access module 220 can advantageously be used to create a hierarchy of access rights for creating and using a set of property files 130 under the company member account. The property file access module 220 is preferably used to grant access rights for using the property file 130 within the hierarchy of access rights. In one embodiment, the property file access module 220 is used to create a view comprising some or all of the portions of a set of property files 130 under the company member account. Thus, the company member “has possession of,” or has the administrative control of the access rights to, the property files 130 created under the company member account.

Group Member

FIG. 3B illustrates a group member account comprising two or more of individual accounts, company accounts, or a suitable combination thereof, in accordance with an embodiment of the invention.

In one embodiment, a company member account, a company member sub-account, an individual member account, or any suitable combination thereof use the commercial real estate transaction system 110 to create one or more property files by logging in under a group member account. The accounts that comprise the group member account preferably may use the one or more property files created under the group account.

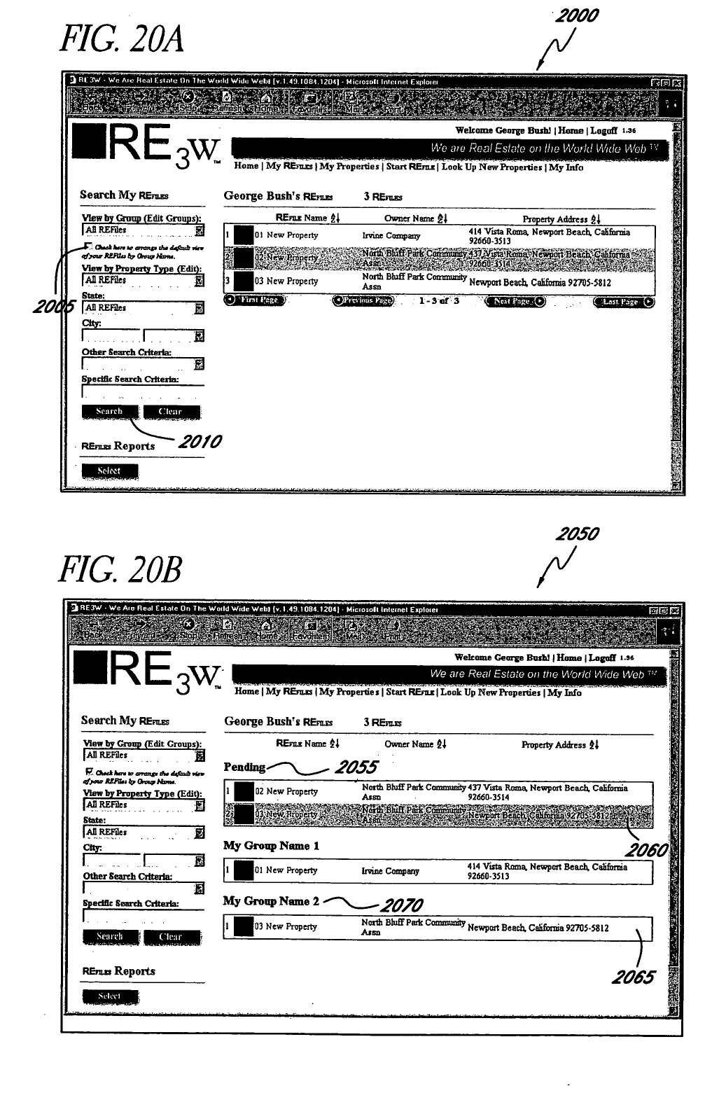

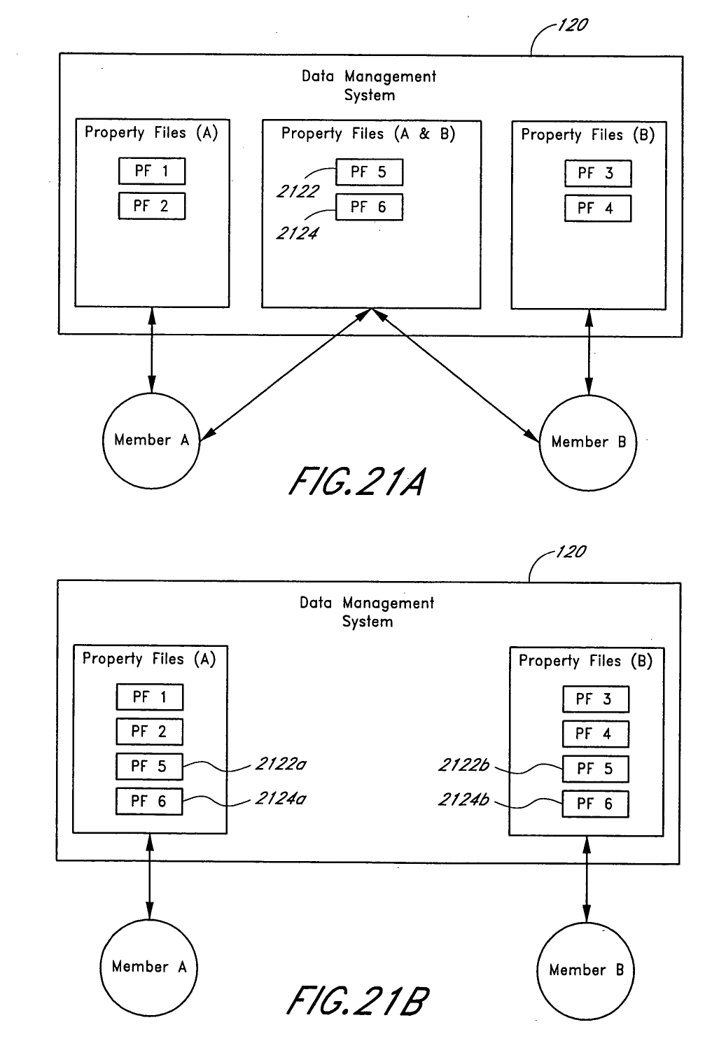

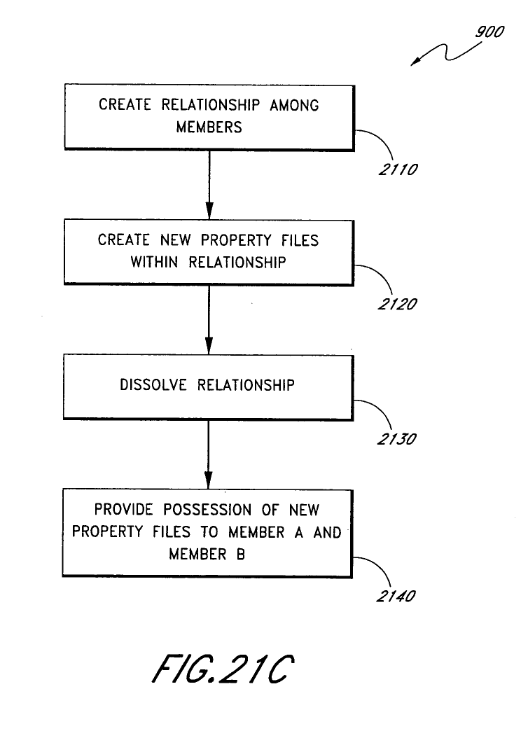

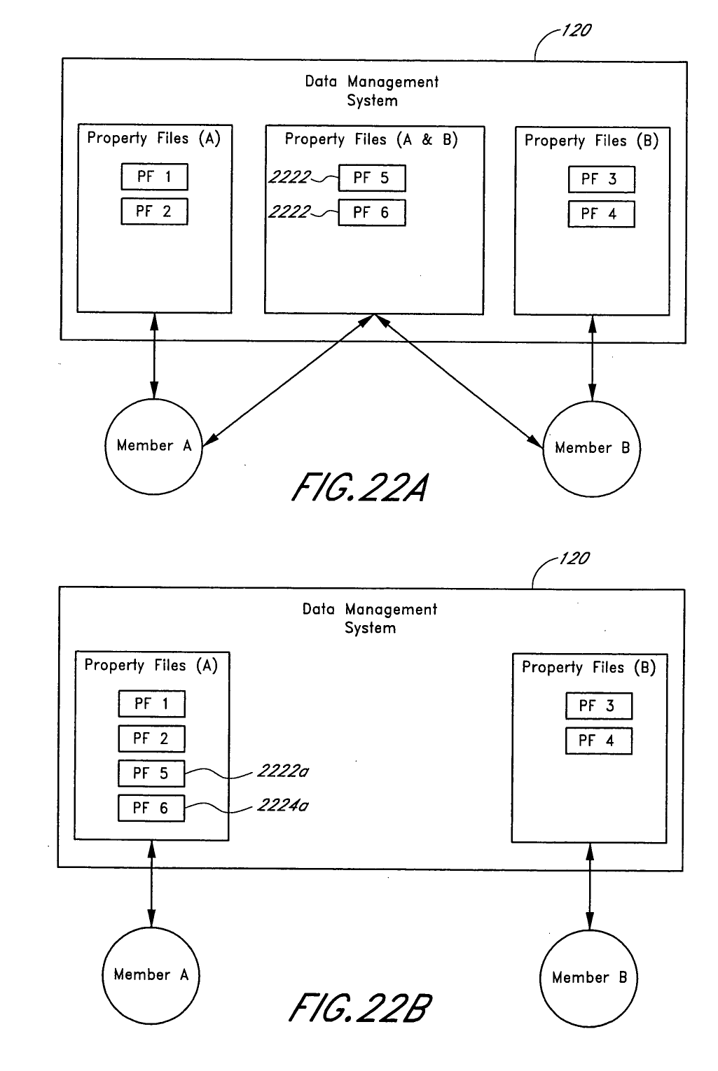

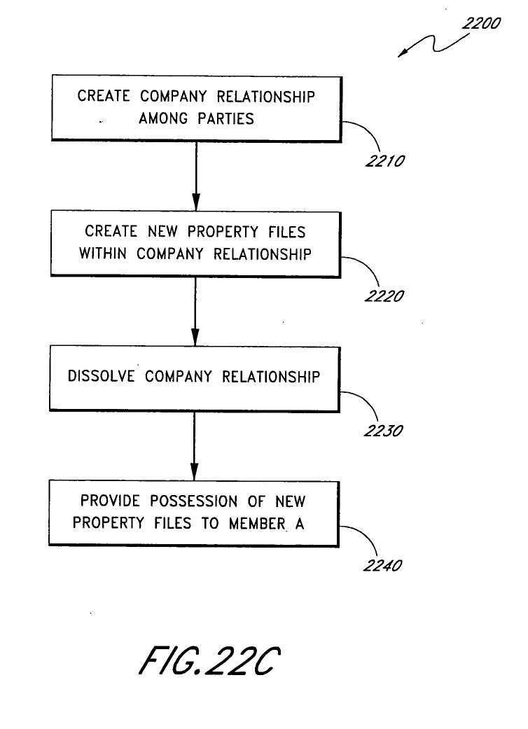

In one embodiment, when the group account is dissolved, one or more of the accounts retain access rights to copies of the one or more property files created under the group account in a manner substantially similar to that described herein with reference to FIGS. 21A, 21B, 21C; FIGS. 22A, 22B, 22C, or any suitable combination thereof.

Guest Member

In one embodiment, a guest member does not create property files 130. Rather, the guest member can advantageously use a property file, after a company member or an individual member creates a property file 130 and grants the guest member access rights to the property file 130. The creating member may advantageously use the property file access module 220 to create a view using some or all of the portions of one or more of the creating member's property files 130. In one embodiment, the guest may access services provided by one or more service provider accounts.

Service Provider

In one embodiment, a service provider with a service provider account preferably does not create property files 130. Rather, the service provider offers goods, services, or both to the member using a property file 130. The service provider with a service provider account preferably uses a property file, after a company member or an individual member creates a property file 130 and grants the guest member access rights to the property file 130. The creating member may advantageously use the property file access module 220 to create a view using some or all of the portions of one or more of the creating member's property files 130. As described in certain embodiments below, the results of the goods, services or both may advantageously be added to the content of the property file 130.

In one embodiment, the service provider with a service provider account offers goods, services, or both to guests. The guests can advantageously receive the results of the goods, services, or both via any suitable method, including but not limited to downloading, email, or the like. For example only and not to limit the scope of the invention, a guest might desire to order one or more aerial photographs from a service provider (e.g., a photographer).

In some instances, a service provider with a service provider account may wish to create property files 130 for its own purposes. For example, although a broker could offer services to members having property files 130, the broker may wish to create property files 130 for tracking prospective clients. Accordingly, in addition to a service provider account, the broker can advantageously create property files 130 by opening an individual account, a company account, or both. In another embodiment, a service provider account can create property files 130.

### Property File Access Management

In some embodiments of invention, a user uses the property file access module 220 to administer access rights to property files 130. The term “access rights” is a broad term, and is used in its ordinary sense, and further includes without limitation rights to view, add, delete, edit, import, export, upload, and download files (e.g., a property file) or some or all of the content of files. The user uses the property file access module 220 via one or more suitable accounts, including but not limited to a company member account, a company member sub-account, an individual account, or the like.

Access Rights Hierarchy

A company member account preferably comprises a company administrator account for administrating to property files 130 created under the company member account. The company administrator account preferably can create a tree hierarchy, such as, for example, the tree hierarchy 310 of FIG. 3C, that defines the set of property files 130 that a user can access or view. In one embodiment, each user is associated with a role pertaining to a node within the tree hierarchy. Preferably, when a user creates a property file 130, the property file 130 is associated with the node associated with the creating user. Thus, with reference to FIG. 3C, for example, if the user associated with the agent node 338 creates a property file, the created property file is associated with the agent node 338. Preferably, the position of each user's node within the tree hierarchy defines the set of property files 130 that the user can access. Specifically, in one embodiment, a user can access property files that are associated with the user's own node (e.g. the property files that the user created) and any property files that are associated with any node that descends from the user's own node. For example, in the example hierarchy 310, the user associated with the agent node 338 can access property files associated with the agent node 338, property files associated with the PF1 node, and property files associated with the PF2 node. However, the user associated with the agent node 338 cannot access the property files associated with the office manager node 334, because the node 334 is not a descendant of the agent node 338. Similarly, the user associated with the agent node 338 cannot access the property files associated with the PF3 node, even though the PF3 node is on a lower echelon of the hierarchy 310, because the PF3 node does not descend from the agent node 338. As will be appreciated by a skilled artisan in light of this disclosure, the foregoing access rules that are defined by the hierarchy 310 advantageously allow an organization to effectively allow access to property files according to an organization's real-world management hierarchy. For example, as illustrated, a president node 314 is at the top of hierarchy 310, meaning that a user associated with the president node 314 can access every property file that is created, regardless of which user creates the property file. Advantageously, the president node 314 can be assigned to a real-world user that is actually the president of an organization, such that the actual president will have access to every property file that is created using the system. Additionally, the foregoing hierarchical structure can be used to allow a sales manager to access the property files created by the sales agents that the sales manager supervises, for a regional manager to access the files created by the sales managers that the regional manager supervises in addition to those created by the sales agents supervised by each sales manager.

A skilled artisan will appreciate, in light of this disclosure, that the foregoing hierarchical structure preferably lines up with real-world hierarchies and therefore enforces real-world intuitive principles concerning who in an organization should be granted access to information. A skilled artisan will also appreciate, however, that real-world cases can arise in which users may desire to depart from ordinary rules while generally maintaining the overall hierarchical rules. For example, a sales manager may, in his or her supervisory duties, have occasion to create a property file but not subsequently update the property file. For example, at times a sales manager may create a property file but then assign a sales agent that the sales manager supervises to perform subsequent management of and updates to the property file. In order to accommodate such situations, in one embodiment, a user can create a property file and associate the property file with either the creator's node or with any node that descends from the creator's node (e.g. any node to which the creator has access rights.) Additionally or alternatively, in one embodiment, a user can create a property file in any node to which he or she has access and then later re-associate the property file with another node. A skilled artisan will appreciate, in light of this disclosure, that there exist a number of ways in which a user can create a property file and have the property file associated with another user's node. Embodiments of the invention encompass all such ways understood by a skilled artisan in light of this disclosure, and the invention is not limited to the foregoing embodiments.

FIG. 3C illustrates a hierarchy 310 according to one embodiment of the invention for an illustrated company. Because a president 314 has company-wide responsibility, the hierarchy 310 is configured that the president 314 can use property files 130 created within each sub-tree of the hierarchy 310 (e.g., subtree 318, subtree 322). Because a regional manager 326 has region-based responsibility, the hierarchy 310 is configured that the regional manager 326 can use property files 130 within a region sub-tree (e.g., sub-tree 318). Because an office manager 334 has office-wide responsibility, the hierarchy 310 is configured that the office manager 334 can use property files 130 within a office sub-tree (e.g., sub-tree 330). In a situation wherein the region sub-tree 318 comprises two or more office sub-trees, the hierarchy 310 is configured that the regional manager can use the property files 130 within the two or more office sub-trees. The hierarchy 310 is configured that an agent 338 can use one or more property files 130 within an agent sub-tree 342. In another situation, the hierarchy 310 is configured that the agent 338 can use one or more property files 130 within the office sub-tree 330. Thus, the hierarchy 310 may advantageously be used to create a tree hierarchy defining the property files 130 that one or more user accounts may access.

The company administrator account preferably can create one or more roles for use within some or all portions of a tree hierarchy. The roles preferably comprise a set of rights to use (e.g., view, add, delete, edit, import, export or the like) the content of the property files 130 within a specified tree or sub-tree.

In one embodiment, the company administrator account creates one or more “views” comprising some or all of the content of a property file 130. Roles may comprise one or more sets of rights associated with one or more views. A view may optionally comprise a set of one or more tabs, portions of tabs, or both in a property file 130 that has tabs.

For example only and not to limit the scope of the invention, the hierarchy 310 comprises an office sub-tree 342. The company administrator account advantageously creates an “office manager” role having rights to view, add, delete, edit, import, export content from property files 130. The company administrator account advantageously creates a company sub-account for an office manager 346. The company administrator account advantageously associates the sub-account for the office manager 346 with the office manager role and with the office sub-tree 342. Accordingly, the office manager 345 may view, add, delete, edit, import, export content from property files 130 within office sub-tree 342.

For example only and not to limit the scope of the invention, the company administrator account advantageously creates an “assistant” role having rights to view content from property files 130. The company administrator account advantageously creates a company sub-account for an assistant 350 to the office manager 346. The company administrator account advantageously associates the sub-account for the assistant 350 with the assistant role and with the office sub-tree 342. Accordingly, the assistant 350 may view content from property files 130 within the office sub-tree 342.

For example only and not to limit the scope of the invention, the company administrator account advantageously creates an “appraiser” role. The company administrator account gives the appraiser role rights to view suitable portions of a property file 130 (e.g., property description, location, exterior photographs, interior photographs, or the like). The company administrator account gives the appraiser role rights to upload an appraisal into a portion of the property file 130. In one embodiment, an appraiser 354 has a service provider account. The company administrator account advantageously associates the service provider account for the appraiser 354 with the appraiser role and with the office sub-tree 342. Accordingly, the appraiser 354 may view the suitable content from property files 130 within the office sub-tree 342 and upload appraisals to the property files 130.

For example only and not to limit the scope of the invention, the company administrator account advantageously creates a “client” role. The company administrator account gives the client role rights to view limited portions of a property file 130 (e.g., exterior photographs, interior photographs, or the like). In one embodiment, a client 358 has a guest account. The company administrator account advantageously associates the guest account for the client 358 with the client role and with the agent sub-tree 342. Accordingly, the client 358 may view the suitable content from property files 130 within the agent sub-tree 342. In the situation where a client is motivated to purchase a property after viewing the suitable content from property files 130 within the agent sub-tree 342, the client and agent may sign a representation contract or the like.

In one embodiment, the company administrator account creates an administrator role that has administrative rights to create roles, manage roles, create views, manage views, create sub-accounts, manage sub-accounts, or any suitable combination thereof for a set of property files 130. Accordingly, in one situation, the company administrator account advantageously associates the sub-account for the office manager 346 with the office manager role for the office sub-tree 342 and with administrator role for the office sub-tree 342. Accordingly, the office manager 346 may act as an administrator for the office sub-tree 342. A sub-account may have any suitable number of roles associated with any suitable number of property files 130.

In one embodiment, a company administrator account comprises a company sub-account having an associated “company administrator” role, which has administrative rights to create roles, manage roles, create views, manage views, create sub-accounts, manage sub-accounts, or any suitable combination thereof for the property files 130 of the company. One or more sub-accounts are preferably associated with the company administrator role. At creation of the company member account, the company member account may optionally be assigned the company administrator role.

The company member account preferably retains control of the property files 130 created under the company member account. For example only and not to limit the scope of the invention, the company administrator account creates a sub-account for an employee, who subsequently creates a set of property files 130. However, because of business reasons, the company must layoff the employee, and the company administrator account deletes the sub-account for the employee. The employee no longer has access to the property files 130 that the employee created; however, the company account still does. Thus, the company administrator account can advantageously grant access rights to the property files 130 to a second employee.

As indicated, a number of different roles can be associated with each user. Each role allows each user to perform some action within embodiments of the invention, such as, for example, modifying a role, assigning a role, creating or changing a hierarchy, creating, modifying, viewing, or deleting property files or portions of property files, or the like. A skilled artisan will appreciate in light of this disclosure, that a large number of actions can be performed within embodiments of the invention, and that every potential action can be made subject to access restrictions defined by the foregoing roles. FIG. 3D illustrates an example screen shot of one embodiment in which many actions and associated access rights are listed. The illustrated list is by way of example only; embodiments make many more actions that are not illustrated subject to access restrictions and access rights.

As illustrated in FIG. 3D, access rights can be allowed or denied and event history rights can be allowed or denied. Generally, access rights, if allowed, allow a user to actually perform the action that is the subject of the access right. For example, with regard to the “Create Hierarchy” action, a user that has this action allowed can create a new hierarchy node. A user that has this action denied cannot create a new hierarchy node. Event history rights, on the other hand, do not allow a user to actually perform an action, but allow the user to view a log, or event history, of any action that has been performed by any user on the system. For example, if a system administrator has “allowed” checked for the event history of the “Create Hierarchy” action, the system administrator is allowed to execute reports that show which members attempted to create a new hierarchy node, when such attempts occurred, whether the attempt succeeded, which nodes were created if the attempt succeeded, other details regarding the creation of a hierarchy node, and the like. In one embodiment, access rights and event history rights are associated with roles, not with individual users. Thus, in this embodiment, a role, such as, for example, “President” or “Sales Agent” can have specific access and event history rights. In this embodiment, a user has the rights that are associated with the user's role, such that, for example, if a user has the role of “President,” the user has the rights assigned to the “President” role. Advantageously, changing a user's role, such as when a user receives a promotion from “Sales Agent” to “Sales Manager,” quickly allows the user to have a different level of access in accordance with his or her new role. Nevertheless, a skilled artisan will appreciate, in light of this disclosure, how access rights can be assigned, in alternative embodiments, on an individual user basis.

A system administrator will appreciate, in light of the larger number of access rights and event history rights depicted on FIG. 3C, that associating access rights and event history rights for each role can be a complex and potentially time-consuming task. Indeed, FIG. 3C is merely an illustrative example of some access rights and event history rights that can be associated. Many embodiments allow for the association of many more access rights and event history rights than are illustrated. Additionally, a system administrator will appreciate that the simplified hierarchy 310 represents only one of many possible organizational structures. Furthermore, an organizational structure for most organizations, especially large organizations, will be much more complex than represented by the hierarchy 310. For this reason, a system administrator will appreciate that creating an hierarchy like the hierarchy 310 can be a complex and potentially time-consuming task.

Accordingly, in one embodiment the data management system 120 comprises a template management module. In one embodiment, the template management module comprises a large number of pre-defined roles that can be associated with a hierarchy 310. FIGS. 3E through 3H are simplified examples of pre-defined roles that are provided by the template management module. In one embodiment, one pre-defined template defines a “President” role. As illustrated by FIG. 3E, the “President” role, in one embodiment, is allowed to access everything and is allowed to view an event history for everything. In one embodiment, another pre-defined template defines a “System Administrator” role. As illustrated by FIG. 3F, the “System Administrator” role, in one embodiment, is allowed to access everything and is allowed to view an event history for everything. While system administrators are typically not officers of an organization and sometimes lower-level staff of an organization, it is desirable in many cases for a system administrator to have a lot of access to operations of the data management system 120. For example, at times a system administrator may be asked to fix an error in data stored in the data management system 120. System administrators often are more able to correct certain errors than are sales managers, sales agents, and presidents. As such, while system administrators typically do not “need to know” actual data related to properties, system administrators sometimes do “need to know” such data in the sense that they must access the data in order to perform system maintenance, error correction, and the like. Despite the foregoing, some organizations may determine that it is a security risk to let system administrators access key strategic data regarding property files. Therefore, in embodiments the template management module provides one or more “System Administrator” roles that give restricted privileges to system administrators. Additionally, as will be described hereinafter, in one embodiment a user can modify the pre-defined roles and can manually restrict a system administrator's privileges.

FIG. 3G illustrates a “Sales Manager” role that, in one embodiment, grants full access to tasks related to the management of property files. As illustrated, such tasks include, for example, creating a property file, assigning a property file, revoking a property file, viewing a property file, and viewing a public portion of a property file. Advantageously, by having access to assigning property files and revoking property files, a sales manager can designate which of the sales agents that he or she supervises is in charge of a particular property file. FIG. 3H illustrates a “Sales Agent” role that, in one embodiment, grants limited rights related to property files to a sales agent. For example, a sales agent can create a property file, but cannot view an event history for a property file. Additionally, a sales agent can view property files, view public portions of property files, view event histories of when property files are viewed, and view event histories of when public portions of property files are viewed. Advantageously, by viewing an event history of when a property file has been viewed, a sales agent can monitor potential customers' interest in a particular property file.

Additionally, in one embodiment, the template management module provides access to a large number of pre-defined organizational hierarchy templates. Preferably, the pre-defined organizational hierarchy templates provided by the template management module include organizational structures that are typical of many organizations, such that a user is able to select an organizational structure that is at least similar to the organizational structure of the user's organization. FIGS. 31 and 3J are simplified illustrations of two organizational hierarchy templates such as the organizational hierarchy templates provided by the template management module. A skilled artisan will appreciate, in light of this disclosure, that many organizational structures are far more complex than the illustrated structures. As such, the illustrated organizational hierarchy templates are intended to illustrate the concept of an organizational hierarchy template as provided by the template management module and in no way limit the invention to organizational hierarchy templates that are of similar complexity. A skilled artisan will appreciate, from this disclosure, that embodiments of the template management module provide access to organizational hierarchy templates that are more complex than those illustrated, including, for example, organizational hierarchy templates that have hundreds of nodes.

FIG. 3I illustrates an organizational hierarchy template that represents a sales organization with a geographical division of labor. As illustrated, the organization of FIG. 3I has a Western Sales Manager and an Eastern Sales Manager. Each sales manager is responsible for supervising two sales agents. FIG. 3J illustrates an organizational hierarchy template that represents an organization that has a vice president over sales and a vice president over operations. The vice president for sales is responsible for supervising a sales force, which in this simplified example comprises two sales agents. A skilled artisan will appreciate, in light of this disclosure, that in many organizations the sales force can be much more complex, comprising, for example, multiple managers, multiple sales agents, and the like.

Advantageously, in one embodiment each node of each organizational hierarchy template corresponds to a role, such as, for example, “President,” “Sales Manager,” “Sales Agent,” and the like. Advantageously, in one embodiment, each role on each organizational hierarchy template has a corresponding pre-defined template that defines the role's access privileges. In an advantageous embodiment, a user can initially set up an organization by selecting an organizational hierarchy template that is at least similar to the user's organization. In one embodiment, the template management module provides editing tools that allow a user to modify the organization of the selected pre-defined template. Advantageously, therefore, to the extent that the real-world hierarchy of the user's organization is different from the pre-defined hierarchy template, the user can modify the template to more closely match the user's real-world organization. For example, with reference to FIG. 3I, if an organization does not have a system administrator, the user can delete the “System Admin” node from the hierarchy template. In one embodiment, the template management module allows the user to make such modifications graphically, such as, for example, by dragging and dropping nodes to add or delete them, selecting role names from a pick list or another selection tool to associate a role with a node, drawing a line from one node to another to establish descendency of nodes, and the like. A skilled artisan will appreciate, in light of this disclosure, how an assortment of commonly used graphical user interface tools can be used to allow a user to graphically modify a hierarchy template. Alternatively or additionally, non-graphical tools, such as, for example, menus with selections keyed to particular keys on a keyboard, can be used.

Upon using the template management module to select an organizational hierarchy and to associate roles with the hierarchy, the user can modify either the selected hierarchy or the associated roles, or both. In one embodiment, to modify an associated role, the user selects a role to be modified, such as by double-clicking on a node that is associated with the role. Upon selection of a role, the template management module presents to the user a list of privileges associated with the selected role, such as, for example, a list like that illustrated by FIG. 3D. As illustrated, such a list has a number of checkboxes that the user can check or uncheck using any graphical or non-graphical technique known in the art or that becomes known in the art.

Advantageously, embodiments of the template management module as described allow a user to more quickly set up an electronic organizational structure within the data management system 120. Consequently, the template management module enables organizations to use the powerful features of the data management system 120 without becoming bogged down with complex administrative tasks.

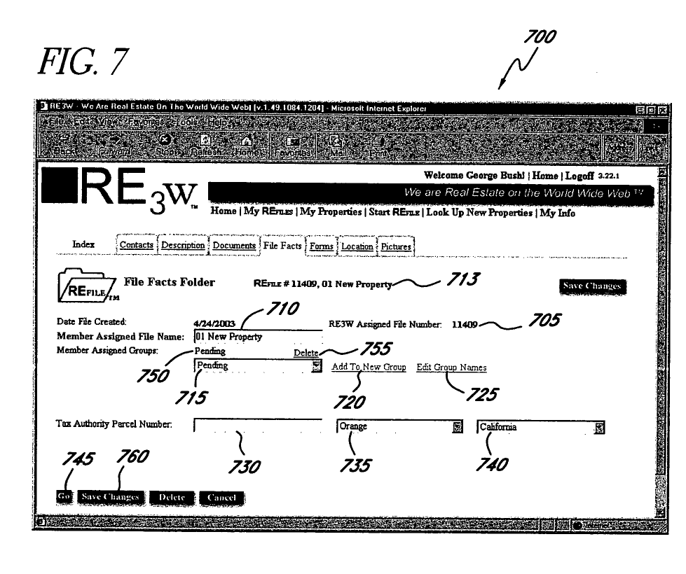

Referring again to FIG. 3C, although FIG. 3C illustrates the hierarchy 310 as having a tree structure, any suitable structure other than a tree hierarchy may be used to administer access rights, sub-accounts, views, or the like. In one embodiment, property files 130 are associated with a property file group, as described with reference to FIG. 7. Access rights, sub-accounts, views, or the like may be administered with reference to a property file group in a manner substantially similar to that described with reference to FIG. 3C.

Further, although FIG. 3C illustrates the hierarchy 310 in the context of a company member, in one embodiment, an individual member may administer access rights, views, or the like to the individual member's property files 130, or subsets of the individual member's property files 130, in a manner substantially similar to that described with reference to FIG. 3C.

In one embodiment, an account (e.g., an individual member, a company member, a company sub-account, a guest member, a service provider) may be associated with a plurality of roles for a plurality of sets of property files 130. In one embodiment, the account has similar roles, different roles, or both among the plurality of sets of property files 130, which sets may be different (e.g., mutually exclusive, not mutually inclusive) or the same (e.g., mutually inclusive).

In one embodiment, an access rights hierarchy can be defined in order to grant a different level of access to different geographically-based workgroups. Advantageously, such an access rights hierarchy allows a real estate sales organization to establish one team in Orange County that has access to properties in Orange County and another team in San Diego that has access to properties in San Diego. Advantageously, according to one embodiment, different levels of access can be established such that, for example, the Orange County team may be granted privileges to view, but not modify, the property files of the San Diego team. Additionally or alternatively, an individual might be assigned a supervisory role in Orange County, with all rights to access all Orange County data, but a much more limited role to view property files associated with San Diego. Advantageously, therefore, an access rights hierarchy can be used to define flexible roles across a geographically diverse organization.

Advantageously, embodiments of the access rights hierarchy allow one role to be assigned to different users while still providing secure access to individual files for each user with the same role. For example, many real estate organizations have multiple vice presidents. While it is appropriate for each vice president to have a “Vice President” role, it is also appropriate in some cases to prevent one vice president from accessing another vice president's property files. Such may be the case, for example, when an organization has a vice president for an east region and a vice president for a west region. In such a case, it may be appropriate for the vice president of the East to access property files that relate to sales in the East and for the vice president of the West to access property files that relate to sales in the West. Using the access rights hierarchy as disclosed herein, a user can accomplish this by assigning the “Vice President” role to both vice presidents, but assigning a separate node in the access rights hierarchy to each vice president. As such, embodiments of the access rights hierarchy are advantageously adapted to the needs of real estate organizations.

In one embodiment, a plurality of accounts are associated with the same role for a set of property files 130. Accordingly, each account has the same access rights defined within that role for that set of property files 130.

In one embodiment, a user associates a first account with a role for a set of property files 130 and later removes that association. Accordingly, the first account no longer has the access rights within that role for that set of property files 130. For example only and not to limit the scope of the invention, in one situation, an individual member is an owner seeking representation in a sale transaction of a property. The individual member creates a “broker” role having suitable access rights to a property file 130 for the property. A broker has a service provider account. The individual member advantageously associates the service provider account for the broker with the broker role for the property file 130. Accordingly, the broker may use the suitable content from the property file 130. Upon dissatisfaction with the broker's services, the individual member advantageously removes the service provider account for the broker from the broker role for the property file 130. The individual member advantageously reassigns the broker role for the property file 130 to a second service provider account.

In one embodiment, a member may advantageously use the website 410 to grant access to a view to some or all of the members; the member may directly or indirectly invite one or more members to access the views. The view may be used for any suitable purpose, including but not limited to a for-sale listing, a for-lease listing, a property submittal package for a lender, equity investor submissions, submission to a tenant, or the like. In one embodiment, a member may use the website to select one or more members (e.g., developers, investors) and submit a view directly to the selected group. For example only and not to limit the scope of an invention, a developer or a property owner may advantageously submit a view to a group of tenants. Any appropriate member may create a view, including but not limited to developers, investors, sellers, governmental entities, or the like.

In one embodiment, the website 410 includes a searchable database of for-sale listing and displays the results of a related search. The for-sale searches may be performed using any suitable criteria (e.g., property type, property size, price range, location or the like). The for-sale listings are preferably viewable by some or all members and preferably include an asking price. The website 410 preferably includes a searchable database of for-lease listing and displays the results of a related search. The for-lease searches may be performed using any suitable criteria, including information contained within the associated property files (e.g., property type, property size, price range, location or the like). The for-lease listings are preferably viewable by some or all members and preferably include an asking price.

In one embodiment, the website 410 includes for-sale listings that are judicially originated (e.g., bankruptcy, estate, foreclosure sales, or the like).

In one embodiment, a member may share access to content in one or more property files to other parties (e.g., developers, investors, lenders, equity investors, or the like). Any suitable content may be shared, including but not limited to financial information. Access may include any suitable combination of viewing, editing, exporting, adding, or the like. Access rights may vary according to the type of party.

### Members

A member account may be used by any suitable industry participant, including but not limited to an owner (or investor), a developer, a broker, a client of a broker, or the like. Such participants may advantageously use the commercial real estate transaction system 110 for any suitable purpose such as tracking properties they already own, tracking properties for future acquisition, viewing properties, or the like. Further, an industry participant (e.g., a broker or the like) may advantageously use the commercial real estate transaction system 110 for future marketing of goods, services, or both to property owners. A member account may use the commercial real estate transaction system 110 for any other suitable purpose, whether for commercial real estate, for residential real estate, or for non-real estate purposes.

An investor member or owner member preferably uses the commercial real estate transaction system 110 for creating a property file 130 for each property that the member owns. When a plurality of investors or owners own a property, the commercial real estate transaction system 110 can advantageously provide each with access to the related property file (e.g., they may be given equal access rights to the file). Accordingly, the plurality of investors or owners can have the same, current information on the property. The property file 130 preferably includes the information about that particular property that the investor or owner possesses. The investor or owner may advantageously add information to a property file 130 by accessing goods, services, or both from a service provider, as described herein.

An investor or owner may use the commercial real estate transaction system 110 to generate reports, presentations or the like from information in the property file 130. For example, when the investor or owner desires to sell a property, the investor or owner selects a report function that generates a related sales presentation and due diligence package. In one embodiment, when an investor or owner sells a parcel of property, the contents of the seller's property file 130 for the parcel may be merged with the purchaser's property file 130 for the parcel. The merged contents preferably include history data associated with the property file 130. A seller may maintain a property file 130 for any suitable purpose, including but not limited to for tax or partnership needs.

An investor member, a developer member, or a broker member preferably uses the commercial real estate transaction system 110 for creating a property file 130 for each property of interest, such as for acquisition. The member begins the origination process by identifying possible properties that meet certain requirements of each individual member, identifying the property owner, and contacting the property owner. In one embodiment, the member uses a property file contact management system to contact the property owner, as described herein. An investor member, a developer member, or a broker member may advantageously add content to a property file 130 by accessing goods, services, or both from a service provider, as described herein. For example, the member may access any suitable service including but not limited to deeds, title reports, or the like. Accordingly, the member can gain a better understanding of the property without directly contacting the property owner. As discussed above, in one embodiment, when an investor or owner sells a property, the contents of the property file 130 of the seller may advantageously be merged into the property file 130 of the purchaser (e.g., the investor, developer, or the like).

A broker member may advantageously use the commercial real estate transaction system 110 to build a list of properties of interest (e.g., representation for purchase by a client, representation for leasing, representation for sale, or the like). Accordingly, the broker member may rapidly gather information on a portfolio of properties. This portfolio of property files becomes a valuable asset for the broker member. As discussed below, in some embodiments, the broker member may advantageously retain the possession of the portfolio of property files, depending on the type of relationship (if any) under which the files were created. For example, a broker may create a company member account in which possession of the property files created under the company member account will remain with the company. Accordingly, independent contract agents or employees are less likely to leave with the company's information assets as kept in the company's property files 130.

The guest member can advantageously use a property file, after a company member or an individual member creates a property file 130 and grants the guest member access rights to the property file 130. For example, a broker may create a guest member account for the broker's client. When the broker identifies a property for the client, the broker creates a corresponding property file 130 and grants his client's guest member account access rights to the property file 130. However, the broker might be comfortable allowing the client to view some basic information, photographs, or the like, but not to view ownership information. Accordingly, the broker may create a view of the property file 130 to limit the contents shown to the client. After the view is created, the broker can advantageously use the commercial real estate transaction system 110 to submit the view for the client's acceptance. Once accepted, the client can view the allowed portions of the property file. Of course, if the client is interested in the property, the broker could seek the right (e.g., exclusive, non-exclusive) to represent the client in the possible acquisition of the property for a suitable period of time.

### Providing Content

As illustrated in FIG. 3C, a service provider with a service provider account uses the commercial real estate transaction system 110 to provide content to a guest, to a member having possession of a property file 130, or both. The term “content” is a broad term, and is used in its ordinary sense, and further includes without limitation goods, services, work product, data or the like. As illustrated in FIG. 1, examples of service providers include but are not limited to include accountants, appraisers, attorneys, architects, engineers, contractors, brokers, escrow companies, title companies, financial companies, insurance companies, marketing companies, governmental entities, photographers, property managers, or the like. Of course, any other suitable service provider, shown or not shown in FIG. 1, may use the commercial real estate transaction system 110.

A service provider may advantageously use a service provider account to use the commercial real estate transaction system 110 for providing content. In some situations, a service provider may provide a service that results in the creation of work product (e.g., a photographer's photographs, an attorney's contract, an appraiser's appraisal, or the like), provide data (e.g., ownership information, sales information, tax information) or the like regarding a property, or provide a product (e.g., a title report, title insurance) or the like, which are preferably added to the property file. When providing content to a guest member, the service provider may advantageously transmit the content directly to the guest member.

FIG. 4 illustrates a website 410 hosted by a web server 415 according to one embodiment. A user accesses the website 410 using a web browser operating on any suitable device such as a personal computer 420, a laptop 425, a personal digital assistant 430, a portable computing device (not shown), or the like.

The user preferably accesses the functionality of the commercial real estate transaction system 110, the data management system 120, the property file application module 210, the property file access module 220, and the property file relationship management module 230 using a web browser. In another embodiment, any suitable method may be used to access and implement such functionality, including but not limited to a client module (e.g., a rich client) operating on the personal computer 420, the laptop 425, the personal digital assistant 430, or the like and communicating with a remote server module.

Web Server—depending upon the context, is (a) a program that, using the client/server model and the World Wide Web's Hypertext Transfer Protocol (HTTP), serves the files that form Web pages to Web users (whose computers contain HTTP clients that forward their requests), or (b) a computer connected to the Internet on which a Web server program operates. Generally, a server is a computer or program that controls a central repository of data that can be downloaded and manipulated in some manner by a client.

The web server 415 comprises the data management system 120 and accesses a database 435 or other suitable storage for storing data (e.g., membership account data, access rights data, property-related data, or any other suitable data) used by the data management system 120. In one embodiment, the database 435 comprises a plurality of databases for storing data used by the data management system 120. In one embodiment, the database 435 comprises a database of statically-stored, property-related data and a database of membership account data and access rights data. Any suitable combination of data can be stored in any suitable location.

FIG. 4 illustrates an XML system 440 comprising an XML server 445, according to an embodiment of the invention. In one embodiment, the XML system 445 accesses a source of information, content or the like stored in a database 450 or other suitable storage. In one embodiment, data stored in the database 435 or the database 450 or both is provided by or derived from data provided by First American Real Estate Solutions (“FARES”). A skilled artisan will appreciate, in light of this disclosure, that the data can be provided by other providers of such data.

In one embodiment, the database 450 comprises dynamically-stored, property-related data and the database 435 comprises a database of statically-stored, property-related data; a user preferably executes a search of the property-related data in the database 435, the property-related data in the database 450, or both. In response to the search, some of all of the data identified in the search is incorporated into a property file 130 using any suitable method.

Advantageously, the system can perform initial searches on the static database 435. Performing initial searches, such as to find a particular property at a particular address, owned by a particular owner, or the like, on a static database 435 increases the speed of searching, because the static database 435 is local to the website 410 and can therefore be searched without requiring a substantial amount of network traffic. Additionally, the static database 435 includes a large amount of data about properties, such as, for example, addresses, zoning, buildings on the property, square footage of the parcel and of the buildings, and the like, that are relatively constant and not likely to change on a regular basis. Accordingly, the static database 435 provides sufficient information to perform initial searches while requiring minimal updates. While requiring few updates is generally advantageous, a skilled artisan will appreciate that periodic updates can nevertheless be performed and can nevertheless be advantageous.

In one embodiment, after an initial search is performed using the static database 435, an XML query can be used to retrieve updated information from a dynamic database 450. Preferably, the dynamic database 450 is kept up-to-date by entering property information as soon as it becomes available or shortly thereafter. Preferably, the dynamic database 450 is used for finding the most up-to-date information about a particular property, not for searching a large number of records for identifying properties that meet specific criteria. Preferably, using the dynamic database 450 for updates allows for queries to the dynamic database 450 that are relatively less complex than if the dynamic database 450 were used for performing initial searches. Upon receiving updated information about a particular property from the dynamic database 450, the data management system 120 prompts a user as to whether the local property files 130 should be updated to reflect the new information. For example, the database 435 might indicate that Owner A owns a certain property, but a sales transaction from Owner A to Owner B of the certain property might be reflected in the dynamic database 450. In such case, the data management system 120 performs an XML update, determines that Owner B, not Owner A, is the true owner of the specific property, and allows the user to have the local property file 130 updated to reflect the change of ownership. Preferably, the data management system 120 includes an update button that a user may select that causes the data management system 120 to request, from the XML Server 445, an XML update for one or more property files 130. Alternatively, the data management system 120 can be configured to automatically and periodically request an XML update for each property file.

In one embodiment, the website 410 maintains information that specifies, for each member, a type of data stored in the database 435 or the supplemental content database 450, that each member can access. In one embodiment, the website 410 grants such access, member-by-member, on a subscription basis. In one embodiment, a user accesses the website 410, and using the tools provided by the data management system 120, selects particular content or subscription services that the user desires each member to access. In this context, the user may be an administrator that signs up each member for particular subscriptions or the user may be a member himself or herself. In one embodiment, the subscription services offered by the website 410 can be classified according to geography, property type, property value, and the like. For example, in one embodiment, a user can purchase a subscription for all available real estate information in a particular geographical region, such as, for example, all of the state of California. Alternatively or additionally, a user can purchase a subscription for all real estate information in the entire United States. Geographical subscriptions can be defined by neighborhood, borough, city, county, state, region, country, or any other geographical subdivision. In a preferred embodiment, each geographical subscription, is defined by county. Alternatively or additionally, in one embodiment, a subscription can be restricted to particular real estate data, such that, for example, in one subscription a member might be limited to viewing tax records about each parcel, while in another subscription a member might be able to view both tax records and parcel maps. A skilled artisan will appreciate, in light of this disclosure, that there exist a vast number of ways in which data can be grouped in order to create an vast number of different subscription plans. Each of these data groups and subscription plans are encompassed by this disclosure.

In one advantageous embodiment, the website 410 requires the payment of a fee for each subscription. Additionally, in one embodiment, the website 410 maintains information concerning when a subscription expires, which may be, for example, one year from a subscription sign up date. In one preferred embodiment, the website 410 denies access to the data covered by the subscription plan when any associated fees are not paid or when the subscription plan has expired. Advantageously, in one embodiment, subscriptions may be assigned to either individual members or company members. In one embodiment, any member associated with a company membership can access the subscriptions that are accessible to the company membership. In one embodiment, access rights can be appropriately set to restrict access to certain information to certain members. Advantageously, the foregoing embodiments allow for great flexibility in setting up subscription plans for each member, each company, and the like, and for tailoring the type of content that should be accessible to each individual or group within a company. Also advantageously, the foregoing embodiments allow the operator of the website 410 to assess appropriate fees to each subscription plan in a way that is calculated to maximize profits. While flexibility and profit maximization are useful consequences of some embodiments, they are not necessary features of the invention.

In one embodiment, the website 410, upon registering a subscription, prompts the user with an option of locking in current subscription terms for an extended period. For example, in one embodiment, a user may lock in the current yearly subscription rate for two, three, four, five, or more years. In one embodiment, subscriptions may be available in different increments, such as, for example, in hours, days, months, quarters, and the like. Alternatively or additionally, a member can be allowed to access certain data in a pay-as-you-go fashion without a subscription, such as, for example, by being charged on a credit card, or on a pre-established account, based on metered usage. In one embodiment, the aforementioned lock in feature is available in any subscription period that is selected. In one embodiment, the price per period can be set to decline as longer lock in periods are selected. In one advantageous embodiment, a website operator can specify a limit, such as, for example, two years or three years, on how long a member may lock in a subscription.

In one embodiment, the website 410 allows the user to participate in a subscription referral program. Under such a subscription referral program, the website 410 prompts the user to enter contact information for another potential member. If the potential member subscribes to the website 410 and remains as a member for a certain amount of time, the referring user earns a free subscription of a specified length. For example, In one embodiment, if the potential member stays as a member past the end of a trial date of 30 days, the referring member gets a free subscription for one month. A skilled artisan will appreciate, in light of this disclosure, that the subscription referral program can have any number of alternative or additional terms, all of which are encompassed within this disclosure.

In one embodiment, the supplemental content database 450 can contain content added to each property file 130, such as, for example, annotations, offers to buy, offers to sell, inside information to be shared among individual members associated with a company membership, and the like. Additionally or alternatively, in one embodiment, the database 435 and the supplemental content database 450 can be periodically automatically updated to reflect new information about particular parcels. For example, in one embodiment, if a title report is run on a particular parcel, a new title report can be entered into the property file 130 associated with the parcel, and any changes over an earlier title report can be flagged. In one advantageous embodiment, each member has access to a certain amount of storage on or accessible to the XML system 440, for storing such information about each parcel. In one advantageous embodiment, such information is stored in the supplemental content database 450. Advantageously, providing content that is associated with each member allows for the efficient propagation of updates to the property files 130. In one embodiment, a member is notified, such as, for example, by electronic mail, when an update has occurred on a property file 130 that is associated with that member. Advantageously, in contrast to static downloads, such as downloads of pdf files, the foregoing embodiments assist a member to know that the member's property files 130 provide the most up-to-date information that is available. The foregoing advantages illustrate usefulness of embodiments of the invention but are not required features of the invention, and some embodiments may not achieve these advantages.

In light of the foregoing advantages, many users can be expected to desire to maintain a large amount of storage on or accessible to the XML system 440. In one embodiment, the website 410 grants access, for each member, to a certain amount of storage. In one embodiment, the website 410 grants access to an extra amount of storage that is greater than a base amount of storage, for a fee. As with the subscription services disclosed herein, the website 410 can set a wide range of policies and fees associated with the purchase of storage. For example, in one embodiment, the website 410 charges a per megabyte fee for storage that is assessed during every subscription period. A skilled artisan will appreciate, in light of this disclosure, that there exist many alternatives to this fee arrangement, all of which are encompassed by this disclosure.

In one embodiment, a service provider uses the XML system 440 to offer goods, services, or both to users of the website 410. Accordingly, an operator of the website 410 may advantageously create a contractual relationship with the service provider to process a transaction via the website 410, via the service provider's own processing system, via another suitable system, or any suitable combination thereof. The XML system 440 and the website 410 preferably communicate using any suitable communications network, such as the Internet, a local area network, a wide area network, or the like.

In one embodiment, the service provider is preferably provided with a software development kit that enables the service provider to integrate its back-end processing system with the user interface of the website 410 and the data delivery system of the website 410. Specifically, the service provider preferably creates a website plug-in that enables the service provider to integrate their service offerings into the website 410.

The website plug-in preferably is configured for one or more of the following: a type of goods or service (e.g., escrow services, legal services, or the like), securable activities, storage characteristics, a web-service interface, a user interface, a private service indication, or any other suitable aspects.

The list of securable activities advantageously includes what transactions, activities, services, goods, or the like are offered by the service provider via the website 410. Accordingly, in an embodiment wherein access rights are used, an administrator of access rights may view the securable activities offered by a service provider, and granted access to use some or all of the secured activities to one or more users. The storage characteristics advantageously define how the offered information or content is stored. For example, content may be stored within the database 435, within the database 450, within any suitable computer system, or any suitable combination thereof.

In one embodiment, content is retrieved from the XML system 440 and statically stored in the database 435. The website 410 may monitor the statically stored content in the database 435 to determine whether the statically stored content is different from the corresponding content in database 450; if the website 410 determines that it is different, the website 410 provides an alert to the user to manually request the changed content. The XML system 440 may monitor the statically stored content and provides an alert to the user to manually request the changed content.

In one embodiment, the website 410 uses information in a property file 130 to order a preliminary title report for the property and/or copies of some or all of the documents mentioned in the preliminary title report, which may advantageously be stored as part of the property file. The website 410 preferably provides an alert to the member when a change occurs in the property's status in a preliminary title report (e.g., change in ownership, notice of defaults, foreclosures, or the like). In one embodiment, the alert may be presented in an alert web page displayed to a user upon logging into the website 410. Any other suitable alert may be provided including but not limited to an email. The alert to the change in status may include an offer to purchase an updated title report. The website 410 preferably creates a billing record for tracking the number of offers to purchase an updated title report that have been provided. Accordingly, the offering party may be charged an associated advertising fee.

In one embodiment, the statically stored content in the database 435 is updated using the content from the database 450 according to any suitable time period, including but not limited to a daily retrieval. In another embodiment, content is retrieved dynamically from the database 435; accordingly, the website 410 advantageously displays the content taken from the XML system 440.

The web service interface advantageously defines the interface from the website 410 to the service provider's system to retrieve the data. For example, the interface may define function calling or the like. In a preferred embodiment, content is sent from the XML system 440 to the website 410 using XML documents or the like. Any suitable method of sharing content may be used among the XML system 440, the website 410, another computer system, or any combination thereof. The user interface preferably defines the user interface for displaying an offer to a user, user interface for the delivered content to a user, or both. In one embodiment, the property file 130 comprises a display of a plurality of tabs, and the delivered content is integrated into an existing tab. In another embodiment, the purchased content is integrated in a new tab through which the service provider preferably interacts with the user.

In a preferred embodiment, some or all of the content from a property file 130 (e.g., tax authority parcel number, address, photographs, ownership information, or the like) is sent from the website 410 to the XML system 440 using XML documents or the like. The XML system 440 preferably uses the content from the property file 130 to generate supplemental content to be added to the property file 130. In one embodiment, the XML system 440 automatically generates the supplemental content. In another embodiment, a person uses the XML system 440 to generate the supplement content. The supplemental content is then preferably sent from the XML system 440 to the website 410 using XML documents or the like. The supplemental content is preferably automatically added to the property file 130. In one embodiment, the website 410 prompts a user prior to adding the supplemental content to the property file 130. Any suitable service provider, including but not limited to those described herein, may add supplemental content using this or other suitable processes. Any suitable content from a property file 130 may be sent to the XML system 440. Further, any non-XML-based system may be used to provide supplemental content.

The private service indication preferably indicates one or more users to whom the services are offered. For example, in one situation, a service provider uses the website 410 to offer goods, services, or both to a single member. In another situation, the service provider has the ability to create property files and provides the service within the service provider itself. For example, a service provider may have data in its sales force automation system. Accordingly, the service provider could create a user interface (e.g., a tab or the like) for the information from its sales force automation system. Accordingly, the service provider would create property files with a custom tab for its internal use, for sharing with others, or both.

In one embodiment, the website 410 prompts a user to select types of service providers from which the user would prefer to receive content. The website 410 may advantageously prompt a user to disable offers from service providers.

In one embodiment, the website 410 includes an interactive service provider directory that can advantageously display a set of service providers according to one or more suitable criteria, including geographic location, service type, or the like. A member may select one or more of the set of service providers to request information (e.g., price quotes, product descriptions, or the like). The member may request information using any suitable method, such as website email or the like. A service provider may preferably filter out unwanted requests according to any suitable criteria, including geographic location, property type, property size, or the like. In one embodiment, the website 410 allows a service provider to create a personalized sub-website within the website 410. In one embodiment, the displayed set of service providers includes links to service providers' sub-websites. The access to the interactive service provider directory is preferably limited to members of the website 410.

In one embodiment, in response to the member submitting a request for information, information from the property file 130 is provided to the service provider's system, which advantageously prepares a customized offer for display at the website 410. The website 410 preferably retrieves the offers and displays a list of the offers. The member may then choose an offer, if one is acceptable.

Accountants can perform a range of suitable tasks for members (e.g., monthly accounting services, annual property audits, preparation of tax returns, or the like). A member may grant the accountant access rights to use any task-related information and to upload the results of the task into the property file. In a preferred embodiment, the member views a history of the activity in the property file 130 using an audit module, according to embodiments disclosed herein.

Appraisers assess the value of a parcel of property. A member may grant the appraiser access rights to use any task-related information (e.g., property description, location, income, expenses, loan and title information, exterior photographs, interior photographs) and to upload the results of the task into the property file. Once the appraiser uploads the assessment, the member may then view the uploaded assessment, and, if desired, grant the right to view the assessment to others.

In one situation, a member may grant the appraiser access rights to use any task-related information and to upload the results of the task into the property file. For example, the property manager can upload income information, expense information, or the like into the property file. Accordingly, the member may review the information, along with any others to which the member has granted access rights.

Attorneys provide various services to various members during the property ownership cycle (e.g., ownership, leasing, property management, acquisition, disposition, or the like). Accordingly, a member may grant the rights to view and collaborate on a document in a property file 130 to a guest and a service provider (e.g., the attorney). When the member, guest, and attorney approve, the document is advantageously saved in the property file. Because each works with the same document, some redundant activities are eliminated.

Architects, engineers, contractors or the like can provide varied services for members. For example, one of these many situations is when a developer wishes to develop a property. The interactive service provider directory may include architects, engineers, contractors or the like. The architect, engineer, contractor or the like preferably provide a customized integrated user interface within the property file 130 for information related to their services. For example, the interface may include a portion for the zoning and development standards from the municipality with jurisdiction over the property. Accordingly, the standards may advantageously be uploaded into the user interface in suitable format such as a digital format, as a scanned document, or the like. In another embodiment, the standards are available from a governmental entity service provider. The member preferably may grant access to view a history of the activity in the property file 130 using an audit module, according to embodiments disclosed herein. Accordingly, redundant work is reduced.

Brokers provide consulting, leasing representation, acquisition representation, disposition representation, or the like. The interactive service provider directory preferably includes brokers. Brokers may advantageously create property files for properties related to the services they provide. In a preferred embodiment, where a broker uses a property file 130 created by a member, the member views a history of the broker's activity in the property file 130 using an audit module, according to embodiments disclosed herein.

In a real estate transaction, an escrow provides services for financial transactions, acquisition transactions, disposition transactions or the like. The interactive service provider directory preferably includes escrow companies. In one situation, a member hires a title company. In another situation, the member grants a previously hired escrow company access to hire a title insurance company for a property file. The interactive service provider directory preferably include title insurance companies. In some instances, title insurance companies can provide title insurance or many other services. For example, a title insurance company may provide a survey such as one for an American Land Title Association (ALTA) policy or the like. The member preferably uses the interactive service provider directory to solicit bids from the title insurance companies. Also, the title insurance company can advantageously offer preliminary title reports, copies of deeds, and copies of documents to member via the website 410.

Financial and Insurance providers provide varied services during the real estate life cycle. A member may grant the financial or insurance provider access rights to use any service-related information (e.g., property information, photographs, or the like), which thus allows the provider to give customized, less general quote and offer for services. This can save considerable time and money for the member.

Marketing and advertising firms can offer their services to members, other service providers (e.g., brokers), or both.

Often, a governmental entity governs a parcel of property within the entity's boundaries. Governmental entities pass laws, ordinances, regulations, or the like that affect the use and therefore value of a property. Governmental entities often spend a significant amount of resources responding to requests regarding the laws, ordinances, and regulations affecting a particular property. In one situation, a governmental entity creates a service provider account for the website 410. Accordingly, the governmental entity preferably provides content regarding the laws, ordinances, and regulations via the website 410, which content may be added to a property file 130. This automated process reduces the amount of resources the governmental entity spends in responding to requests for property-related laws, ordinances, and regulations.

In one embodiment, photographers (e.g., aerial, architectural, or the like) maintain a plurality of images associated with coordinates for a global positioning system (GPS); the images are advantageously offered to members. In one embodiment, when a property file 130 is created using GPS coordinates as described in certain embodiments herein, the images corresponding to the coordinates are automatically added to the property file. The website 410 preferably includes an interactive photographer directory that can advantageously display a set of photographers (e.g., aerial photographers or the like) according to one or more suitable criteria, including geographic location or the like. A member preferably may flag one or more of the set of photographers to solicit offers. The member may solicit using any suitable method, such as website email or the like. In one embodiment, the website 410 allows a photographer to create a personalized sub-website within the website 410. The displayed set of photographers may include links to photographers' sub-websites. The access to the interactive insurer directory is preferably limited to members of the website 410, to the public, or both. In one embodiment, a member uses the website 410 to purchase photographs that are added to a property. The purchased photographs are preferably editable (e.g., for marking or the like).

### Property File

In one embodiment, a member preferably uses the property file application module 210 to create a property file 130 for a parcel of property.

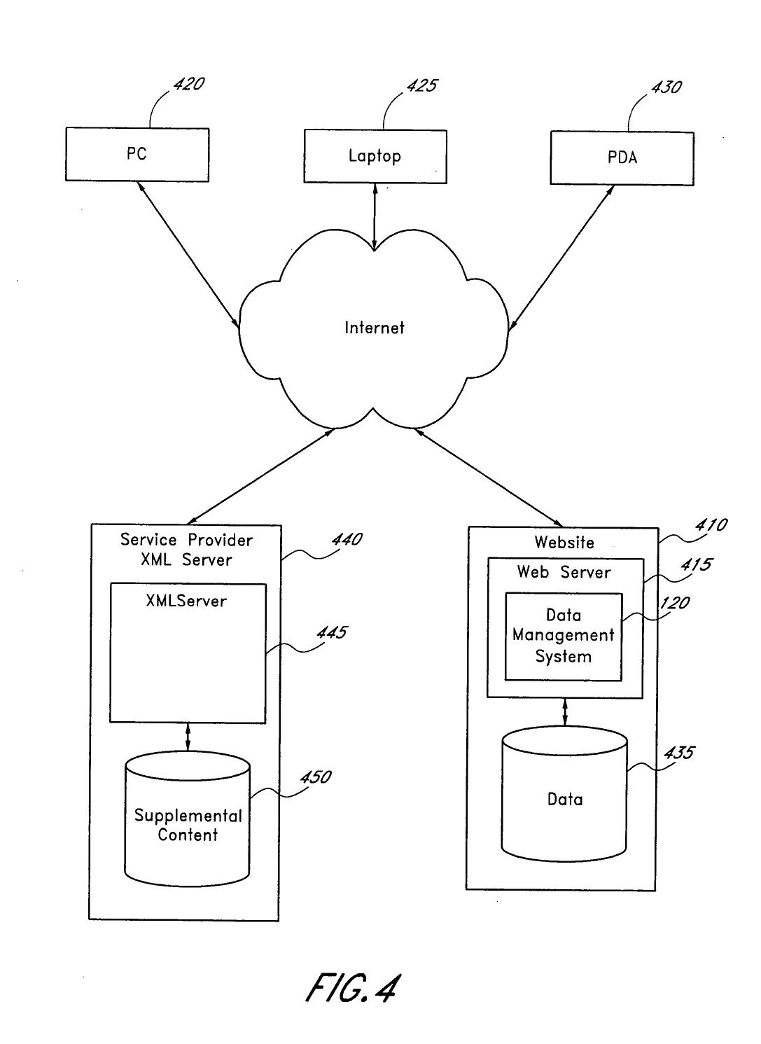

FIG. 5 illustrates a screen 500 according to one embodiment of the invention. The screen 500 comprises an edit groups hyperlink 505, a groups list box 510, an edit property type hyperlink 515, a property type list box 520, and a search button 525.

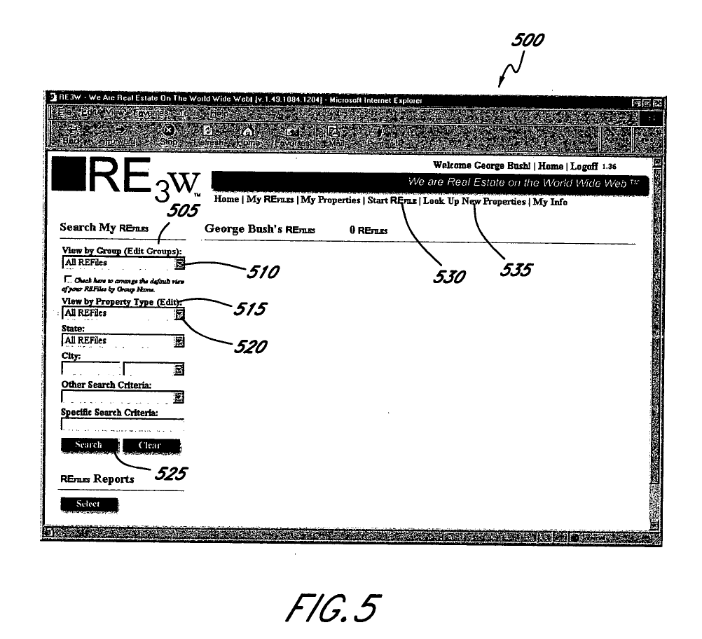

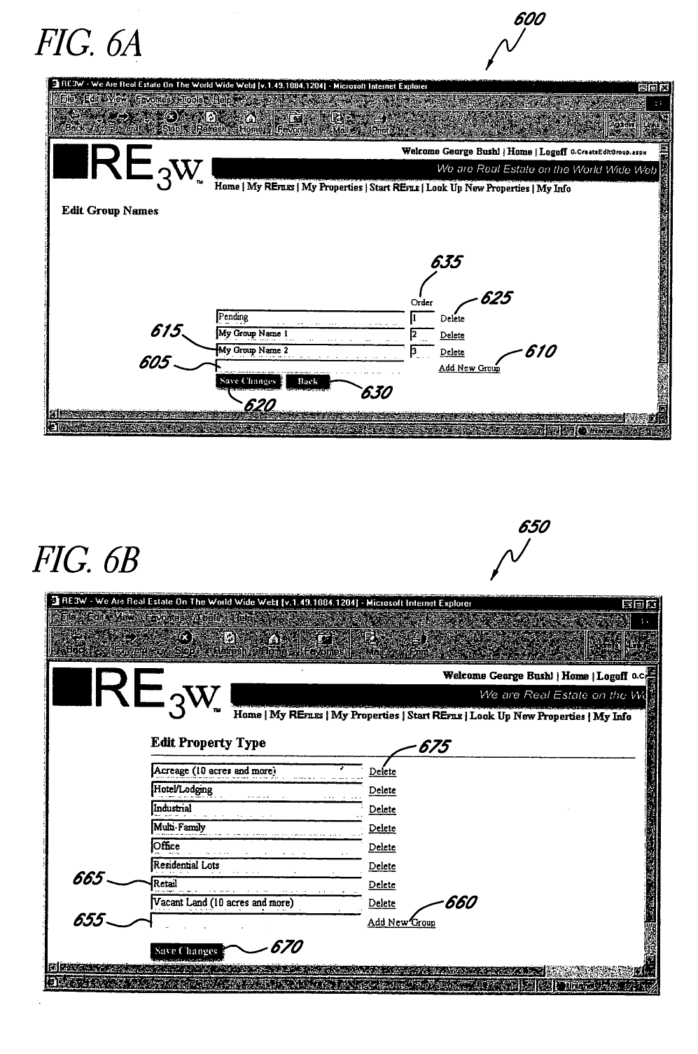

In response to selecting the edit groups hyperlink 505 in FIG. 5, an edit groups screen 600 is displayed as illustrated in FIG. 6A. A user may enter the name of a new group in field 605 and select hyperlink 610 to add a new group. Upon selection of hyperlink 610, a new row appears with the newly chosen group name. The user may revise an existing group (e.g., field 615) and press button 620 to save the revisions. A group may be deleted using the corresponding delete hyperlinks 625. Selecting the back button 630 displays the screen 500. The order that the property files organized by group names are displayed in the screen 500 may advantageously be established by entering an order value in the order fields 635. As shown in some embodiments, a user may advantageously associate an individual property file 130 with one or more groups.

In one embodiment, the groups are advantageously color-coded. In one embodiment, a user may associate a color with the member-created group.

In response to selecting the edit property hyperlink 515 in FIG. 5, an edit property type screen 650 is displayed as illustrated in FIG. 6B. A user may enter the name of a new property type in field 655 and select hyperlink 660 to add a new group. Upon selection of hyperlink 660, a new row appears with the newly chosen property type. The user may revise an existing property type (e.g., field 665) and press button 670 to save the changes. A property type may be deleted using the corresponding delete hyperlinks 675. As shown in some embodiments, a user may advantageously associate a property file 130 with a property type.

In one embodiment, screen 500 comprises one or more fields, list boxes, or the like for searching and displaying a user's property files in response to selecting the search button 525. In one embodiment, a user may execute a search restricted by group selected in the groups list box 510, restricted by property type selected in the property type list box 520, or both. Any suitable criteria may be used to search and display property files, including but not limited to state, city, zip code, keyword search, other search criteria, or the like.

In one embodiment, selecting hyperlink 530 in FIG. 5 creates a new property file 130 as illustrated in FIG. 7. FIG. 7 illustrates a file facts tab screen 700 of the property file 130. The screen 700 advantageously includes a system-assigned file number 705, a user-assigned name field 710, a display of the user-assigned name and system-assigned file number 713, a group list box 715, an add to new group hyperlink 720, an edit group names hyperlink 725, a tax authority parcel number field 730, a county field 735, a state field 740, and a go button 745. A user may rename a property file 130 using the field 710. In one embodiment, a user may assign a property file 130 to one or more groups. For example, in response to the user selecting a group from group list box 715 and selecting the add to new group hyperlink 720, a new row (e.g., row 750 or the like) will appear, indicating the property file 130 is associated with the selected group. To remove a property file 130 from a group, the user may select a corresponding delete hyperlink (e.g., hyperlink 755). If a user wishes to create a new group, the user may select the edit group names hyperlink 725, which displays the screen 600 (FIG. 6A). The tax authority parcel number field 730 represents the tax authority parcel number, which is an identification assigned to a parcel of property by a governmental entity that seeks to tax the owner of the property. The county field 735 represents a county in which a property is located and the state field 740 represents the state in which a property is located.

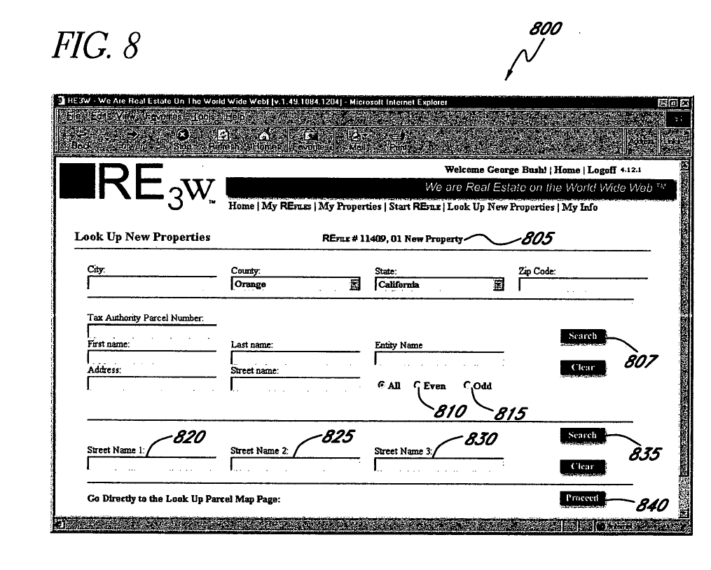

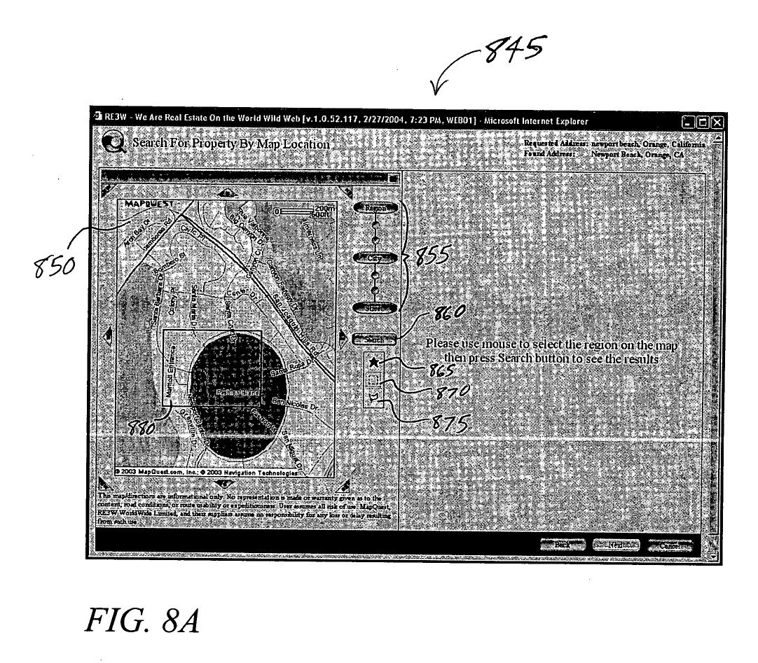

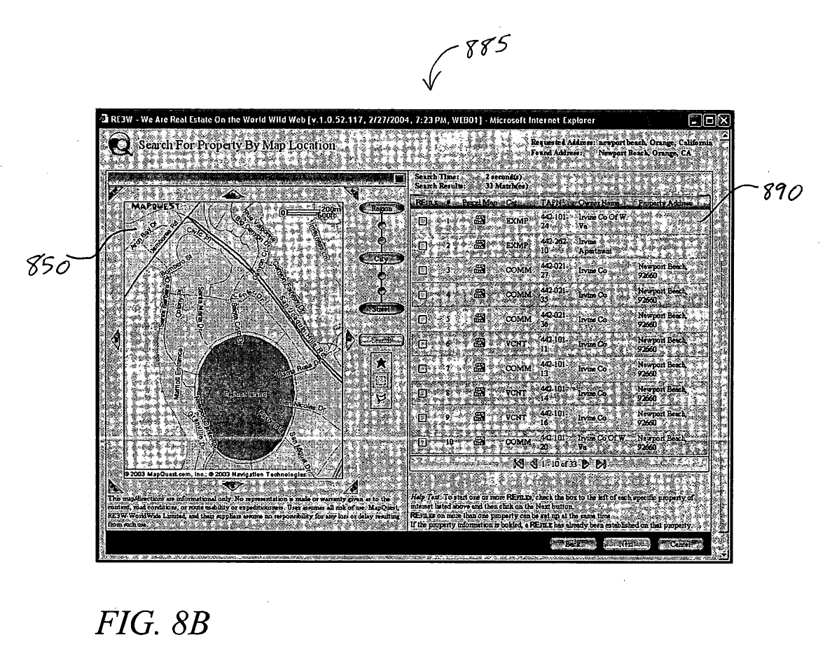

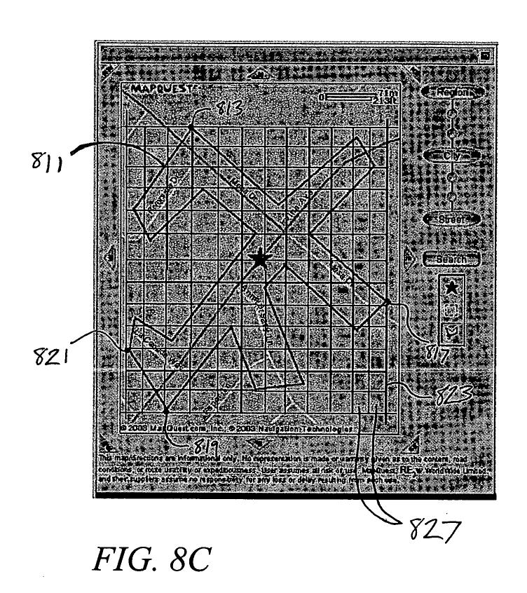

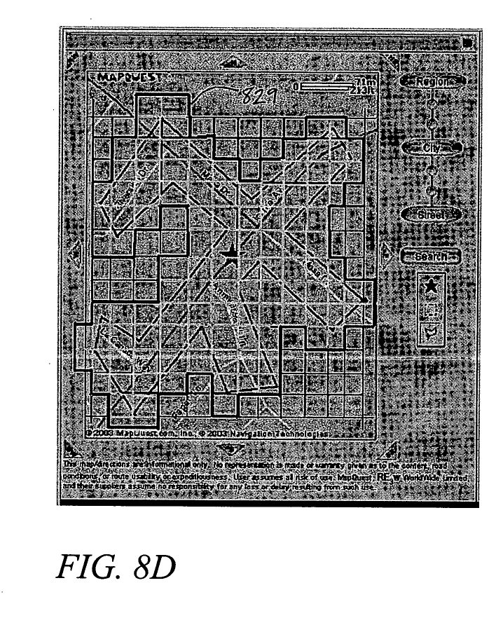

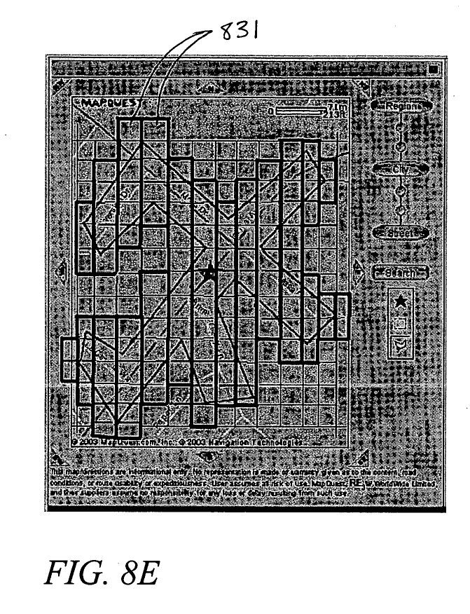

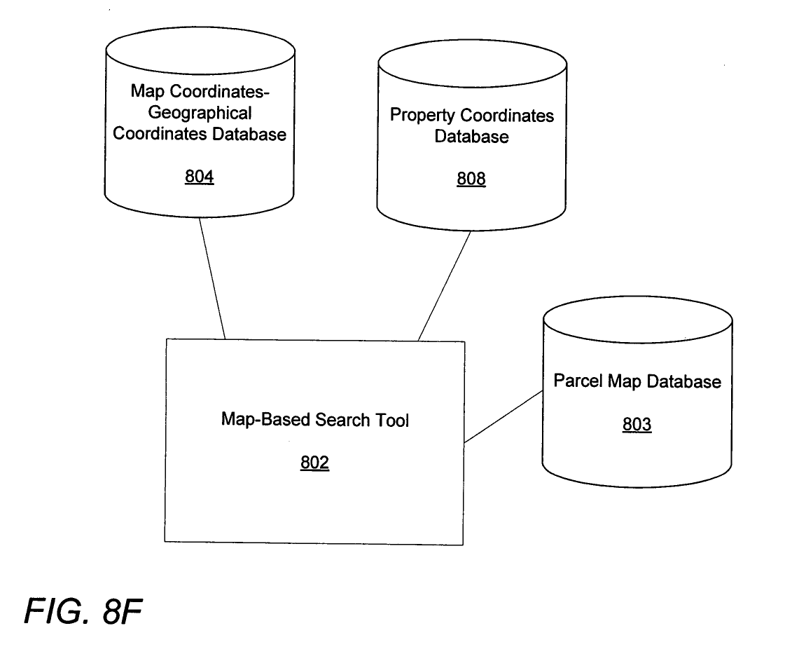

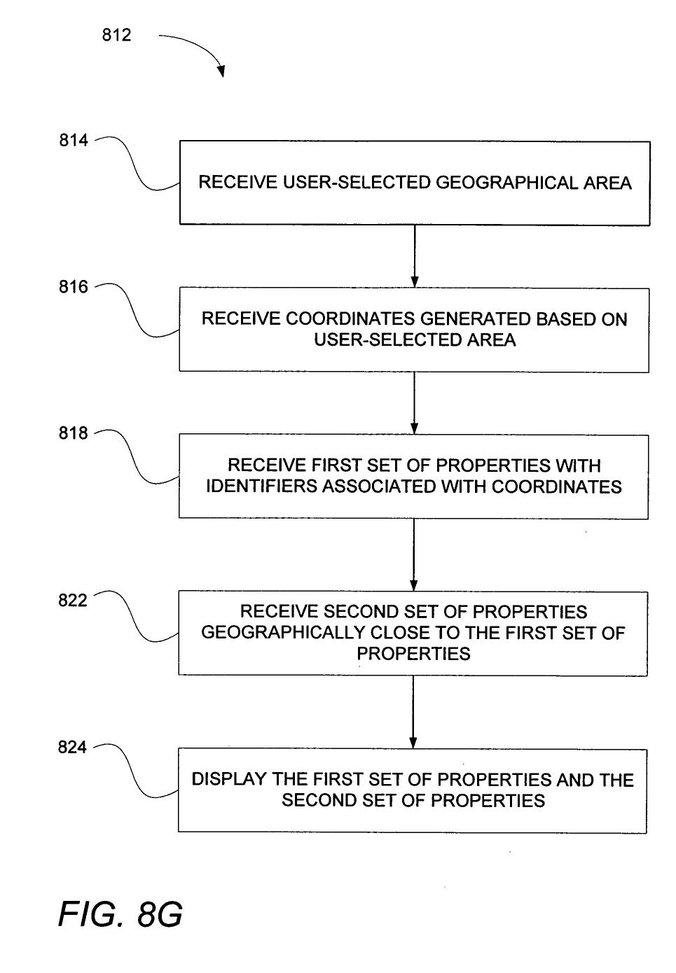

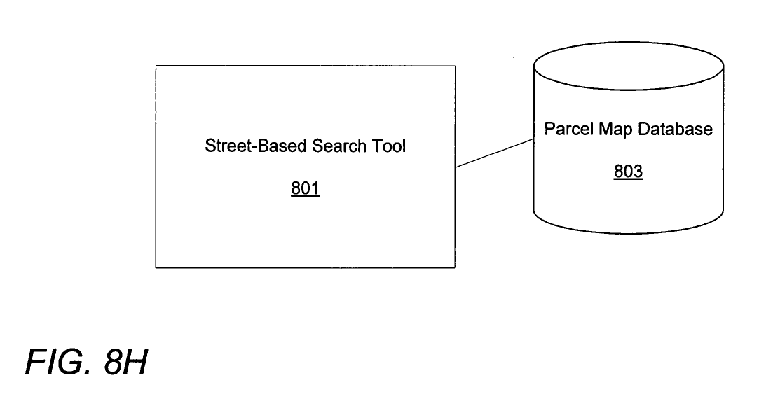

In one embodiment, a database identifies property-related information using any suitable information such as a tax authority parcel number or the like. In one embodiment, if a user knows the tax authority parcel number, the user may enter it in field 730 and press button 745; in response, the website 410 retrieves property-related information associated to that tax authority parcel number and incorporates that information into the property file 130. In one embodiment, if the user does not know the tax authority parcel number of interest, the user leaves the field 730 blank and then selects button 745, which opens screen 800 in FIG. 8.

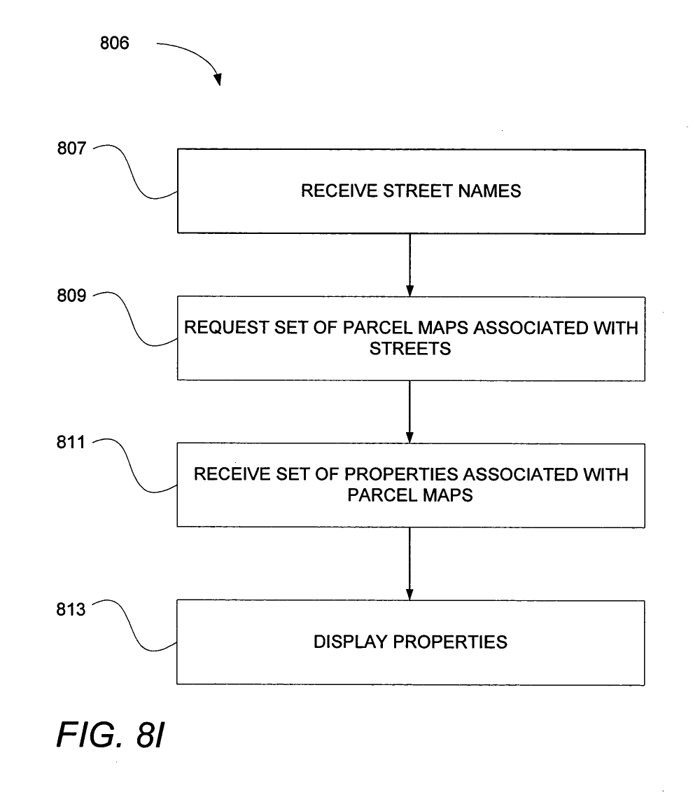

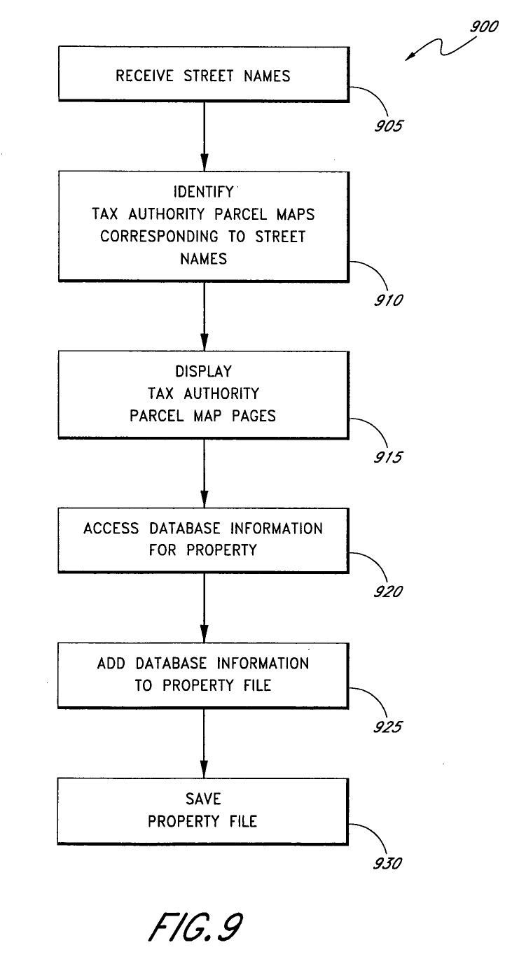

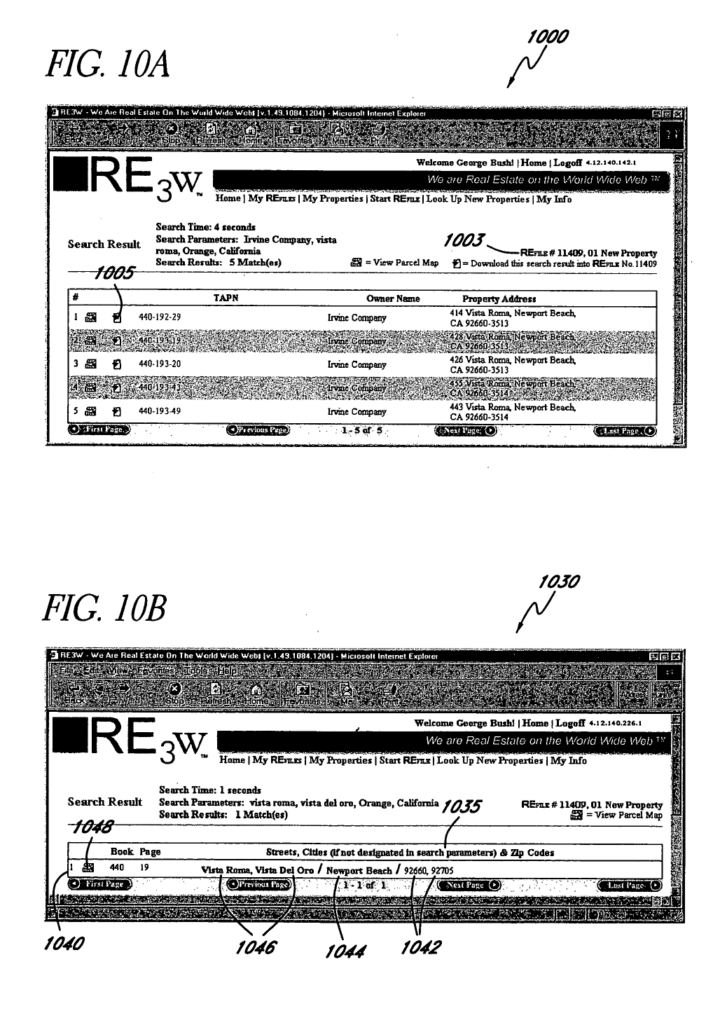

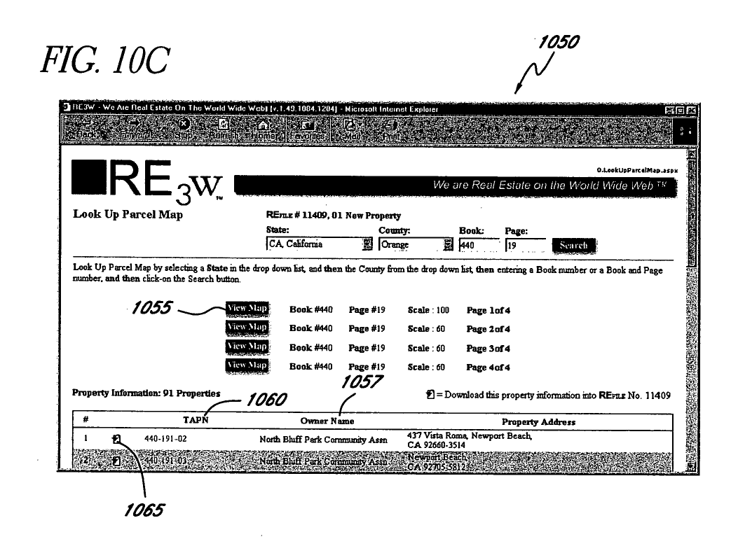

FIG. 8 illustrates an embodiment of the screen 800 in which a user may search a database of property-related data (e.g., database 435, database 450, or the like) to identify a parcel of property, and then incorporate the property-related data within the property file 130. The property file with which a user is working may advantageously be indicated using text 805 (e.g., the user-assigned name and the system-assigned file number). Accordingly, the user may execute a search of the database of property-related data by city, county, state, zip code, tax authority parcel number, owner first name, owner last name, legal entity owner name (e.g., corporation, partnership, or the like), address number, street name, or any suitable combination thereof. Upon entering the suitable criteria, the user may execute search by selecting button 807, which then displays the results of the search in a screen 1000 in FIG. 10A. The user may then incorporate property-related data for a property found in the search into a property file indicated by text 1003, as discussed in further detail below. Any suitable values may be used to execute a search, such as search terms, portions of search terms, “wildcard” characters, or the like.

According to one aspect of an embodiment, the screen 800 allows the user to limit the search to a particular side of a street. In some locations, one side of a street is even-numbered and the other side is odd-numbered. Accordingly, in one embodiment, a user may select one side of a street by selecting radio button 810 (for even-numbered) or radio button 815 (for odd-numbered) or any other selection mechanism supported by the user interface. Because one side of the street may be more valuable than the other (e.g., one side of a street might be coastal properties with an ocean view), a user may wish to view properties on the more valuable side of a street. A user may wish to limit the search to one side of a street for any other reason.

Map-Based Searches

FIG. 8A is an illustrative screen shot of a map-based search tool according to one embodiment. In one embodiment, a map-based search screen 845 comprises a map area 850, a plurality of zoom buttons 855, a search button 860, a plurality of map selection tools including, for example, a map centering tool 865, a map box selection tool 870, and a map irregular shape selection tool 875. In one embodiment, a user can use the zoom buttons 855 to zoom in, so as to get a view of city streets that has more detail at the street level, or to zoom out, so as to get a wider geographical view of a larger section of a city or region. In one embodiment, the user can select the map centering tool 865 and then select a location on the map. In one embodiment, the location that is selected when the map centering tool 865 is in use becomes the new center of the map, and the map is reloaded accordingly. In one embodiment, the user can use the map box selection tool 870 to draw a selection box, such as the illustrated selection box 880, within the map area 850. Alternatively or additionally, In one embodiment, the user can use the map irregular shape selection tool 875 to draw curved lines, straight lines, or any combination of curved lines and straight lines to define an area within the map area 850.

In one embodiment, a user may select the search button 860 in order to instruct the system to search for properties that are within the area that has been selected using the map box selection tool 870, using the map irregular shape selection tool 875, or using some combination of the map box selection tool 870 and the map irregular shape selection tool 875. In one embodiment, when the system receives a user instruction to perform a search for the properties within the selected area, such as, for example, when a user selects the search button 860, the system communicates with a map coordinate-geographical coordinate database 804 (FIG. 8F) that relates map coordinates with longitudinal and latitudinal geographic coordinates. The map coordinate-geographical coordinate database returns, based on the map coordinates selected, a range of longitudinal and latitudinal geographic coordinates that are within the box selected by the user. In one embodiment, the map coordinate-geographical coordinate database 804 is maintained by an external provider of map information, such as, for example, MapQuest.com, Inc. Alternatively or additionally, some or all of the map coordinate-geographical coordinate database 804 can be locally stored in relation to the rest of the system.

In one embodiment, data within the a property coordinates database 808 associates lots, buildings, developments, parcels, other properties, or the like with geographical coordinates. As used herein, all of the foregoing types of properties are generically referred to as properties. As used herein, property is a broad term that refers generally to real property as understood by a skilled artisan familiar with real estate and that includes portions of real property with or without buildings or other developments, that can be owned by a private or public person or entity. As used herein, parcel and lot are broad terms that refer to designated portions of real property. The portions can be designated, for example, by metes and bounds.

The geographical coordinates used can be longitudinal and latitudinal coordinates. A skilled artisan will appreciate in light of this disclosure, however, that other coordinate systems exist and that embodiments of the invention encompass the use of other coordinate systems. The property coordinates database 808 preferably identifies each property using one or more property identifiers. Preferably, at least one of the property identifiers for each property uniquely identifies the property. Suitable property identifiers can include, for example, an address, a parcel number, a telephone number, and a property name, such as, for example the Empire State building. In a preferred embodiment, an address is used to identify most properties. Preferably, the property coordinates database 808 stores, for each property identifier, a longitude and a latitude of the property's geographical location.

As indicated, in a preferred embodiment, the property coordinates database 808 stores a longitude and a latitude for each property address. A skilled artisan will appreciate, in light of this disclosure, however, that not all properties have addresses. As such, in an embodiment in which the property coordinates database 808 stores a longitude and a latitude only for each property address, not every property can be geographically located with reference to the property coordinates database 808 alone. Nevertheless, advantageously, the map-based search tool 802 is able to geographically locate a number of properties for which no address data is available. One manner in which the map-based search tool 802 can perform this function, according to one embodiment, is now described.

In one embodiment, when a search is executed, the map-based search tool 802 associates the coordinate ranges provided by the map coordinate-geographical coordinate database 804 with the geographical coordinates of the properties in the property coordinates database 808 to find a set of properties, identified by address or other property identifier, that are geographically located within the geographical area corresponding to the selected area 880 on the map. In one embodiment, finding such properties is performed by executing a query that specifies a number of longitudes and latitude pairs that define a geographical box or rectangle. A skilled artisan will appreciate that an upper-left longitude, latitude coordinate and a lower-right longitude, latitude coordinate, are sufficient to define the rectangle. Upper-right and lower-left coordinates would also be sufficient. A skilled artisan will appreciate that more than two longitude, latitude coordinate pairs can be used, such as by providing coordinates for all four corners of the rectangle. Preferably, however, only two coordinate pairs representing two diagonally opposing corners of the rectangle are used.

Upon finding a set of properties that are within the range of coordinates, the map-based search tool 802 queries a parcel map database 803 to find properties that are geographically close to the found set of properties within the range of coordinates. Preferably, the parcel map database 803 stores records that associate a number of parcel maps with streets, parcels, properties, addresses, and the like, that appear on each parcel map. Thus, for an example Parcel Map A, addresses 1000 Oak Street, 1234 Main Street, and 1125 Cherry Street appear on the parcel map. Furthermore, parcels that have parcel numbers 123, 456, and 789 appear on the parcel map. In this example, which is illustrative only and does not limit the scope of the invention, the parcel map database 803 has records that associate Parcel Map A with 1000 Oak Street, 1234 Main Street, 1125 Cherry Street, parcel number 123, parcel number 456, and parcel number 789. As explained below in further detail, because parcel number 456 is associated with Parcel Map A and because 1000 Oak Street and 1234 Main Street are also associated with Parcel Map A, the map-based search tool 802 can associate parcel number 456 with 1000 Oak Street and 1234 Main Street. Intuitively, to the user, this association means that parcel number 456 is geographically close to 1000 Oak Street and 1234 Main Street, as parcel maps generally cover a limited geographical area.

As has been indicated, parcels with parcel numbers 123, 456, and 789 may or may not be associated with an address. For example, the parcel with parcel number 123 might have an address of 1125 Cherry Street, while the parcel with parcel number 456 might be a new development that does not yet have an address. Advantageously, because developments and other properties without addresses or other common identification information nevertheless generally appear on up-to-date parcel maps, the map-based search tool 801 allows a user to find properties that are close to certain properties that can be geographically located according to their address but that nevertheless do not yet have addresses or similar identifying information. A skilled artisan will appreciate, in light of this disclosure, that not all parcel maps are up-to-date and therefore not all accurately display every property within the geographical borders of the map. Complete coverage, by the parcel map database 803, of every existing property, is not a required aspect of the invention. Nevertheless, preferably the parcel map database 803 provides up-to-date information about a high percentage of existing properties.

In one embodiment, the parcel map database 803 finds properties that are geographically close to an identified property as follows. The parcel map database 803 receives, within the query, a property identifier, such as, for example, an address. The parcel map database 803 finds a set of parcel maps that are associated with the property identifier. A parcel map is associated with the property identifier if the property identified by the identifier appears on the parcel map. The parcel map database 803 finds properties associated with at least one of the parcel maps within the found set of parcel maps that are associated with the property identifier. For example, with regard to the 1234 Main Street example, the parcel map database 803 may include Parcel Map A in the set of found parcel maps because 1234 Main Street appears on Parcel Map A and is therefore associated with Parcel Map A. The parcel map database 803 then finds the property that is parcel number 456 because parcel number 456 is associated with Parcel Map A because parcel number 456 appears on Parcel Map A. Thus, the map-based search tool 802, in cooperation with the property coordinates database 808 and the parcel map database 803, can advantageously find not just the properties identified by a property identifier and stored in the property coordinates database 808, but the properties stored in the parcel map database 803 that are geographically close to the properties located by the property coordinates database 808. As indicated, many of the properties stored in the parcel map database 803 are not otherwise identifiable by a product identifier such as an address or the like. Advantageously, therefore, the parcel map database 803 can locate properties within a geographical area even if some of the properties do not have an address.

In one embodiment, the map-based search tool 802 receives a list of properties identified by the property coordinates database 808 and the parcel map database 803. Preferably, the map-based search tool 802 displays summary information for the identified properties found within the selected area 880. In FIG. 8B, an illustrative screen shot 885 shows one embodiment of such a summary list 890. Advantageously, the map-based search tool 802 of the foregoing embodiments allows a user to search for properties in an intuitive way, based on geography that a user may be familiar with. According to one advantageous use of the map-based search tool 802 of the foregoing embodiments, a user may select an area surrounding a particular landmark, region, or section of town that is known to the user. Advantageously, this use can assist purchasers of real estate to locate properties based on their convenience to a particular area, for strategic purposes or otherwise.

According to embodiments, the parcel map database 803, the property coordinates database 808, or both, comprise data provided by or derived from data provided by First American Real Estate Solutions (“FARES”). A skilled artisan will appreciate, in light of this disclosure, that the data can be provided by another provider of such information.

In one embodiment, the map-based search tool 802 is configured to find properties within a user-defined irregularly shaped polygon. In one embodiment, a user can use the polygon selection tool 875 to draw a polygon on the map area 850. In one embodiment, the user selects a series of points within the map area 850. Pairs of consecutive points define each line of a polygon. For example, a first point and a second point define a first line, the second point and a third point define a second line, the third point and a fourth point define a third line, and so on. In one embodiment, the user re-selects the first point in the series of points in order to enclose the selected area. In one embodiment, the system can automatically close off a selected polygon area when the user fails to manually select a fully enclosed polygon, such as by, for example, automatically drawing a line from the last point selected by the user to the first point selected by the user. For example, in one embodiment, the system completes and encloses the selected polygon, according to the foregoing fashion, when the user selects the search button 860.

In one embodiment, searching for properties within a polygon comprises dividing the selected polygon area into a number of rectangular areas that together approximate the shape of the polygon, performing a rectangle search as has been disclosed for each rectangular area, and merging the results of the individual rectangle searches. FIGS. 8C to 8E illustrate how this can be done. FIG. 8C illustrates a map-based search tool 802 screen shot in which the user has drawn a polygon 811. According to an embodiment, the map-based search tool finds extreme points of the polygon 811. In one embodiment, the extreme points of the polygon 811 are the highest vertical point 813, the right-most horizontal point 817, the lowest vertical point 819, and the left-most horizontal point 821. Based on the extreme points, the system, in one embodiment, defines a rectangle 823 that at least covers the polygon 811. As illustrated, in one embodiment the borders of the rectangle 823 are defined by the highest vertical point 813, the right-most horizontal point 817, the lowest vertical point 819, and the left-most horizontal point 821.

In one embodiment, the rectangle 823 is subdivided into a number of rectangles 827. As illustrated, some of the rectangles 827 overlap at least a portion of the polygon 811, while others do not overlap the polygon 811 at all. Referring to FIG. 8D, in one embodiment those rectangles 827 that overlap at least a portion of the polygon 811 form a rectangle-approximated polygon 829. Referring to FIG. 8E, in one embodiment the rectangles 827 that form the rectangle-approximated polygon 829 are vertically merged into a number of vertically merged rectangles 831. Preferably, the vertically merged rectangles 831 comprise a number of rectangles 827 that are vertically adjacent to each other and can therefore be combined into larger rectangles 831. Preferably, in one embodiment, horizontally adjacent rectangles are also merged into horizontally merged rectangles (not shown). Preferably, in one embodiment, by combining merging of vertically adjacent rectangles and merging of horizontally adjacent rectangles, a lowest number of merged rectangles that encompasses the entire rectangle-approximated polygon 829 can be formed. A skilled artisan will appreciate in light of this disclosure, however, that while forming a lowest number of merged rectangles will in many cases lead to computational efficiency, forming a lowest number of merged rectangles is not essential to find properties within the area of the rectangle-approximated polygon 829.

As indicated, in one embodiment, the system defines a number of rectangles that, in combination, encompass the entire rectangle-approximated polygon 829. In one embodiment, the system performs a series of searches, one search for each rectangle, to find properties within each rectangle. In one embodiment, the searches are performed in serial. In another embodiment, the searches are performed in parallel. In another embodiment, the searches are performed using some combination of serial and parallel processing. Each individual rectangle search proceeds according to the procedure that has previously been described. In one embodiment, the results of the individual rectangle searches are merged into global search results that represent properties within the entire area of the rectangle-approximated polygon 829. Advantageously, the map-based search feature using the polygon selection tool 875 allows a user to search for properties in an area that approximates a user-defined polygon. Advantageously, the user can use such a feature, for example, to search for properties within a particular area, such as a neighborhood or business district, that is defined, for example, by irregularly shaped streets.

With reference to FIG. 8G, a process for finding properties that can be performed by a map-based search tool is now described. In a block 814, the process 812 receives a user-selected geographical area. The user-selected geographical area can be received by the map-based search tool 802 by receiving input from a user that represents a box or polygon drawn on a map. In a block 816, the process 812 proceeds to receive a range of coordinates generated based on the user-selected geographical area. In one embodiment, the map-based search tool 802 performs this function by receiving a response to a query to the map coordinate-geographical coordinate database 804. In a block 818, the process 812 proceeds to receive a first set of properties that have property identifiers associated with the received coordinates. For example, a property identifier can be associated with geographical coordinates that are within bounds defined by the received coordinates, and are therefore within the selected geographical area. In one embodiment, the property identifiers are addresses. In a block 822, the process 812 proceeds to receive a second set of properties that are geographically close to the first set of properties. In one embodiment, the second set of properties are generated by the parcel map database 803 by finding properties that are displayed on parcel maps that also display one or more of the first set of properties. In a block 824, the process 812 proceeds to display the first set of properties and the second set of properties. The block 824 can be performed, for example, by the map-based search tool 802.

In one embodiment, the parcel map database 803, the map coordinate-geographical coordinate database 804, and the property coordinates database 808 reside in one or more computers that are external to the map-based search tool 802, and the map-based search tool 802 communicates with the parcel map database 803, the map coordinate-geographical coordinate database 804, and the property coordinates database 808 over a network or a direct communications line. Such networks and direct communications lines can include, for example, the Internet, an intranet, a Wide Area Network, a Local Area Network, a wireless network or connection, a telephone line, a Digital Subscriber Line, a coaxial cable connection, a T1 line, a T3 line, any other kind of known broadband networks and connections, and the like. Alternatively, any one, two, or all of the parcel map database 803, the map coordinate-geographical coordinate database 804, and the property coordinates database 808 can reside locally, that is, in the same computer as the map-based search tool 802. In one embodiment, the map-based search tool 802 is implemented, at least in part, as a software module as defined herein. A skilled artisan will appreciate, in light of this disclosure, that the map-based search tool 802 can also be implemented, in whole or in part, in hardware, firmware, or any combination of software, hardware, or firmware. A skilled artisan will further appreciate, in light of this disclosure, that while one map-based search tool 802 is illustrated, that the map-based search tool 802 can be implemented as more than one software module, firmware component, or hardware component, and that such components can all exist locally in a single computer or can be distributed over several computers, such as, for example, across a network. Additionally, a skilled artisan will appreciate, in light of this disclosure, that a number of languages and protocols exist for querying an external or local database, and that any such querying language or protocol can be used. In a preferred embodiment, the map-based search tool 802 queries the parcel map database 803, the map coordinate-geographical coordinate database 804, and the property coordinates database 808 using Structured Query Language (“SQL”).

Street-Based Searches

In some situations, a user is interested in a property that has no address of record (e.g., a vacant property) or in a property for which the user has no address and no tax authority parcel number. Accordingly, in one embodiment, the screen 800 (FIG. 8) allows the user to execute a search with two or more street names, which the user preferably knows are in the immediate vicinity of the property of interest. The search preferably identifies one or more parcel maps in the immediate vicinity of the property of interest. Parcel maps preferably display one or more parcels and display corresponding parcel numbers. Parcel maps are sometimes created by tax authorities and referred to as tax authority parcel maps. Similarly, parcel numbers are often assigned by tax authorities and referred to as tax authority parcel numbers. Advantageously, tax authority parcel maps are available in a large number of geographical areas, so such parcel maps can advantageously be used to generate a large amount of information concerning real property. Nevertheless, while embodiments of the invention advantageously use tax authority parcel maps, the term parcel map, as used herein, is a broad term that encompasses any map that displays one or more properties in relation to each other, including, for example, tax authority parcel maps. Similarly, parcel number, as used herein, is a broad term that encompasses any number that identifies a particular parcel of real property, including, for example, a tax authority parcel number.

The user browses the identified parcel maps to determine if the property of interest is shown on one of the maps. If the property is not shown, the user browses related parcel maps (e.g., adjacent maps or the like) to locate the parcel map showing property of interest. Once the user locates the parcel map displaying the property of interest, the user may review the parcel map to determine the associated tax authority parcel number.

For example, in one embodiment, to execute the search, the user enters two or more street names in any suitable combination of field 820, field 825, and field 830 and selects button 835. In response, the website 410 executes a process 900 (FIG. 9) according to one embodiment. At a block 905, the website 410 receives two or more street names.

At a block 910, the website 410 queries a database (e.g., database 435, database 450, or the like). In one embodiment, the database associates a parcel map with the set of properties shown on the parcel map. Additionally, in one embodiment, the database associates one or more of the properties associated with each parcel map with an address or street name. A skilled artisan will appreciate, in light of this disclosure, that at times not all properties shown on a parcel map will have an associated address or street name. Such a circumstance can occur, for example, when a new development has not yet been assigned an address, or when a development is being constructed in an area in which streets have not yet been constructed. Advantageously, however, such properties without addresses may still appear on a parcel map and can therefore be associated with the addresses and street names that also appear on the parcel map. In this way, properties that are geographically near each other can be conveniently associated with each other in the database. For example, a property under development near the corner of First Street and Oak Avenue may appear on a parcel map that depicts the intersection of First Street and Oak Avenue and can therefore be associated with First Street and Oak Avenue, even if the property is not on either First Street or Oak Avenue. Advantageously, by using this search feature, a user can identify the property under development near the corner of First Street and Oak Avenue, by searching for First Street and Oak Avenue, without needing to know the actual address of the property under development.

Accordingly, at the block 910, the query identifies one or more parcel maps that are associated, in the database, with the street names entered by the user. Preferably, a street name is associated with a parcel map if a portion of the street appears on the parcel map. In one embodiment, the query identifies one or more parcel maps that are associated with every one of the street names entered by the user. In one embodiment in which the query identifies one or more parcel maps that are associated with every one of the street names entered by the user, the query finds parcel maps associated with each street name individually and then merges individual queries to find the intersection of the individual queries. A skilled artisan will appreciate, in light of this disclosure, many alternative ways in which the query can be performed. Alternatively or additionally, the query identifies one or more parcel maps that are associated with at least one of the street names, without regard to whether each parcel map is also associated with the other street names. In another embodiment, the query identifies one or more parcel maps that are associated with a threshold number of multiple street names that have been entered by the user, such as, for example, two out of three street names, three out of four street names, three out of five street names, or the like. Such a threshold value can be pre-programmed or can be selected by the user. A skilled artisan will appreciate, in light of this disclosure, that while embodiments have been disclosed in which the user enters three street names, embodiments can allow a user to enter a different number of street names, such as, for example, one, two, four, five, six, seven, or any number of street names greater than seven.

At block 915, the website 410 displays a screen 1030, according to one embodiment of the invention. The screen 1030 comprises a list 1035 of one or more parcel map rows (e.g., row 1040) for the parcel maps identified at the block 910. The parcel map rows preferably display zip codes 1042, the cities 1044, and the queried street names 1046 associated with the parcels shown on the parcel map.

To execute a search, the user preferably enters two or more street names in any suitable combination of field 820, field 825, and field 830, along with other suitable criteria as described with reference to FIG. 8, including but not limited to city, county, state, and zip code. In one embodiment, the cities are optionally not displayed in the parcel map row when a city was specified in the search criteria. In one embodiment, the user preferably enters one or more street names in field 820, field 825, or field 830, along with other suitable criteria as described with reference to FIG. 8, including but not limited to city, county, state, and zip code. Any suitable values may be used to execute a search, such as search term s, portions of search terms, “wildcard” characters, or the like.

Selecting a lookup parcel map button, (e.g., button 1048) causes the website 410 to display a screen 1050 (FIG. 10C), according to one embodiment of the invention. The screen 1050 further comprises a list 1057 of the properties shown in the selected parcel map. Selecting a view map button (e.g., button 1055) causes the website 410 to display an image of the corresponding portion of the parcel map (e.g., button 1055 corresponds to book 440, page 19, page 1 of 4). The user may then review the displayed image to determine what tax authority parcel number is associated with the property for which the user wishes to create a property file 130. When the user determines what the tax authority parcel number is, the user may locate that tax authority parcel number in the list 1057 by reviewing tax authority parcel number column 1060, which contains a list of tax authority parcel numbers. When the number is located, the user may select a corresponding load data button (e.g., button 1065); in response to the selection of the load button, at a block 920, the website 410 retrieves the corresponding data from database of property-related data, and, at a block 925, the website 410 incorporates the data into the property file. The user may then choose to save the incorporated data at a block 930. Similarly, as illustrated in the screen 1000 in FIG. 10A, a user may select a load button (e.g., button 1005) to incorporate property related data into the property file 130. In response to the selection of the load button (e.g., button 1005), the website 410 retrieves the corresponding data from database of property-related data and incorporates the data into the property file. The user may then choose to save the incorporated data. Although selecting load button (e.g. buttons 1005 and 1065) is illustrated, the interface could be designed to prompt the user to type in the parcel number or to click on an associated portion of the parcel map, and, in response, the website 410 could retrieve the corresponding data from database of property-related data.

In the foregoing embodiment, a user is able to enter street names and receive a list of parcel maps that display the street names. The user is then able to view one or more of the parcel maps to manually find other properties that appear on the parcel maps. In this way, a user is able to find, by manually looking at the parcel maps, properties that are located geographically near the entered street names.

Advantageously, according to one embodiment, a street-based search tool 801 provides an automated process that is configured to find properties that are displayed on parcel maps that also display the entered street names. Advantageously, providing an automated process makes searching for properties using parcel maps much easier and efficient for the user. Rather than requiring a user to view one or more parcel maps to manually to find properties on each map, the street-based search tool 801 performs this aspect of the search for properties. Advantageously, according to one embodiment illustrated in FIG. 8H, the street-based search tool 801 communicates with a parcel map database 803. Preferably, the parcel map database 803 stores records that associate a number of parcel maps with streets, parcels, properties, and the like, that appear on each parcel map. Thus, for an example Parcel Map A, streets Oak, Main, and Cherry appear on the parcel map. Furthermore, parcels that have parcel numbers 123, 456, and 789 appear on the parcel map. In this example, which is illustrative only and does not limit the scope of the invention, the parcel map database 803 has records that associated Parcel Map A with Oak Street, Main Street, Cherry Street, parcel number 123, parcel number 456, and parcel number 789. As explained below in further detail, because parcel number 456 is associated with Parcel Map A and because Oak Street and Main Street are also associated with Parcel Map A, the street-based search tool 801 can associate parcel number 456 with Oak Street and Main Street. Intuitively, to the user, this association means that parcel number 456 is geographically close to Oak Street and Main Street, as parcel maps generally cover a limited geographical area.

In one embodiment, the parcel map database 803 comprises data provided by or derived from data provided by First American Real Estate Solutions (“FARES”). A skilled artisan will appreciate, in light of this disclosure, that the data can be provided by other providers of such data.

As has been indicated, parcels with parcel numbers 123, 456, and 789 may or may not be associated with an address. For example, the parcel with parcel number 123 might have an address of 123 Oak Street, while the parcel with parcel number 456 might be a new development that does not yet have an address. Advantageously, because developments and other properties without addresses or other common identification information nevertheless generally appear on up-to-date parcel maps, the street-based search tool 801 allows a user to find properties that are close to certain streets but that nevertheless do not yet have addresses or similar identifying information. A skilled artisan will appreciate, in light of this disclosure, that not all parcel maps are up-to-date and therefore not all accurately display every property within the geographical borders of the map. Complete coverage, by the parcel map database 803, of every existing property, is not a required aspect of the invention. Nevertheless, preferably the parcel map database 803 provides up-to-date information about a high percentage of existing properties.

A manner in which the street-based search tool 801 and the parcel map database 803 interact, according to one embodiment, to assist the user to locate properties by entered street names is now described. Referring to FIG. 8, the user enters one or more street names into one or more of the street name fields 820, 825, and 830. While three street name fields are illustrated, more can be provided. Alternatively, one or more street name fields can be provided that accept more than one street name in a list separated by, for example, commas, semicolons, or the like. Preferably, a user enters at least two street names. Entering a single street could potentially cause the street-based search tool 801 to find too many parcel maps and therefore too many properties to provide a useful search result, as long streets typically appear in hundreds or thousands of parcel maps. Nevertheless, while certain embodiments of the street-based search tool 801 require the user to enter two or more street names, the street-based search tool 801 does not need to have such a restriction.

In one embodiment, the map-based search tool 801 queries the parcel map database 803 to find parcel maps associated with one or more of the streets identified by the entered street names. For conciseness, a “street identified by the entered street name” is sometimes hereinafter referred to as an “entered street.” A parcel map is associated with a street if a portion of the street appears on the parcel map. The street name does not have to appear on the parcel map in order for the street to be associated with the parcel map. The degree of association that is required in order to satisfy the query can vary according to the structure of the query. For example, a query structured to require a high degree of association with the entered streets and to find a relatively narrow set of parcel maps finds only parcel maps that display every one of the entered streets. Alternatively, a query structured to find a broad set of parcel maps can find all parcel maps that display any of the entered streets. A query can also be structured to find parcel maps that display two out of three entered streets, or three out of five entered streets, or the like. The manner in which the query is structured can be preconfigured within the map-based search tool 801 such that a user does not choose how the query works. Alternatively or additionally, the street-based search tool 801 can allow a user to participate in structuring a query, such as, for example, by allowing a user to enter a query using boolean algebra. Alternatively or additionally, the map-based search tool 801 can provide a limited number of choices for how a query is structured, such as for example, to require all entered streets to be associated with a parcel map or to require two of three entered streets to be so associated.

In accordance with the foregoing query, the parcel map database 803 finds a set of parcel maps. In one embodiment, the parcel map database 803 returns the found set of parcel maps to the street-based search tool 801. As indicated, in addition to maintaining records that associate streets with parcel maps, the parcel map database 803 maintains records that associate properties, with or without addresses or similar property identifiers, with parcel maps. That is, the parcel map database 803 has data about which properties are displayed on each parcel map. In one embodiment, the parcel map database 803 finds, using the foregoing associations, a set of properties associated with one or more of the found parcel maps. As indicated, parcel maps preferably cover a small geographical area, such that two properties displayed on the same parcel map are geographically close to each other. Therefore, the set of properties associated with the found parcel maps constitutes the set of properties that are geographically close to, or in the same geographical area as, the entered streets.

In one embodiment, instead of or in addition to returning the found set of parcel maps to the street-based search tool 801, the parcel map database 803 also finds and returns the set of geographically close properties to the street-based search tool 801, without requiring another query from the street-based search tool 801. Alternatively, the street-based search tool 801 receives the set of parcel maps from the parcel map database 803 and queries the parcel map database 803 again, requesting the set of geographically close properties. Either way, the street-based search tool 801, in cooperation with the parcel map database 803, advantageously assists a user to find properties, whether having addresses or other property identifiers or not, that are close to one or more known streets. This feature can be used by a user for many reasons, including, for example, to locate suitable properties in a particularly strategic or otherwise desirable location.

Preferably, the street-based search tool 801 displays the foregoing set of geographically close properties such that the user can view a list of properties, select one or more properties, create property files for one or more properties, refine the search for properties, request additional information for one or more of the properties, manipulate the set of properties in some other way, or the like.

FIG. 81 illustrates a process for finding properties geographically close to one or more streets identified by street names. In one embodiment, such a process 806 receives one or more street names in a block 807. The street names can be received from a user upon entry by the user into one or more street name entry fields. The process 806 can proceed to a block 809, in which parcel maps associated with streets identified by the entered street names are requested. The function of the block 809 can be performed, for example, by the street-based search tool 801, which queries the parcel map database 803. In the block 809, parcel maps associated with every one of the entered streets can be requested. Alternatively, parcel maps associated with at least one of the entered streets can be requested. Alternatively, parcel maps associated with two out of three, or three out of five, of the entered streets can be requested. Alternatively, parcel maps can be requested according to rules of association entered by the user using boolean algebra. The association between streets and parcel maps can be that the parcel maps display at least a portion of the street.

In one embodiment, the process 806 proceeds to a block 811, in which a set of properties associated with the identified parcel maps are received. The function of the block 811 can be performed, for example, by the street-based search tool 801. The set of properties associated with the identified parcel maps can be found, for example, by the parcel map database 803. The process 806 can proceed to a block 813, in which the received set of properties are displayed. The function of the block 813 can be performed, for example, by the street-based search tool 801.

In one embodiment, the parcel map database 803 resides in a computer that is external to the street-based search tool 801, and the street-based search tool 801 communicates with the parcel map database 803 over a network or a direct communications line. Such networks and direct communications lines can include, for example, the Internet, an intranet, a Wide Area Network, a Local Area Network, a wireless network or connection, a telephone line, a Digital Subscriber Line, a coaxial cable connection, a T1 line, a T3 line, any other kind of known broadband networks and connections, and the like. Alternatively, the parcel map database 803 can reside locally, that is, in the same computer as the street-based search tool 801. In one embodiment, the street-based search tool 801 is implemented, at least in part, as a software module as defined herein. A skilled artisan will appreciate, in light of this disclosure, that the street-based search tool 801 can also be implemented, in whole or in part, in hardware, firmware, or any combination of software, hardware, or firmware. A skilled artisan will further appreciate, in light of this disclosure, that while one street-based search tool 801 is illustrated, that the street-based search tool 801 can be implemented as more than one software module, firmware component, or hardware component, and that such components can all exist in a single computer or can be distributed over several computers, such as, for example, across a network. Additionally, a skilled artisan will appreciate, in light of this disclosure, that a number of languages and protocols exist for querying an external or local database, and that any such querying language or protocol can be used. In a preferred embodiment, the street-based search tool 801 queries the parcel map database 803 using Structured Query Language.

Global Position Searches

In one embodiment, the database of property-related data (e.g., database 435, database 450, or the like) includes coordinates (e.g., longitude, latitude, or the like) associated with individual parcels of property. Accordingly, a user may have a mobile computing device comprising a GPS receiver, which is useful for the process 1100 shown in FIG. 11. In response to a user input, the GPS receiver retrieves its coordinates from a global positioning system at a block 1110. The mobile computing device transmits the coordinates to the website 410, which accesses the database of property-related data to determine the corresponding parcel of property at a block 1115. The website 410 retrieves the corresponding data from database of property-related data at a block 1120 and the website 410 incorporates the data into the property file at a block 1125. The user may then choose to save the incorporated data at a block 1130. This feature allows a user who is visiting a parcel of land to conveniently create a property file 130 for that parcel without having to know its parcel number or its address.

In one embodiment, an interactive map comprising an aerial photograph, satellite aerial photograph, or the like is configured to determine the coordinates of properties displayed in the interactive map. Upon user selection of a portion of the map, the coordinates associated with the selected portion are transmitted to the website 410, which queries a database of property-related data including coordinates. The website 410 displays one or more properties coordinates that correspond to the queried coordinates. Upon user selection of a displayed property, the website 410 creates a property file 130 for the selected property. In one embodiment, a street map overlay is provided wherein the streets are labeled on the photographs.

Additional Search Variables

Embodiments of each of the foregoing search techniques allow a user to focus the search using additional search variables. For example, in one embodiment, the searches can be focused on property category, such that the search finds exempt property, light industrial property, commercial property, residential property, some combination of the foregoing, or the like. Alternatively or additionally, the searches can be focused to exclude certain types of property, such as, for example, excluding residential property. Searches can include or exclude other property classifications, such as, for example, commercial, light industrial, heavy industrial, multi-family dwellings, detached single family homes, and the like. A skilled artisan familiar with real estate will understand, in light of this disclosure, that there exist a number of other property classifications, and that the system can or can be made to search based on any of these classifications. Other additional search variables include property value, age of property, date of last development, asking price, owner, and the like. A skilled artisan will appreciate, in light of this disclosure, that a large number of other characteristics of property can be tracked, and that any characteristic that is tracked can, according to alternative embodiments, be allowed to be a component of a search. All such embodiments are encompassed by this disclosure.

Content may be incorporated into the property file 130 in any suitable manner. In some embodiments, content may be automatically incorporated using a database search with screen 800 (FIG. 8), selecting load button 1005 (FIG. 10A), selecting load button 1065 (FIG. 10C), using process 900 (FIG. 9), using process 1100 (FIG. 11) or any suitable combination thereof. In one embodiment, content may be manually entered into a property file 130, manually uploaded, automatically entered, automatically uploaded, or any suitable combination thereof. Any other suitable methods of incorporating data into the property file may be used.

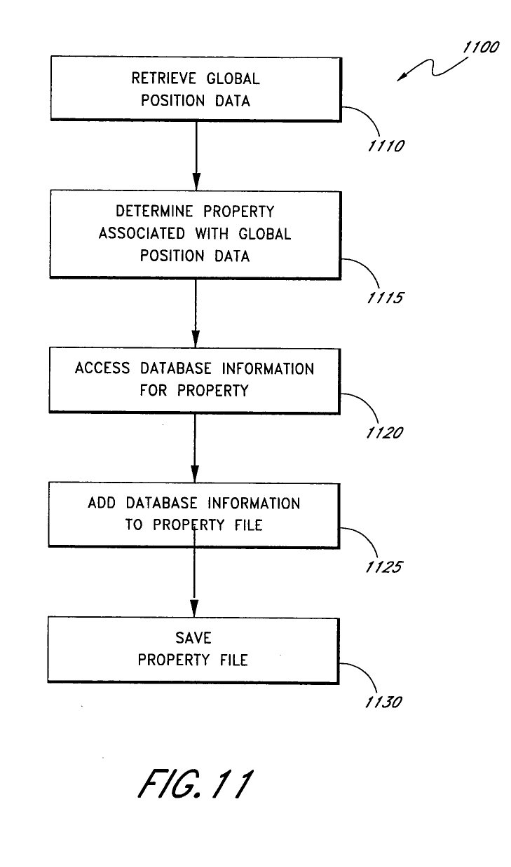

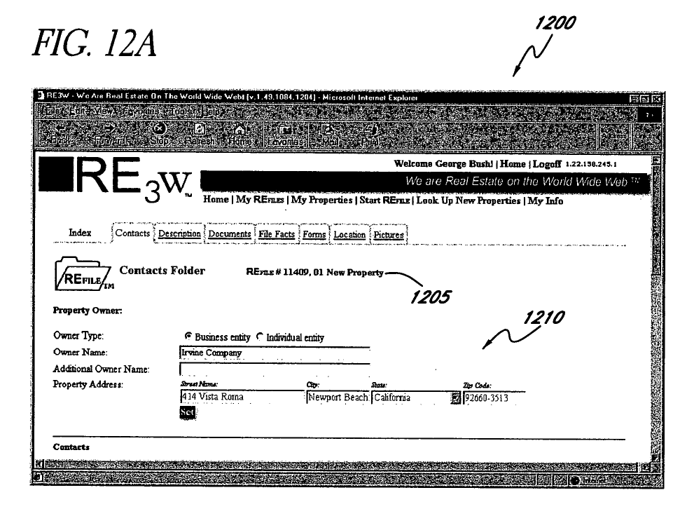

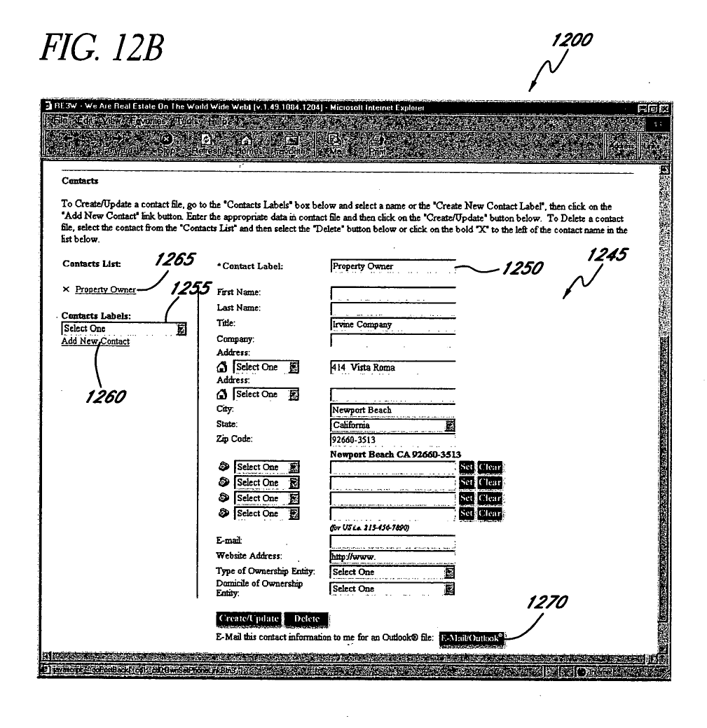

FIGS. 12A-17 illustrate embodiments of a property file 130 wherein a series of tabs (e.g., contacts, description, documents, file facts, forms, location, pictures) hold property-related content. Although the tabs comprise various fields, any suitable information may be displayed in a property file, including any subset of the information displayed, any other information that is not displayed, or both. Further, although certain tabs are displayed,. additional tabs or fewer tabs may be used. Also, although tabs are illustrated, any suitable method of display may be used. The term “property file” is a broad term and is used in its ordinary sense and further includes without limitation a file comprising property-related content or aspects of some embodiments disclosed herein.

FIG. 12A illustrates a contacts tab 1200 for a property file 130 indicated by text 1205 in accordance with an embodiment of the invention. A property owner section 1210 of the contacts tab 1200 preferably comprises suitable owner-related information such as an owner type (e.g., business entity, individual entity), one or more owner names, and a property address.

FIG. 12B further illustrates a contacts section 1245 of the contacts tab 1200. A list of contacts is provided; for example, the contacts section 1245 illustrates a contact for a property owner, as indicated in field 1250. A user wishing to create a new contact would select a contact label from the list box 1255 and select hyperlink 1260; in response, the website would display a new contact area 1245 for entering any suitable contact-related information and display a corresponding hyperlink (e.g., hyperlink 1265) for accessing the contact related information. The contact labels may comprise a broker/agent, a property manager, a property owner, a property owner from a deed, or any other suitable label. Further, in one embodiment, the list box 1255 advantageously includes a option to create new contact label wherein selection of the create a new contact label displays a screen adapted to allow the user to create, revise, or delete contact labels.

As illustrated in FIG. 12B, the contacts section 1245 includes any suitable contact-related information. The contract-related information may include the name of the contact label, the first name of the contact, the last name of the contact, the title of the contact, and the company of the contact. The contract-related information may include one or more addresses (e.g., business, home and mailing) and one or more telephone numbers (e.g., assistants, business phones, business faxes, home phones, home faxes, ISDNs, mobile, other faxes, pagers, primary phone, or the like). The contract-related information may include email addresses, a website addresses, type of ownership entity (e.g., a corporation, a general partnership, an individual, a limited liability corporation, a limited liability partnership, a limited partnership, a trust or the like), and a domicile of the ownership entity (e.g., states, countries, or the like).

As illustrated in FIG. 12B, the user may advantageously select a button 1270 to activate an export module configured to export the contacts information from the contacts tab 1200 into a document usable by a commercially available software program (e.g., a contact form for MICROSOFT OUTLOOK™, ACT™, or the like). The exported document preferably contains substantially the same content shown in the contacts tab 1200. In one embodiment, selecting the button 1270 further attaches the formatted document to email the contact information to the user, one or more other persons, or any suitable combination thereof.

In a preferred embodiment, the website 410 provides a property file contact management system (not shown) to manage communication with contacts (e.g., property owners, developers, investors, tenants, or the like). The property file contact management system uses information in one or more property files to create documents, including emails, commercially available documents (e.g., MICROSOFT WORD™ documents, MICROSOFT EXCEL™ spreadsheets), solicitation letters, or the like. In one embodiment, the property file contact management system includes a scheduling system for soliciting or otherwise communicating with contacts using any suitable method, including mail, telephone, email or the like; accordingly, the member has the ability to schedule follow up contacts.

In one embodiment, the property file contact management system accesses a searchable database of telephone numbers (e.g., white pages or the like). For example, the member may execute search using one or more of the data in the property file (e.g., owner name, property address, address of the vesting, address to where tax bills are sent, or the like) and retrieve relevant records from the database into the property file contact management system.

In one embodiment, the property file contact management system accesses a searchable database of public records, such as DBA records, certificates of partnerships, or the like. Thus, the member can identify officers or other persons associated with DBA's, partnerships, or other business entities and then add one or more corresponding entries in the property file contact management system. The member may then search for the telephone number of the person or prepare documents as described above.

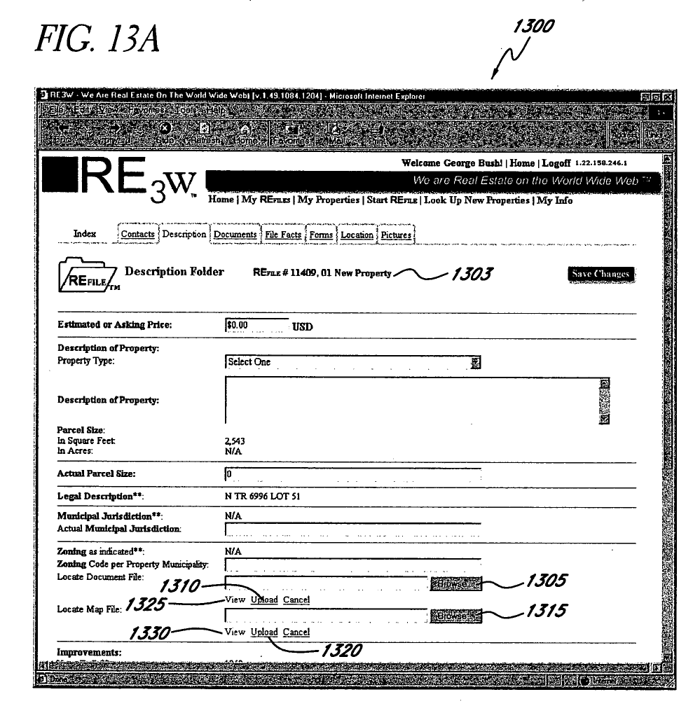

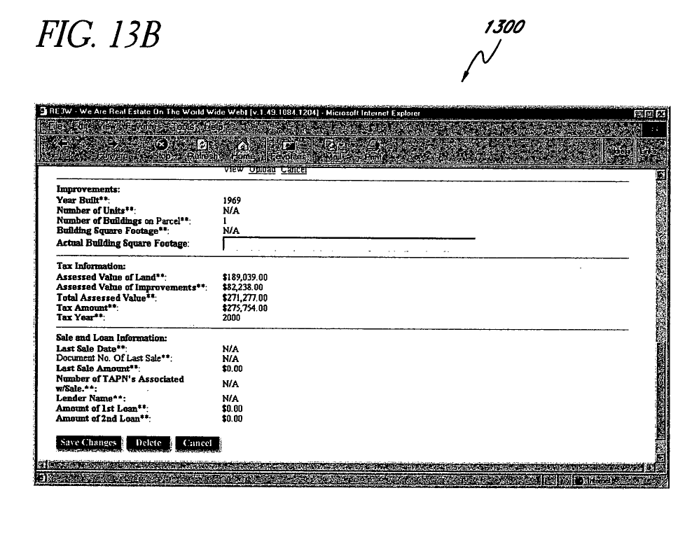

FIG. 13A illustrates a description tab 1300 for a property file 130 indicated by text 1303 in accordance with an embodiment of the invention. The description tab 1300 includes any suitable information. In one embodiment, the description tab 1300 advantageously provides one or more fields, text, or both for viewing, revising, and saving content, including an estimated or asking price for the property, a property type for the property (e.g., acreage—ten acres or more, hotel/lodging, industrial, multi-family, office, residential lots, retail, vacant land—ten acres or more, or the like), a description of the property, parcel size (e.g., acres, square feet), a legal description number, a governmental jurisdiction (e.g., a municipal), and governmental zoning code (e.g., municipal).

In one embodiment, the user may browse and select a document file related to zoning (e.g., zoning regulations or the like) using button 1305. Upon selection of the document file, the user may select hyperlink 1310 to upload the document file into the property file 130. Similarly, in one embodiment, the user may browse and select a file related to a zoning map (e.g., one or more portions of a zoning map or the like) using button 1315. Upon selection of the file, the user may select hyperlink 1320 to upload the file into the property file 130. In one embodiment, the user may advantageously view the uploaded file by selecting a corresponding view hyperlink (e.g., hyperlink 1325, hyperlink 1330) or the like.

As illustrated in FIG. 13B, the description tab 1300 advantageously provides one or more fields, text, or both for viewing, revising, and saving content, including the year a unit was built, the number of units built, the number of buildings on the parcel, building square footage, tax assessed value of the land, tax assessed value of improvements, total assessed value, tax amount, tax year, last date of sale, document number of the last sale, the last sale amount, tax authority parcel numbers associated with the sale, lender name, and one or more loan amounts.

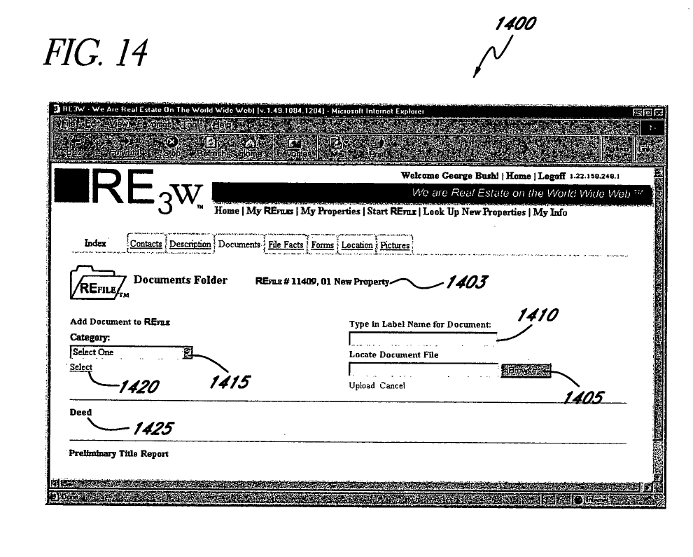

FIG. 14 illustrates a documents tab 1400 for a property file 130 indicated by text 1403 in accordance with an embodiment of the invention. In one embodiment, the user may browse and select a document file using button 1405, enter a name into a field 1410, and select a document category from a list box 1415. The user may select hyperlink 1420 to upload the document file into the property file 130. In one embodiment, the uploaded documents are displayed under a heading (e.g., heading 1425) corresponding to a document category. In one embodiment, the uploaded documents are scanned documents, electronic documents, or any other suitable document. Any suitable categories of documents may be used including but not limited to deeds, preliminary title reports, or the like. In one embodiment, the user may advantageously view the uploaded file by selecting a corresponding view hyperlink or the like.

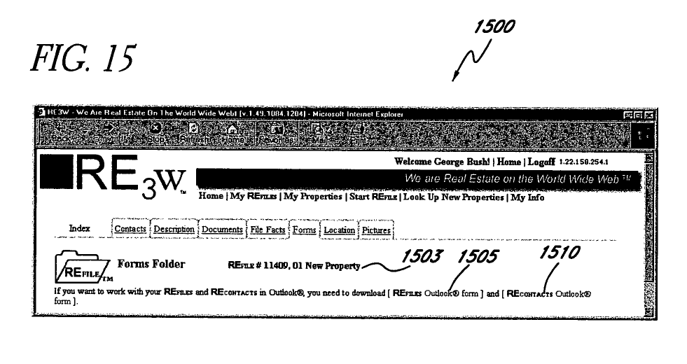

FIG. 15 illustrates a forms tab 1500 for a property file 130 indicated by text 1503 in accordance with an embodiment of the invention. In one embodiment, forms compatible with a commercially available contact system (e.g., MICROSOFT OUTLOOK™, ACT™, or the like) are advantageously downloadable for a user's computing device including but not limited to a personal computer, a laptop computer, a personal visual assistant, a portable computer device, or the like.

In one embodiment, the user advantageously selects a hyperlink 1505 to activate an export module configured to export information from the property file 130 into a document usable by the commercially available software program. The exported document preferably contains substantially the same content shown in some or all of the property file 130. For example, in one embodiment, the exported document preferably contains substantially the same content illustrated in the series of tabs (e.g., contacts, description, documents, file facts, forms, location, pictures) illustrated in FIGS. 12-17. In one embodiment, the export document preferably contains some of the content illustrated in the series of tabs.

In one embodiment, the user advantageously selects a hyperlink 1510 to activate an export module configured to export the contacts information from the contacts tab 1200 into a document usable by the commercially available software program. The exported document preferably contains substantially the same content shown in some or all of the contacts tab 1200.

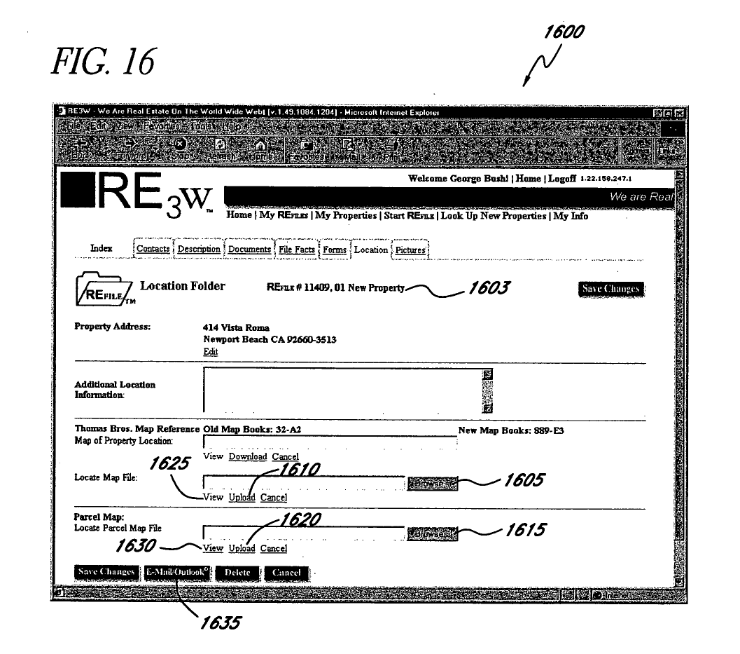

FIG. 16 illustrates a locations tab 1600 for a property file 130 indicated by text 1603 in accordance with an embodiment of the invention. The locations tab 1600 includes any suitable information. In one embodiment, the locations tab 1600 advantageously provides one or more fields, text, or both for viewing, revising, and saving content, including a property address, additional location information, one. or more references (e.g., page, grid coordinates, or the like) for a commercially available map (e.g., THOMAS BROTHERS™) or the like.

In one embodiment, the user may browse and select a commercially available map file or the like using button 1605. Upon selection of the commercially available map file, the user may select hyperlink 1610 to upload the commercially available map file into the property file 130. Similarly, in one embodiment, the user may browse and select a parcel map file (e.g., parcel map) or the like using button 1615. Upon selection of the file, the user may select hyperlink 1620 to upload the file into the property file 130. In one embodiment, the user may advantageously view the uploaded file by selecting a corresponding view hyperlink (e.g., hyperlink 1625, hyperlink 1630) or the like.

In one embodiment, the user may advantageously select a button 1635 to activate an export module configured to export the contacts information from the locations tab 1600 into a document usable by a commercially available software program (e.g., a form for MICROSOFT OUTLOOK™, ACT™, or the like). The exported document preferably contains substantially the same content shown in the locations tab 1600. In one embodiment, selecting the button 1635 further attaches the formatted document to an email for emailing to the user, one or more other persons, or any suitable combination thereof.

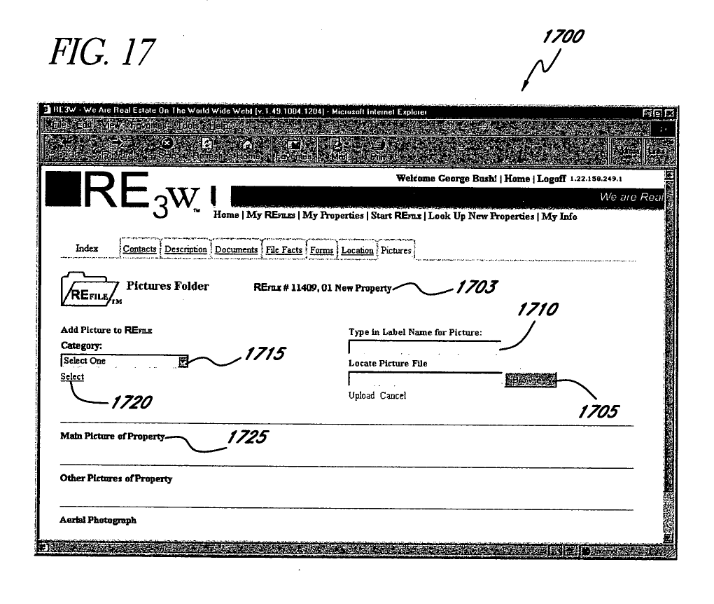

FIG. 17 illustrates a pictures tab 1700 for a property file 130 indicated by text 1703 in accordance with an embodiment of the invention.

In one embodiment, the user may browse and select a picture file using button 1705, enter a name into a field 1710, and select a picture category from a list box 1715. The user may select hyperlink 1720 to upload the picture file into the property file 130. In one embodiment, the uploaded documents are displayed under a heading (e.g., heading 1725) corresponding to a document category. Any suitable categories of pictures may be used including but not limited to photographs, aerial photographs, satellite photographs, interior photographs, or the like. In one embodiment, the user may advantageously view the uploaded file by selecting a corresponding view hyperlink or the like.

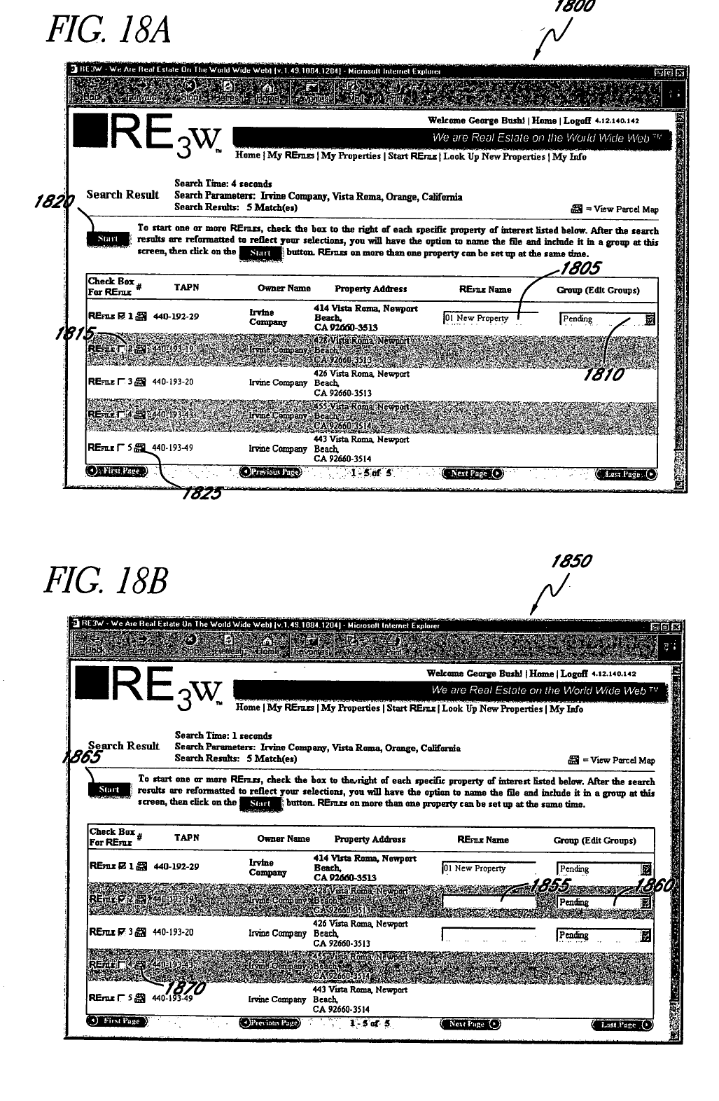

With reference to FIG. 5, a user may select the hyperlink 535 to open a search window substantially similar to screen 800 (FIG. 8) except the text 805 is not shown. The user may execute a search according to criteria in a manner substantially similar to that shown in FIG. 8 and the corresponding descriptions. In response to the search, the website displays a screen 1800 (FIG. 18A). In one embodiment, the results shown in the screen 1800 preferably indicate that a particular property already has an associated property file; for example, an associated property file name 1805 and an associated group name 1810 indicate that a property file 130 has already been created the first property listed in the results.

As illustrated in FIG. 18A, in one embodiment, the user may select a check box (e.g., check box 1815) and press the start button 1820 to generate a property file having the information corresponding to the parcel associated with check box 815. In one embodiment, the user may select a plurality of such check boxes and press the start button 1820 to create a plurality of property files for the plurality of selected check boxes.

In one embodiment, upon selection of a check box, a screen 1850 (FIG. 18B) is displayed. The user may advantageously enter a name for a property file into a field (e.g., field 1855) and choose an associated property file group from a list box (e.g., list box 1860). Accordingly, upon selection of the start button 1865, a property file is created for the associated check boxes and any given file names and file groups are thus associated with the property files.

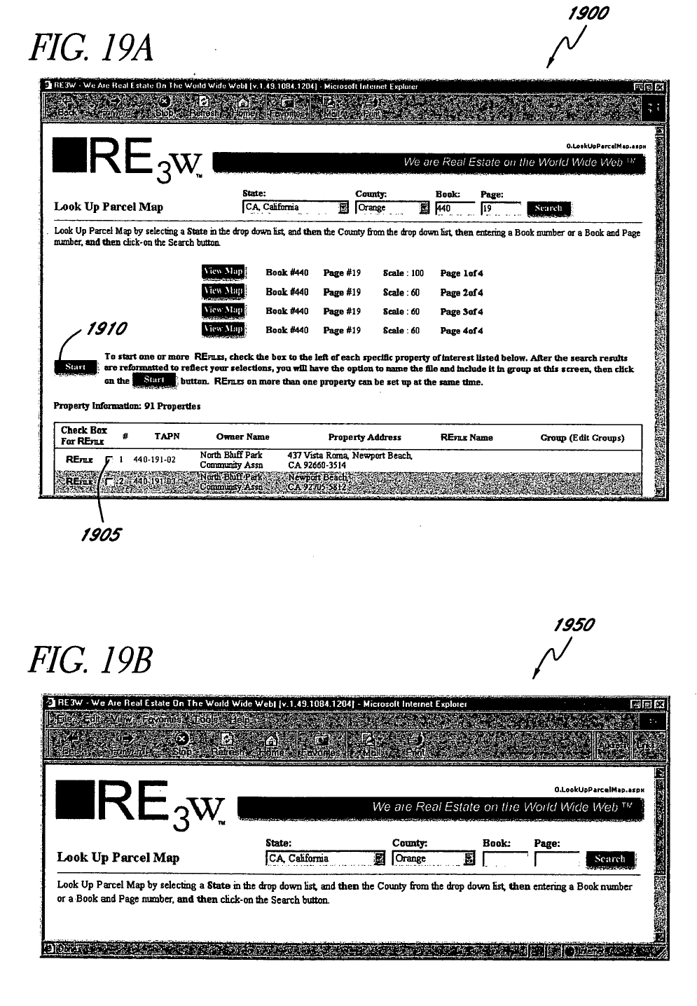

In one embodiment, a user may select a view parcel map button (e.g., the parcel map button 1825 in FIG. 18A or view parcel map button 1870 in FIG. 18B). In response to selecting the view parcel map button, the look up parcel map screen 1900 (FIG. 19A) is displayed. As shown in FIG. 19A, the user may select a check box 1905 that has preferably has substantially similar functionality as check box 1815 (FIG. 18A). Thus, in one embodiment, upon selection of the check box 1905, a field may advantageously appear for entering a property file name and a list box for a group type. In response to the user selecting a start button 1910, a corresponding property file will be created with that corresponding file name and group name. In one embodiment, the user may select a plurality of such check boxes and press the start button 1910 to create a plurality of property files for the plurality of selected check boxes.

With reference to FIG. 5, a user may select the hyperlink 535 to open a search window substantially similar to screen 800 (FIG. 8) except the text 805 is not shown. In one embodiment, the user would select a proceed button 840 to open a parcel look up screen 1950 (FIG. 19B). Accordingly, as illustrated in FIG. 19B, the user may search the parcel map or the like on the basis of a state, a county, a book, a page, or any suitable combination thereof. The results of the search are displayed and used in a manner substantially similar to that shown in FIG. 19A. Also, in FIG. 19A, the user may search the parcel map or the like on the basis of a state, a county, a book, a page, or any suitable combination thereof.

FIG. 20A illustrates screen 2000, which is an embodiment of screen 500 in which a plurality of property files 130 have been created. In this embodiment, the property files 130 are displayed as a list, as shown in screen 2000. Upon selection of check box 2005 and selecting the search button 2010, a screen 2050 (FIG. 20B) is shown. In the embodiment shown in screen 2050, the property files 130 are displayed according to associated groups under a particular group heading (e.g., group heading 2055). In one embodiment, a property may be within multiple groups. For example, one illustrated property file is in two groups: list entry 2060 and list entry 2065 corresponding respectively to group 2055 and 2070.

### Relationship Management

FIG. 21A, FIG. 21B and FIG. 21B illustrate an embodiment of the invention wherein the data management system 120 determines the possession of a set of one or more property files created within a relationship between a member A and a member B. In one embodiment, in a process 2100, at a block 2110, member A and member B enter into a relationship via a data management system 120. The relationship preferably defines the post-relationship access rights to property files that were created within the relationship. In one embodiment, the relationship defines that member A and member B each retain a separate copy of the property files created within the relationship. At a block 2120, a property file 2122 and a property file 2124 are created within the relationship. Accordingly, member A and member B use the property files 2122 and 2124 for any suitable purpose. However, at a block 2130, the member A and member B dissolve the relationship via the data management system 120. At a block 2130, in dissolving the relationship, the data management system 120 preferably automatically processes the post-relationship access rights to property files, as defined in the relationship. Accordingly, at a block 2140, the data management system 120 provides a copy of property files 2122 and 2124 for member A (i.e., property files 2122A and 2124A) and for member B (i.e., property files 2122B and 2124B).

In one embodiment, the relationship advantageously defines post-relationship access rights to property files created outside the relationship. For example only and not to limit the scope of the invention, a member creates one or more property files prior to entering a relationship. When creating the relationship or during the relationship, the member adds the one or more property files to the relationship. Upon dissolution of the relationship, each member retains a separate copy of the one or more property files.

In one embodiment, a member may create a property file during the existence of a relationship, but not within the relationship. Accordingly, during the relationship, the member adds the one or more property files to the relationship. Upon dissolution of the relationship, each member retains a separate copy of the one or more property files.

FIG. 22A, FIG. 22B and FIG. 22B illustrate an embodiment of the invention wherein the data management system 120 determines the possession of a set of one or more property files created within a relationship between a member A and a member B. In one embodiment, in a process 2200, at a block 2210, member A and member B enter into a relationship via a data management system 120. The relationship preferably defines the post-relationship access rights to property files that were created within the relationship. In one embodiment, the relationship defines that only member A will retain a copy of the property files created within the relationship. At a block 2220, a property file 2222 and a property file 2224 are created within the relationship. Accordingly, member A and member B use the property files 2222 and 2224 for any suitable purpose. However, at a block 2230, the member A and member B dissolve the relationship via the data management system 120. At a block 2230, in dissolving the relationship, the data management system 120 preferably automatically processes the post-relationship access rights to property files, as defined in the relationship. Accordingly, at a block 2240, the data management system 120 automatically provides a copy of the property files 2222 and 2224 for member A (i.e., property files 2222A and 2224A) and member B is provided with no copy of the property files 2222 and 2224.

In other embodiments, three or more members enter into a relationship via a data management system 120 in which one, two, or more of the members are granted post-relationship access rights to a copy of property files that were created within the relationship. Any suitable number of members may enter into a relationship. Further, any suitable number of members may be granted post-relationship access rights to a copy of property files that were created within the relationship.

Other preferred embodiments comprising other combinations, omissions, substitutions and modifications to the above-described preferred embodiments may be used, as described below.

In one embodiment, the website 410 advantageously includes one or more features, including a secure environment using encryption or the like, an online customer support system, an accounting/billing system (e.g., processing telephone, mail, and online registration and membership), and an email system.

In one embodiment, the data management system 120 may include an audit module configured to display an audit trail of the access of a property file 130. The audit trail preferably identifies the person (e.g., member, guest, or the like) accessing the property file 130, the time and date of access, the type of access, or any other suitable information. In one embodiment, the audit trial is displayed as an integrated portion of the property file 130 subject to access rights. A person preferably may limit the persons that can view the audit trail and limit the portions of the audit trail that the persons view. Thus, a person may view or supervise the activity of another that is working with a property file 130.

In one embodiment, the data management system 120 may store a history of the data incorporated into a property file 130. The history data may be stored within the database 435, within the database 450, within any suitable computer system, or any suitable combination thereof. Accordingly, as data changes, the data management system 120 allows a person to view the history of changes, which preferably includes the data changed and the data of the change.

In one embodiment, a file content checklist is provided that is preferably expandable by property type. The checklist may advantageously include one or more of the following: a list of participants, a list of documents, and a timeline showing the typical transaction process. The checklist is preferably modifiable and expandable by member for a specific transaction and property type. For example, a transaction for a particular property type may have particular tasks to be carried out by particular participants and documents to be prepared and signed. Accordingly, the checklist would preferably display the status of each task and document, along with any relative order or dependency among the tasks and documents.

In one embodiment, the website 410 includes an interactive developer directory that can advantageously display a set of developers according to one or more suitable criteria, including geographic location and property type. A member preferably may flag one or more of the set of developers to submit one or more properties. The member may submit a property using any suitable method, such as website email or the like. A developer preferably may filter out unwanted submissions according to any suitable criteria, including geographic location, property type, property size, or the like. In one embodiment, a developer may request notification of a property recently listed as “for sale.” Notifications may be requested for properties accordingly to any suitable criteria (e.g., property type, property size, price range, location or the like). In one embodiment, the website 410 allows a developer to create a personalized sub-website within the website 410. The displayed set of developers preferably includes links to developers' sub-websites. In one embodiment, a developer bulletin board is provided wherein developers may exchange information. The access to the interactive developer directory is preferably limited to members of the website 410. The access to the developer bulletin board is preferably limited to developer members of the website.

In one embodiment, the website 410 includes an interactive investor directory that can advantageously display a set of investors according to one or more suitable criteria, including geographic location and preferred property type. A member preferably may flag one or more of the set of investors to submit one or more properties. The member may submit a property using any suitable method, such as website email or the like. An investor preferably may filter out unwanted submissions according to any suitable criteria, including geographic location, property type, property size, or the like. In one embodiment, a developer may request notification of a property recently listed as “for sale.” Notifications may be requested for properties accordingly to any suitable criteria (e.g., property type, property size, price range, location or the like). In one embodiment, the website 410 allows an investor to create a personalized sub-website within the website 410. In one embodiment, the displayed set of investors includes links to investors' sub-websites. In one embodiment, an investor bulletin board is provided wherein investors may exchange information. The access to the interactive investor directory is preferably limited to members of the website 410. The access to the investor bulletin board is preferably limited to investor members of the website.

In one embodiment, the website 410 includes an interactive municipal/governmental directory that can advantageously display a set of municipalities, governmental entities, or the like according to one or more suitable criteria. The website 410 preferably allows the municipality or governmental entity to create a personalized sub-website within the website 410. The displayed set preferably includes links to the sub-websites. The access to the directory is preferably limited to members of the website 410. In one embodiment, the website 410 includes a directory for the offices and officials of one or more governmental entities (e.g., federal, state, county, city, or the like). The access to the directory for the offices and officials is preferably provided to members of the website 410 and the public.

In one embodiment, the website 410 includes an interactive insurer directory that can advantageously display a set of insurers (e.g., property, casualty, environmental, or the like) according to one or more suitable criteria, including geographic location, coverage type, or the like. A member preferably may flag one or more of the set of insurers to solicit offers. The member may solicit using any suitable method, such as website email or the like. An insurer preferably may filter out unwanted solicitations according to any suitable criteria, including geographic location, property type, or the like. In one embodiment, the website 410 allows an insurer to create a personalized sub-website within the website 410. The displayed set of insurers preferably includes links to insurers' sub-websites. The access to the interactive insurer directory is preferably limited to members of the website 410.

In one embodiment, the website 410 includes an interactive lender/equity-investor directory that can advantageously display a set of lenders, equity investors, or the like according to one or more suitable criteria, including geographic location and preferred property type. A member preferably may flag one or more of the displayed set of lenders/equity-investors to submit one or more properties to solicit loans, equity, or both. The member may submit a property using any suitable method, such as website email or the like. A lender/equity-investor preferably may filter out unwanted submissions according to any suitable criteria, including geographic location, property type, loan amount, or the like. In one embodiment, the website 410 allows a lender/equity-investor to create a personalized sub-website within the website 410. The displayed set of lenders/equity-investors preferably includes links to the sub-websites of the lenders/equity-investors. In one embodiment, a lender bulletin board is provided wherein lenders or the like may exchange information. In one embodiment, an equity-investor bulletin board is provided wherein equity-investors or the like may exchange information. The access to the interactive lender/equity-investor directory is preferably limited to members of the website 410. The access to the lender bulletin board is preferably limited to lender members of the website. The access to the equity-investor bulletin board is preferably limited to equity-investor members of the website. In one embodiment, the website 410 provides title insurance products, lender support products, or the like.

In one embodiment, the website 410 includes an interactive tenant directory that can advantageously display a set of tenants according to one or more suitable criteria, including geographic location, tenant industry, tenant size, or the like. A member preferably may flag one or more of the set of tenants to submit one or more properties. The member may submit a property using any suitable method, such as website email or the like. A tenant preferably may filter out unwanted submissions according to any suitable criteria, including geographic location, property type, property size, or the like. In one embodiment, a tenant may request notification of a property recently listed as “for sale.” Notifications may be requested for properties accordingly to any suitable criteria (e.g., size of space, space layout, rent, landlord, location, parking, or the like). In one embodiment, the website 410 allows an tenant to create a personalized sub-website within the website 410. The displayed set of tenants preferably includes links to tenants' sub-websites. In one embodiment, an tenant bulletin board is provided wherein tenants may exchange information. The access to the interactive tenant directory is preferably limited to members of the website 410. The access to the tenant bulletin board is preferably limited to tenant members of the website.

In one embodiment, the website 410 facilitates negotiation among a plurality of members, including developers, investors, sellers, legal counsel, service providers. The website displays documents to the members, which can advantageously negotiate and then revise the content of the documents from remote locations. Standardized documents are preferably provided with selectable, alternative provisions. Accordingly, when the members agree upon an alternative, the alternative provision is selected via the website and the document then reflects the selection. In one embodiment, the website 410 includes voice communication, video communication, or both to allow the plurality of members to negotiate via the website.

In one embodiment, the website 410 facilitates negotiation among a plurality of members, including developers, investors, legal counsel, lenders, equity investors, or the like. The website displays documents to the members, which can advantageously negotiate and then revise the content of the documents from remote locations. Standardized documents are preferably provided with selectable, alternative provisions. Accordingly, when the members agree upon an alternative, the alternative provision is selected via the website and the document then reflects the selection. In one embodiment, the website 410 includes voice communication, video communication, or both to allow the plurality of members to negotiate via the website.

In one embodiment, the website 410 facilitates negotiation among a plurality of members, including tenants, developers, investors, legal counsel, service providers, or the like. The website displays documents to the members, which can advantageously negotiate and then revise the content of the documents from remote locations. Standardized documents are preferably provided with selectable, alternative provisions. Accordingly, when the members agree upon an alternative, the alternative provision is selected via the website and the document then reflects the selection. In one embodiment, the website 410 includes voice communication, video communication, or both to allow the plurality of members to negotiate via the website.

In one embodiment, the website 410 associates a public property number with a property file. A member uses the website to advantageously grant certain access rights for viewing some or all of the information in the property file. For example, the access rights may be granted to the public (e.g., anyone knowing the associated property number of the property file). In one embodiment, the website 410 displays the information in response to receiving the property number via any suitable method, such as via a hyperlink posted on the member's website, via a textbox on the website 410, or the like. Accordingly, a member may advantageously advertise the public property number on the member's website along with hyperlinks to the website 410. In one embodiment, the website 410 associates a member property number to allow a member to access information in a manner substantially similar to that used with a public property number. In one embodiment, a first member, using a member property number associated with a property file 130 of a second member, accesses information associated with the property file 130 and uses that information to create a new property file 130.

In one embodiment, the website 410 displays zoning maps (e.g., city, county, or the like) and zoning descriptions, which may advantageously be viewed or printed by one or more members or by the public. In one embodiment, the website 410 uses information in a property file 130 to determine an associated zoning map and associated zoning description and, in response to a member request, to add the zoning map and zoning description to the property file 130. In one embodiment, the website 410 may similarly display redevelopment-related documents (e.g., site maps, programs, developer qualifications, submission procedures, or the like).

In one embodiment, the website 410 includes a library of oblique aerial photographs. In one embodiment, the library includes photographs of major metropolitan areas. The access to the library of oblique aerial photographs is preferably limited to members of the website 410, to the public, or both.

In one embodiment, the website 410 includes a directory of industry websites for viewing by members of the website 410, the public, or both. In one embodiment, the website 410 includes a database of member-entered compensation information (e.g., concerning positions the members have filled) for viewing by members of the website 410, the public, or both. In one embodiment, the website 410 includes a database of job openings (and employer-related hyperlinks) for viewing by members of the website 410, the public, or both. In one embodiment, the website 410 includes a database of market studies, research reports, technical bulletins, or the like (and author-related hyperlinks) for viewing by members of the website 410, the public, or both. In one embodiment, the website 410 includes a database of sales comparables, lease comparables, or the like for viewing by members of the website 410, the public, or both; The sales/lease comparables database preferably includes data derived from formal transaction documents (e.g., documents generated by the website 410, documents not generated by the website, or both).

In one embodiment, the website 410 provides descriptions of ownership regulations, methods for vesting (e.g., trust deed, warranty deed), or the like for one or more governmental entities.

In one embodiment, the website 410 provides reports (e.g., summary, presentation) using information from one or more property files 130. The reports may advantageously customize the reports to present content from a member's property files 130.

In one embodiment, the website 410 uses information from a property file 130 to generate a proposal to purchase the property associated with the property file. In one embodiment, the purchase proposals may be formatted according to a predetermined property type. In one embodiment, the website 410 uses information from a property file 130 to generate purchase offer documents. In one embodiment, the website 410 uses information from a property file 130 to generate formal documents such as purchase and sales agreements, joint escrow instructions, ground lease documents, deeds, affidavits, bills of sale, or the like. The purchase proposals and formal documents are preferably customized according to property type and according to the laws or regulations of one or more governmental entities associated with a property, such as states or the like.

In another embodiment, the website 410 includes a financial acquisition module. The financial acquisition module preferably accesses information in one or more property files to perform any suitable acquisition-related analysis, such as cash flow, investment evaluation, or the like.

In one embodiment, the website 410 generates reports (e.g., summary reports, presentations) using any suitable combination of one or more member's property files, one or more views, or the like.

In one embodiment, the website 410 uses information from a property file 130 to generate financing documents and exhibits from one or more templates. Financing documents preferably include one or more of promissory notes, deeds of trust, mortgages, peripheral documents (e.g., environmental indemnities, guarantees), or the like. In one embodiment, the documents and exhibits are customized according to a property type.

In one embodiment, the website 410 generates a presentation report concerning properties in selected for-lease listings. In one embodiment, the website 410 displays a comparison grid to compare a plurality of for-lease listings that were submitted directly, indirectly or both.

In one embodiment, the website 410 uses information from a property file 130 to generate a tenant's proposal to lease the property associated with the property file. In one embodiment, the lease proposals may be formatted according to a predetermined property type and may advantageously be submitted to one or more lessors. In one embodiment, the website 410 uses information from a property file 130 to generate lease proposal documents from a tenant. In one embodiment, the website 410 uses information from a property file 130 to generate formal documents such lease agreements, exhibits, or the like. The lease proposals and formal documents are preferably customized according to property type and according to the laws or regulations of one or more governmental entities associated with a property, such as states or the like.

In one embodiment, the website 410 provides property-specific and vicinity maps. Accordingly, a user may plot the location of a property on the map in lieu of or in addition to using searches described herein.

In one embodiment, the website 410 uses information in the property file 130 to provide loan securitization and sale to an investor, agency, or the like.

In one embodiment, the website 410 includes an auction module configured to receive bids and dispose of properties from for-lease listings, for-sales listings, or the like.

In one embodiment, two or more members each possess a property file 130 corresponding to the same parcel of property. The website 410 preferably allows the two or more members to merge the content from each property file into a single property file.

Although the website 410 is disclosed with reference to its preferred embodiment, the invention is not intended to be limited thereby. Rather, a skilled artisan will recognize from the disclosure herein a wide number of alternatives for the website.

Although the foregoing invention has been described in terms of certain preferred embodiments, other embodiments will be apparent to those of ordinary skill in the art from the disclosure herein. For example, although certain embodiments are disclosed with reference to a website, any suitable computer system may be used, including ones not accessible via the Internet. Further, although certain embodiments are disclosed with reference to the commercial real estate context, these embodiments may also be used in the residential real estate context and in any suitable non-real estate context. For example, although certain embodiments are described with reference to property files, some embodiments may be used with files of other content, structure, or the like. Also, although some embodiments are described with reference to a tax authority parcel number and a parcel map, any suitable parcel map and parcel identification may be used, including without limitation a map displaying parcels of property and having a corresponding parcel identification (e.g., number, code, numbering system, coding system, or the like) that preferably identifies the displayed parcels.

Additionally, other combinations, omissions, substitutions and modifications will be apparent to the skilled artisan in view of the disclosure herein. Accordingly, the present invention is not intended to be limited by the reaction of the preferred embodiments, but is to be defined by reference to the appended claims.

For purposes of construing the claims, a method claim that recites multiple steps should not be construed as necessarily requiring that these steps be performed in the order in which they are recited.

Additionally, all publications, patents, and patent applications mentioned in this specification are herein incorporated by reference to the same extent as if each individual publication, patent, or patent application was specifically and individually indicated to be incorporated by reference.

1. A system for finding parcels of real property located within a geographical area comprising:
at least one property database comprising records concerning properties, wherein at least one of the records comprises geographical coordinates associated with at least one property that indicate a location of the at least one associated property and a property identifier that identifies the property, and wherein at least one of the records is not associated with a street address of any property; and
a map-based search tool configured to receive user input regarding a geographical area to search, to determine, based on the user input, a range of geographical coordinates that define the geographical search area, to find, within the property database, a first set of properties that, according to a property coordinates database, is located within the range of geographical coordinates, and to find a second set of properties that are displayed on at least one parcel map that also displays at least one of the first set of properties.

2. The system of claim 1 wherein the map-based search tool is configured to retrieve the at least one parcel map from an external database.

3. The system of claim 2 wherein the map-based search tool is configured to determine the range of geographical coordinates by querying an external database.

4. The system of claim 3 wherein the geographical coordinates comprise longitude and latitude coordinates.

5. The system of claim 4 wherein the map-based search tool further comprises a first map selection tool that allows a user to provide input regarding a geographical area to search by drawing, on a map, a rectangle that defines the geographical area to search.

6. The system of claim 5 wherein the map-based search tool further comprises a second map selection tool that allows a user to provide input regarding a geographical area to search by drawing, on the map, a polygon that defines the geographical area to search.

7. The system of claim 6 wherein the map-based search tool is further configured to generate a rectangle-approximated polygon of any polygon that a user draws using the second map selection tool and to find parcels of real property that, according to the property database, are located within the rectangle-approximated polygon.

8. The system of claim 7 wherein the map-based search tool generates the rectangle-approximated polygon by determining extreme points of the polygon, dividing a rectangle defined by the extreme points into a plurality of smaller rectangles, and including, in the generated rectangle-approximated polygon, each smaller rectangle that has at least a portion of the polygon within the confines of the smaller rectangle.

9. The system of claim 6 further comprising a street-based search tool configured to receive user input comprising a plurality of street names and to find at least one parcel of real property that appears on a parcel map on which a street designated by each of the plurality of street names appears.

10. A method of finding real property comprising:
receiving a user-selected geographical area;
receiving a range of geographical coordinates generated based on the selected geographical area;
receiving a first set of properties having property identifiers and being associated with the range of geographical coordinates;
receiving a second set of properties that are geographically close to the first set of properties; and
displaying summary information regarding the first set of properties and the second set of properties.

11. The method of claim 10, wherein the association between the first set of properties and the range of geographical coordinates is that the property identifiers of the first set of properties are associated with at least one record that indicates that the first set of properties are located within the range of geographical coordinates.

12. The method of claim 11, wherein the receiving a second set of properties comprises querying a parcel map database to find properties that are displayed on at least one parcel map that also displays at least one property in the first set of properties.

13. The method of claim 12, wherein the receiving the second set of properties comprises receiving at least one property that does not have an address.

14. A method of finding parcels of real property located within a geographical area comprising:
receiving user input regarding a geographical area, wherein the user input is entered graphically into a map-based interface;
querying a map coordinates-geographical coordinates database to determine a range of geographical coordinates that define the geographical area;
querying a property coordinates database to find a first set of properties that, according to the property coordinate database, are located within the range of geographical coordinates; and
querying a parcel map database to find a second set of properties that, according to the parcel map database, are displayed on at least one parcel map that also displays at least one of the properties in the first set of properties.

15. The method of claim 14 wherein querying the map coordinates-geographical coordinates database determines a range of geographical coordinates that are longitudinal and latitudinal coordinates.

16. The method of claim 14, wherein receiving user input comprises receiving user input that a user enters into the map-based interface by drawing on a map a rectangle defining an area to be searched.

17. The method of claim 14, wherein receiving user input comprises receiving user input that a user enters into the map-based interface by drawing on a map a polygon defining an area to be searched.

18. A system of finding parcels of real property located within a geographical area comprising a street-based map tool configured to receive user input comprising a plurality of street names and to query a parcel map database that comprises a plurality of records that associate a plurality of parcel maps with streets that appear on each parcel map and with properties that appear on each parcel map, the querying being performed to find at least one property that is displayed on at least one parcel map that also displays at least two of the streets identified by the plurality of street names.

19. The system of claim 18 wherein the street-based search tool is further configured to display a summary listing regarding the at least one property found.

20. The system of claim 19 wherein the street-based search tool is configured to query the parcel map database to find at least one parcel map on which a street identified by all of the plurality of street names appears.

21. A method of finding real property, the method comprising:
receiving a plurality of street names;
requesting a set of parcel maps associated with the streets identified by the street names;
receiving a set of properties associated with the parcel maps; and
displaying summary information about the properties.

22. The method of claim 21, wherein the association between a parcel map and a street is that at least a portion of the street appears on the parcel map.

23. The method of claim 22, wherein receiving the set of properties comprises receiving at least one property that does not have an address.

24. A real property information management system comprising:
a plurality of property files comprising data concerning parcels of real property, the system allowing creation of additional property files;
at least one role database comprising data that defines a plurality of roles, each role being associated with a plurality of access privileges that define one or more tasks that a user associated with the role is allowed to perform on the real property information management system, wherein the real property information management system enforces the access privileges;
at least one hierarchy database comprising data that defines at least one organizational hierarchy having a plurality of nodes, each node being associated with a role and with a user, wherein, when a user creates a property file, the property file becomes accessible to the creating user and to any user that is associated with a node of which the creating user's associated node is a descendant; and
a template management module configured to manage a plurality of role templates that each comprise a pre-defined role and to manage a plurality of hierarchy templates that each comprise a pre-defined organizational hierarchy.

25. The system of claim 24 wherein the template management module is further configured to allow a user to set up an organization within the real property information management system by selecting at least one of the hierarchy templates.

26. The system of claim 25 wherein the template management module is further configured to allow the user to modify the nodes defined by the pre-defined organizational hierarchy of the selected hierarchy template.

27. The system of claim 26 wherein the template management module is further configured to allow the user to modify the access rights defined by the pre-defined roles associated with the selected hierarchy template.

28. The system of claim 27 wherein the pre-defined roles of the role templates comprise at least a “President” role, a “System Administrator” role, a “Sales Manager” role, and a “Sales Agent” role.

29. The system of claim 27 wherein the pre-defined organizational hierarchies of the hierarchy templates comprise at least one organizational hierarchy that defines an organization that has a plurality of geographically-based sales regions.

30. The system of claim 27 further comprising a map-based search tool configured to receive user input regarding a geographical area to search, to determine, based on the user input, a range of geographical coordinates that define the geographic search area, and to find, within a property database, at least one parcel of real property that, according to the property database, is located within the range of geographical coordinates, wherein the system allows the user to import data from a parcel of real property found using the map-based search tool into one of the property files.

31. The system of claim 30 further comprising a street-based search tool configured to receive user input comprising a plurality of street names and to find at least one parcel of real property that appears on a parcel map on which a street designated by each of the plurality of street names appears, wherein the system allows the user to import data from a parcel of real property found using the street-based search tool into one of the property files.
